(19) United States
(12) Patent Application Publication
(10) Pub. No.: US 2005/0219627 A1
(43) Pub. Date: Oct. 6, 2005

(54) Printing method, printing system, printing apparatus, binarization dither matrix pattern, computer-readable recording medium on or in which printing program is recorded, and computer-readable recording medium on or in which binarization program is recorded

(75) Inventors: Nobuaki Usui, Kawasaki (JP); Kiyoto Kosaka, Kahoku-shi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/850,411

(22) Filed: May 21, 2004

(30) Foreign Application Priority Data
Dec. 1, 2003 (JP) 2003-401880

(51) Int. Cl. H04N 1/405

(52) U.S. Cl. 358/3.16; 358/3.23

(57) ABSTRACT

The invention provides a printing system by which a greater number of pixels are used to form a basic pattern and moirés and artifacts can be reduced. A binarization dither matrix pattern is configured by arranging a plurality of pixels to be successively turned on in a matrix and has a plurality of specific points P1 and P2 provided at substantially point symmetric positions with respect to the position C of the center of figure thereof. Those of the pixels which are adjacent to be turned on pixels are preferentially turned on in order beginning with those of the pixels which are positioned near to the specific points P1 and P2 to individually form successive halftone dots. When a number of pixels substantially equal to one half the number of pixels which form the binarization dither matrix pattern are turned on in order, the turned on pixels and unturned on pixels form a checkered pattern in the binarization dither matrix pattern.

### BACKGROUND OF THE INVENTION

1) Field of the Invention

The present invention relates to a binarization dither matrix pattern (dither pattern table) for use with a binarization process for converting a multi-value image (Continuous Tone Image) such as a natural image, a graphic image, a color character image or the like into a binary image, and a printing method, a printing system, a printing apparatus, a computer-readable recording medium having a printing program recorded thereon or therein, and a computer-readable recording medium having a binarization program recorded thereon or therein, in which the binarization dither matrix pattern is utilized.

2) Description of the Related Art

In order to output a multi-value image such as a natural image, a graphic image, a color character image or the like obtained by fetching from an inputting apparatus such as a scanner, by production or the like from an outputting apparatus such as a printer, it is necessary to perform a binarization process in order to represent the multi-value image by ON/OFF of a color material (ink, toner or the like; hereinafter referred to as dot).

A dither method is known as one of binarization methods. In the dither method, a value of a particular pixel (object pixel) in a multi-value image and a threshold value set in advance are compared with each other in magnitude to decide a gradation density of the pixel, and an ON/OFF state of a dot regarding the pixel is decided in response to the gradation density of the pixel using a binarization dither matrix pattern prepared in advance.

For example, in Japanese Patent Publication No. 53-5561 (hereinafter referred to as Patent Document 1), a method is disclosed which utilizes a dither pattern in which the centers of gravity of regions to which a color material is to be fixed are positioned on lines of tan θ=⅓ (approximately 18.43°) and dither angles other than 0° and 45° are used to reduce moirés and artificial striped patterns (artifacts).

However, in the dither pattern disclosed in the Patent Document 1 mentioned above, the number of pixels which form a basic pattern in which a plurality of dither patterns are repetitively arranged is as small as 10. Therefore, there is a subject that high-quality printing of an image having a great number of gradations is difficult. For example, in order to form a monochrome 8-bit (that is, 256 colors) image, a large dither pattern wherein a basic pattern is formed from a greater number of pixels is preferable.

### SUMMARY OF THE INVENTION

It is an object of the present invention to provide a printing method, a printing system, a printing apparatus, a binarization dither matrix pattern, a computer readable recording medium having a printing program recorded thereon or therein and a computer-readable recording medium having a binarization program recorded thereon or therein by which a greater number of pixels are used to form a basic pattern and moirés and artifacts can be reduced.

In order to attain the object described above, according to an aspect of the present invention, there is provided a printing method, comprising an expansion step of expanding a multi-value image in a storage area, and an image forming step of binarizing the multi-value image expanded in the storage area based on a binarization dither matrix pattern and forming an image based on a result of the binarization, the binarization dither matrix pattern being configured by arranging a plurality of pixels to be successively turned on in a matrix, the binarization dither matrix pattern having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order.

The binarization dither matrix pattern may be configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixel of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the 1st to 19th columns and the 21st to 53rd columns which form the 54th row of the rectangular pattern are cut out, a turn on order of the 1556 pixels being set such that the pixels of the 33rd to 34th columns which form the 1st row of the partly lacking pattern are turned on 403rd, and 399th, respectively; the pixels of the 31st to 35th columns which form the 2nd row of the partly lacking pattern are turned on 411th, 427th, 435th, 423rd, and 395th, respectively; the pixels of the 29th to 35th columns which form the 3rd row of the partly lacking pattern are turned on 391st, 445th, 463rd, 481st, 475th, 457th, and 429th, respectively; the pixels of the 28th to 36th columns which form the 4th row of the partly lacking pattern are turned on 437th, 477th, 495th, 517th, 523rd, 515th, 491st, 467th, and 415th, respectively; the pixels of the 26th to 36th columns which form the 5th row of the partly lacking pattern are turned on 419th, 471st, 511th, 531st, 551st, 563rd, 565th, 555th, 535th, 507th, and 455th, respectively; the pixels of the 24th to 37th columns which form the 6th row of the partly lacking pattern are turned on 407th, 453rd, 505th, 539th, 571st, 587th, 599th, 607th, 603rd, 595th, 575th, 547th, 499th, and 443rd, respectively; the pixels of the 23rd to 38th columns which form the 7th row of the partly lacking pattern are turned on 447th, 489th, 529th, 561st, 591st, 621st, 631st, 641st, 655th, 639th, 627th, 615th, 583rd, 543rd, 487th, and 405th, respectively; the pixels of the 21st to 38th columns which form the 8th row of the partly lacking pattern are turned on 417th, 459th, 501st, 545th, 581st, 611th, 637th, 659th, 671st, 683rd, 687th, 679th, 663rd, 643rd, 619th, 579th, 527th, and 451st, respectively; the pixels of the 19th to 39th columns which form the 9th row of the partly lacking pattern are turned on 397th, 431st, 469th, 509th, 549th, 585th, 1623rd, 653rd, 669th, 691st, 703rd, 711th, 715th, 707th, 695th, 675th, 649th, 609th, 559th, 503rd, and 421st, respectively; the pixels of the 18th to 39th columns which form the 10th row of the partly lacking pattern are turned on 401st, 425th, 461st, 493rd, 537th, 577th, 617th, 651st, 677th, 701st, 721st, 727th, 737th, 743rd, 731st, 723rd, 699th, 667th, 635th, 593rd, 541st, and 473rd, respectively; the pixels of the 16th to 40th columns which form the 11th row of the partly lacking pattern are turned on 376th, 380th, 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, and 439th, respectively; the pixels of the 14th to 41st columns which form the 12th row of the partly lacking pattern are turned on 368th, 352nd, 344th, 356th, 384th, 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, and 393rd, respectively; the pixels of the 12th to 41st columns which form the 13th row of the partly lacking pattern are turned on 388th, 334th, 316th, 298th, 304th, 322nd, 350th, 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, and 449th, respectively; the pixels of the 11th to 42nd columns which form the 14th row of the partly lacking pattern are turned on 342nd, 302nd, 284th, 262nd, 256th, 264th, 288th, 312th, 364th, 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, and 408th, respectively; the pixels of the 9th to 42nd columns which form the 15th row of the partly lacking pattern are turned on 360th, 308th, 268th, 248th, 228th, 216th, 214th, 224th, 244th, 272nd, 324th, 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, and 428th, respectively; the pixels of the 7th to 43rd columns which form the 16th row of the partly lacking pattern are turned on 372nd, 326th, 274th, 240th, 208th, 192nd, 180th, 172nd, 176th, 184th, 204th, 232nd, 280th, 336th, 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, and 402nd, respectively; the pixels of the 6th to 43rd columns which form the 17th row of the partly lacking pattern are turned on 332nd, 290th, 250th, 218th, 188th, 158th, 148th, 138th, 124th, 140th, 152nd, 164th, 196th, 236th, 292nd, 374th, 476th, 540th, 592nd, 638th, 670th, 702nd, 726th, 734th, 746th, 744th, 730th, 720th, 700th, 676th, 644th, 616th, 576th, 532nd, 492nd, 452nd, 420th, and 400th, respectively; the pixels of the 4th to 44th columns which form the 18th row of the partly lacking pattern are turned on 362nd, 320th, 278th, 234th, 198th, 168th, 142nd, 120th, 108th, 96th, 92nd, 100th, 116th, 136th, 160th, 200th, 252nd, 328th, 422nd, 506th, 564th, 614th, 654th, 678th, 698th, 710th, 718th, 714th, 706th, 694th, 668th, 652nd, 620th, 584th, 548th, 508th, 468th, 432nd, 394th, 376th, and 380th, respectively; the pixels of the 2nd to 45th columns which form the 19th row of the partly lacking pattern are turned on 382nd, 348th, 310th, 270th, 230th, 194th, 156th, 126th, 110th, 88th, 76th, 68th, 64th, 72nd, 84th, 104th, 130th, 170th, 220th, 276th, 358th, 460th, 530th, 582nd, 622nd, 650th, 666th, 682nd, 690th, 686th, 674th, 662nd, 636th, 612th, 580th, 544th, 500th, 456th, 416th, 368th, 352nd, 344th, 356th, and 384th, respectively; the pixels of the 1st to 45th columns which form the 20th row of the partly lacking pattern are turned on 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, 306th, 412th, 490th, 546th, 586th, 618th, 630th, 646th, 658th, 648th, 634th, 626th, 594th, 562nd, 528th, 488th, 448th, 388th, 334th, 316th, 298th, 304th, 322nd, and 350th, respectively; the pixels of the 1st to 46th columns which form the 21st row of the partly lacking pattern are turned on 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, 340th, 450th, 502nd, 550th, 578th, 598th, 606th, 610th, 602nd, 590th, 574th, 542nd, 504th, 458th, 410th, 342nd, 302nd, 284th, 262nd, 256th, 264th, 288th, 312th, and 364th, respectively; the pixels of the 2nd to 46th columns which form the 22nd row of the partly lacking pattern are turned on 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, 386th, 462nd, 510th, 538th, 558th, 570th, 568th, 556th, 536th, 514th, 478th, 424th, 360th, 308th, 268th, 248th, 228th, 216th, 214th, 224th, 244th, 272nd, and 324th, respectively; the pixels of the 2nd to 47th columns which form the 23rd row of the partly lacking pattern are turned on 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, 330th, 418th, 470th, 494th, 520th, 526th, 522nd, 498th, 486th, 442nd, 372nd, 326th, 274th, 240th, 208th, 192nd, 180th, 172nd, 176th, 184th, 204th, 232nd, 280th, and 336th, respectively; the pixels of the 3rd to 48th columns which form the 24th row of the partly lacking pattern are turned on 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, 371st, 434th, 454th, 480th, 482nd, 466th, 446th, 396th, 332nd, 290th, 250th, 218th, 188th, 158th, 148th, 138th, 124th, 140th, 152nd, 164th, 196th, 236th, 292nd, and 374th, respectively; the pixels of the 3rd to 48th columns which form the 25th row of the partly lacking pattern are turned on 387th, 295th, 245th, 191st, 147th, 107th, 75th, 51st, 29th, 13th, 5th, 7th, 15th, 27th, 47th, 71st, 99th, 139th, 175th, 213th, 255th, 305th, 351st, 398th, 426th, 438th, 430th, 414th, 362nd, 320th, 278th, 234th, 198th, 168th, 142nd, 120th, 108th, 96th, 92nd, 100th, 116th, 136th, 160th, 200th, 252nd, and 328th, respectively; the pixels of the 4th to 49th columns which form the 26th row of the partly lacking pattern are turned on 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, 377th, 404th, 406th, 382nd, 348th, 310th, 270th, 230th, 194th, 156th, 126th, 110th, 88th, 76th, 68th, 64th, 72nd, 84th, 104th, 130th, 170th, 220th, 276th, and 358th, respectively; the pixels of the 5th to 49th columns which form the 27th row of the partly lacking pattern are turned on 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, 379th, 390th, 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, and 306th, respectively; the pixels of the 5th to 50th columns which form the 28th row of the partly lacking pattern are turned on 357th, 273rd, 215th, 165th, 125th, 101st, 81st, 69th, 61st, 65th, 73rd, 85th, 111th, 127th, 159th, 195th, 231st, 271st, 311th, 347th, 385th, 403rd, 399th, 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, and 340th, respectively; the pixels of the 6th to 51st columns which form the 29th row of the partly lacking pattern are turned on 319th, 249th, 197th, 157th, 129th, 113th, 97th, 89th, 93rd, 105th, 117th, 143rd, 167th, 199th, 235th, 279th, 323rd, 363rd, 411th, 427th, 435th, 423rd, 395th, 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, and 386th, respectively; the pixels of the 6th to 51st columns which form the 30th row of the partly lacking pattern are turned on 367th, 289th, 233rd, 193rd, 161st, 149th, 133rd, 121st, 131st, 145th, 153rd, 185th, 217th, 251st, 291st, 331st, 391st, 445th, 463rd, 481st, 475th, 457th, 429th, 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, and 330th, respectively; the pixels of the 7th to 52nd columns which form the 31st row of the partly lacking pattern are turned on 329th, 277th, 229th, 201st, 181st, 173rd, 169th, 177th, 189th, 205th, 237th, 275th, 321st, 369th, 437th, 477th, 495th, 517th, 523rd, 515th, 491st, 467th, 415th, 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, and 371st, respectively; the pixels of the 8th to 52nd columns which form the 32nd row of the partly lacking pattern are turned on 317th, 269th, 241st, 221st, 209th, 211th, 223rd, 243rd, 265th, 301st, 355th, 419th, 471st, 511th, 531st, 551st, 563rd, 565th, 555th, 535th, 507th, 455th, 387th, 295th, 245th, 191st, 147th, 107th, 75th, 51st, 29th, 13th, 5th, 7th, 15th, 27th, 47th, 71st, 99th, 139th, 175th, 213th, 255th, 305th, and 351st, respectively; the pixels of the 8th to 53rd columns which form the 33rd row of the partly lacking pattern are turned on 361st, 309th, 285th, 259th, 253rd, 257th, 281st, 293rd, 337th, 407th, 453rd, 505th, 539th, 571st, 587th, 599th, 607th, 603rd, 595th, 575th, 547th, 499th, 443rd, 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, and 377th, respectively; the pixels of the 9th to 53rd columns which form the 34th row of the partly lacking pattern are turned on 345th, 325th, 299th, 297th, 313th, 333rd, 383rd, 447th, 489th, 529th, 561st, 591st, 621st, 631st, 641st, 655th, 639th, 627th, 615th, 583rd, 543rd, 487th, 405th, 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, and 379th, respectively; the pixels of the 9th to 52nd columns which form the 35th row of the partly lacking pattern are turned on 381st, 353rd, 341st, 349th, 365th, 417th, 459th, 501st, 545th, 581st, 611th, 637th, 659th, 671st, 683rd, 687th, 679th, 663rd, 643rd, 619th, 579th, 527th, 451st, 357th, 273rd, 215th, 165th, 125th, 101st, 81st, 69th, 61st, 65th, 73rd, 85th, 111th, 127th, 159th, 195th, 231st, 271st, 311th, 347th, and 385th, respectively; the pixels of the 10th to 50th columns which form the 36th row of the partly lacking pattern are turned on 375th, 373rd, 397th, 431st, 469th, 509th, 549th, 585th, 623rd, 653rd, 669th, 691st, 703rd, 711th, 715th, 707th, 695th, 675th, 649th, 609th, 559th, 503rd, 421st, 319th, 249th, 197th, 157th, 129th, 113th, 97th, 89th, 93rd, 105th, 117th, 143rd, 167th, 199th, 235th, 279th, 323rd, and 363rd, respectively; the pixels of the 10th to 48th columns which form the 37th row of the partly lacking pattern are turned on 389th, 401st, 425th, 461st, 493rd, 537th, 577th, 617th, 651st, 677th, 701st, 721st, 727th, 737th, 743rd, 731st, 723rd, 699th, 667th, 635th, 593rd, 541st, 473rd, 367th, 289th, 233rd, 193rd, 161st, 149th, 133rd, 121st, 131st, 145th, 153rd, 185th, 217th, 251st, 291st, and 331st, respectively; the pixels of the 11th to 47th columns which form the 38th row of the partly lacking pattern are turned on 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, 439th, 329th, 277th, 229th, 201st, 181st, 173rd, 169th, 177th, 189th, 205th, 237th, 275th, 321st, and 369th, respectively; the pixels of the 12th to 45th columns which form the 39th row of the partly lacking pattern are turned on 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, 393rd, 317th, 269th, 241st, 221st, 209th, 211th, 223rd, 243rd, 265th, 301st, and 355th, respectively; the pixels of the 12th to 43rd columns which form the 40th row of the partly lacking pattern are turned on 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, 449th, 361st, 309th, 285th, 259th, 253rd, 257th, 281st, 293rd, and 337th, respectively; the pixels of the 13th to 42nd columns which form the 41st row of the partly lacking pattern are turned on 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, 408th, 345th, 325th, 299th, 297th, 313th, 333rd, and 383rd, respectively; the pixels of the 13th to 40th columns which form the 42nd row of the partly lacking pattern are turned on 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, 428th, 381st, 353rd, 341st, 349th, and 365th, respectively; the pixels of the 14th to 38th columns which form the 43rd row of the partly lacking pattern are turned on 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, 402nd, 375th, and 373rd, respectively; the pixels of the 15th to 37th columns which form the 44th row of the partly lacking pattern are turned on 476th, 540th, 592nd, 638th, 670th, 702nd, 726th, 734th, 746th, 744th, 730th, 720th, 700th, 676th, 644th, 616th, 576th, 532nd, 492nd, 452nd, 420th, 400th, and 389th, respectively; the pixels of the 15th to 35th columns which form the 45th row of the partly lacking pattern are turned on 422nd, 506th, 564th, 614th, 654th, 678th, 698th, 710th, 718th, 714th, 706th, 694th, 668th, 652nd, 620th, 584th, 548th, 508th, 468th, 432nd, and 394th, respectively; the pixels of the 16th to 33rd columns which form the 46th row of the partly lacking pattern are turned on 460th, 530th, 582nd, 622nd, 650th, 666th, 682nd, 690th, 686th, 674th, 662nd, 636th, 612th, 580th, 544th, 500th, 456th, and 416th, respectively; the pixels of the 16th to 31st columns which form the 47th row of the partly lacking pattern are turned on 412th, 490th, 546th, 586th, 618th, 630th, 646th, 658th, 648th, 634th, 626th, 594th, 562nd, 528th, 488th, and 448th, respectively; the pixels of the 17th to 30th columns which form the 48th row of the partly lacking pattern are turned on 450th, 502nd, 550th, 578th, 598th, 606th, 610th, 602nd, 590th, 574th, 542nd, 504th, 458th, and 410th, respectively; the pixels of the 18th to 28th columns which form the 49th row of the partly lacking pattern are turned on 462nd, 510th, 538th, 558th, 570th, 568th, 556th, 536th, 514th, 478th, and 424th, respectively; the pixels of the 18th to 26th columns which form the 50th row of the partly lacking pattern are turned on 418th, 470th, 494th, 520th, 526th, 522nd, 498th, 486th, and 442nd, respectively; the pixels of the 19th to 25th columns which form the 51st row of the partly lacking pattern are turned on 434th, 454th, 480th, 482nd, 466th, 446th, and 396th, respectively; the pixels of the 19th to 23rd columns which form the 52nd row of the partly lacking pattern are turned on 398th, 426th, 438th, 430th, and 414th, respectively; the pixels of the 20th to 21st columns which form the 53rd row of the partly lacking pattern are turned on 404th, and 406th, respectively; and the pixel of the 20th column which forms the 54th row of the partly lacking pattern is turned on 390th.

Alternatively, the binarization dither matrix pattern may be configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixels of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the pixels of the 1st to 19th columns and the 21st to 53rd columns which form the 54th row of the rectangular pattern are cut out,
a turn on order of the 1556 pixels being set such that the pixels of the 33rd to 34th columns which form the 1st row of the partly lacking pattern are turned on 805th, and 797th, respectively; the pixels of the 31st to 35th columns which form the 2nd row of the partly lacking pattern are turned on 821st, 853rd, 869th, 845th, and 789th, respectively; the pixels of the 29th to 35th columns which form the 3rd row of the partly lacking pattern are turned on 781st, 889th, 925th, 961st, 949th, 913th, and 857th, respectively; the pixels of the 28th to 36th columns which form the 4th row of the partly lacking pattern are turned on 873rd, 953rd, 989th, 1033rd, 1045th, 1029th, 981st, 933rd, and 829th, respectively; the pixels of the 26th to 36th columns which form the 5th row of the partly lacking pattern are turned on 837th, 941st, 1021st, 1061st, 1101st, 1125th, 1129th, 1109th, 1069th, 1013th, and 909th, respectively; the pixels of the 24th to 37th columns which form the 6th row of the partly lacking pattern are turned on 813th, 905th, 1009th, 1077th, 1141st, 1173rd, 1197th, 1213th, 1205th, 1189th, 1149th, 1093rd, 997th, and 885th, respectively; the pixels of the 23rd to 38th columns which form the 7th row of the partly lacking pattern are turned on 893rd, 977th, 1057th, 1121st, 1181st, 1241st, 1261st, 1281st, 1309th, 1277th, 1253rd, 1229th, 1165th, 1085th, 973rd, and 809th, respectively; the pixels of the 21st to 38th columns which form the 8th row of the partly lacking pattern are turned on 833rd, 917th, 1001st, 1089th, 1161st, 1221st, 1273rd, 1317th, 1341st, 1365th, 1373rd, 1357th, 1325th, 1285th, 1237th, 1157th, 1053rd, and 901st, respectively; the pixels of the 19th to 39th columns which form the 9th row of the partly lacking pattern are turned on 793rd, 861st, 937th, 1017th, 1097th, 1169th, 1245th, 1305th, 1337th, 1381st, 1405th, 1421st, 1429th, 1413th, 1389th, 1349th, 1297th, 1217th, 1117th, 1005th, and 841st, respectively; the pixels of the 18th to 39th columns which form the 10th row of the partly lacking pattern are turned on 801st, 849th, 921st, 985th, 1073rd, 1153rd, 1233rd, 1301st, 1353rd, 1401st, 1441st, 1453rd, 1473rd, 1485th, 1461st, 1445th, 1397th, 1333rd, 1269th, 1185th, 1081st, and 945th, respectively; the pixels of the 16th to 40th columns which form the 11th row of the partly lacking pattern are turned on 751st, 759th, 817th, 881st, 965th, 1037th, 1113th, 1193rd, 1257th, 1329th, 1393rd, 1449th, 1477th, 1497th, 1509th, 1513th, 1501st, 1469th, 1437th, 1385th, 1321st, 1249th, 1145th, 1025th, and 877th, respectively; the pixels of the 14th to 41st columns which form the 12th row of the partly lacking pattern are turned on 735th, 703rd, 687th, 711th, 767th, 865th, 969th, 1049th, 1137th, 1209th, 1293rd, 1361st, 1417th, 1465th, 1505th, 1529th, 1537th, 1533rd, 1525th, 1493rd, 1457th, 1409th, 1345th, 1265th, 1177th, 1065th, 957th, and 785th, respectively; the pixels of the 12th to 41st columns which form the 13th row of the partly lacking pattern are turned on 775th, 667th, 631st, 595th, 607th, 643rd, 699th, 825th, 929th, 1041st, 1133rd, 1225th, 1313th, 1377th, 1433rd, 1489th, 1521st, 1545th, 1553rd, 1549th, 1541st, 1517th, 1481st, 1425th, 1369th, 1289th, 1201st, 1105th, 993rd, and 897th, respectively; the pixels of the 11th to 42nd columns which form the 14th row of the partly lacking pattern are turned on 683rd, 603rd, 567th, 523rd, 511th, 527th, 575th, 623rd, 727th, 887th, 991st, 1103rd, 1199th, 1283rd, 1367th, 1423rd, 1475th, 1515th, 1539th, 1555th, 1551st, 1535th, 1511th, 1479th, 1431st, 1375th, 1311th, 1215th, 1119th, 1035th, 927th, and 815th, respectively; the pixels of the 9th to 42nd columns which form the 15th row of the partly lacking pattern are turned on 719th, 615th, 535th, 495th, 455th, 431st, 427th, 447th, 487th, 543rd, 647th, 783rd, 967th, 1067th, 1175th, 1263rd, 1343rd, 1407th, 1455th, 1499th, 1531st, 1547th, 1543rd, 1527th, 1503rd, 1463rd, 1415th, 1359th, 1279th, 1207th, 1131st, 1047th, 947th, and 855th, respectively; the pixels of the 7th to 43rd columns which form the 16th row of the partly lacking pattern are turned on 743rd, 651st, 547th, 479th, 415th, 383rd, 359th, 343rd, 351st, 367th, 407th, 463rd, 559th, 671st, 879th, 1023rd, 1143rd, 1247th, 1319th, 1383rd, 1443rd, 1483rd, 1507th, 1523rd, 1519th, 1495th, 1471st, 1447th, 1391st, 1327th, 1255th, 1191st, 1107th, 1031st, 943rd, 871st, and 803rd, respectively; the pixels of the 6th to 43rd columns which form the 17th row of the partly lacking pattern are turned on 663rd, 579th, 499th, 435th, 375th, 315th, 295th, 275th, 247th, 279th, 303rd, 327th, 391st, 471st, 583rd, 747th, 951st, 1079th, 1183rd, 1275th, 1339th, 1403rd, 1451st, 1467th, 1491st, 1487th, 1459th, 1439th, 1399th, 1351st, 1287th, 1231st, 1151st, 1063rd, 983rd, 903rd, 839th, and 799th, respectively; the pixels of the 4th to 44th columns which form the 18th row of the partly lacking pattern are turned on 723rd, 639th, 555th, 467th, 395th, 335th, 283rd, 239th, 215th, 191st, 183rd, 199th, 231st, 271st, 319th, 399th, 503rd, 655th, 843rd, 1011th, 1127th, 1227th, 1307th, 1355th, 1395th, 1419th, 1435th, 1427th, 1411th, 1387th, 1335th, 1303rd, 1239th, 1167th, 1095th, 1015th, 935th, 863rd, 787th, 752nd, and 760th, respectively; the pixels of the 2nd to 45th columns which form the 19th row of the partly lacking pattern are turned on 763rd, 695th, 619th, 539th, 459th, 387th, 311th, 251st, 219th, 175th, 151st, 135th, 127th, 143rd, 167th, 207th, 259th, 339th, 439th, 551st, 715th, 919th, 1059th, 1163rd, 1243rd, 1299th, 1331st, 1363rd, 1379th, 1371st, 1347th, 1323rd, 1271st, 1223rd, 1159th, 1087th, 999th, 911th, 831st, 736th, 704th, 688th, 712th, and 768th, respectively; the pixels of the 1st to 45th columns which form the 20th row of the partly lacking pattern are turned on 755th, 707th, 635th, 571st, 483rd, 403rd, 323rd, 255th, 203rd, 155th, 115th, 103rd, 83rd, 71st, 95th, 111th, 159th, 223rd, 287th, 371st, 475th, 611th, 823rd, 979th, 1091st, 1171st, 1235th, 1259th, 1291st, 1315th, 1295th, 1267th, 1251st, 1187th, 1123rd, 1055th, 975th, 895th, 776th, 668th, 632nd, 596th, 608th, 644th, and 700th, respectively; the pixels of the 1st to 46th columns which form the 21st row of the partly lacking pattern are turned on 739th, 675th, 591st, 519th, 443rd, 363rd, 299th, 227th, 163rd, 107th, 79th, 59th, 47th, 43rd, 55th, 87th, 119th, 171st, 235th, 307th, 411th, 531st, 679th, 899th, 1003rd, 1099th, 1155th, 1195th, 1211th, 1219th, 1203rd, 1179th, 1147th, 1083rd, 1007th, 915th, 819th, 684th, 604th, 568th, 524th, 512th, 528th, 576th, 624th, and 728th, respectively; the pixels of the 2nd to 46th columns which form the 22nd row of the partly lacking pattern are turned on 691st, 587th, 507th, 419th, 347th, 263rd, 195th, 139th, 91st, 51st, 27th, 19th, 23rd, 31st, 63rd, 99th, 147th, 211th, 291st, 379th, 491st, 599th, 771st, 923rd, 1019th, 1075th, 1115th, 1139th, 1135th, 1111th, 1071st, 1027th, 955th, 847th, 720th, 616th, 536th, 496th, 456th, 432nd, 428th, 448th, 488th, 544th, and 648th, respectively; the pixels of the 2nd to 47th columns which form the 23rd row of the partly lacking pattern are turned on 731st, 627th, 515th, 423rd, 331st, 243rd, 179th, 123rd, 67th, 35th, 11th, 3rd, 7th, 15th, 39th, 75th, 131st, 187th, 267th, 355th, 451st, 563rd, 659th, 835th, 939th, 987th, 1039th, 1051st, 1043rd, 995th, 971st, 883rd, 744th, 652nd, 548th, 480th, 416th, 384th, 360th, 344th, 352nd, 368th, 408th, 464th, 560th, and 672nd, respectively; the pixels of the 3rd to 48th columns which form the 24th row of the partly lacking pattern are turned on 669th, 565th, 453rd, 357th, 273rd, 189th, 133rd, 81st, 41st, 17th, 1st, 5th, 21st, 45th, 77th, 125th, 181st, 245th, 341st, 437th, 521st, 629th, 741st, 867th, 907th, 959th, 963rd, 931st, 891st, 791st, 664th, 580th, 500th, 436th, 376th, 316th, 296th, 276th, 248th, 280th, 304th, 328th, 392nd, 472nd, 584th, and 748th, respectively; the pixels of the 3rd to 48th columns which form the 25th row of the partly lacking pattern are turned on 773rd, 589th, 489th, 381st, 293rd, 213th, 149th, 101st, 57th, 25th, 9th, 13th, 29th, 53rd, 93rd, 141st, 197th, 277th, 349th, 425th, 509th, 609th, 701st, 795th, 851st, 875th, 859th, 827th, 724th, 640th, 556th, 468th, 396th, 336th, 284th, 240th, 216th, 192nd, 184th, 200th, 232nd, 272nd, 320th, 400th, 504th, and 656th, respectively; the pixels of the 4th to 49th columns which form the 26th row of the partly lacking pattern are turned on 677th, 533rd, 413th, 309th, 237th, 173rd, 113th, 73rd, 49th, 33rd, 37th, 61st, 85th, 109th, 165th, 229th, 301st, 365th, 449th, 525th, 613th, 685th, 753rd, 807th, 811th, 764th, 696th, 620th, 540th, 460th, 388th, 312th, 252nd, 220th, 176th, 152nd, 136th, 128th, 144th, 168th, 208th, 260th, 340th, 440th, 552nd, and 716th, respectively; the pixels of the 5th to 49th columns which form the 27th row of the partly lacking pattern are turned on 605th, 477th, 373rd, 281st, 217th, 153rd, 105th, 89th, 65th, 69th, 97th, 117th, 157th, 205th, 269th, 325th, 405th, 493rd, 573rd, 653rd, 717th, 757th, 779th, 756th, 708th, 636th, 572nd, 484th, 404th, 324th, 256th, 204th, 156th, 116th, 104th, 84th, 72nd, 96th, 112th, 160th, 224th, 288th, 372nd, 476th, and 612th, respectively; the pixels of the 5th to 50th columns which form the 28th row of the partly lacking pattern are turned on 713th, 545th, 429th, 329th, 249th, 201st, 161st, 137th, 121st, 129th, 145th, 169th, 221st, 253rd, 317th, 389th, 461st, 541st, 621st, 693rd, 769th, 806th, 798th, 740th, 676th, 592nd, 520th, 444th, 364th, 300th, 228th, 164th, 108th, 80th, 60th, 48th, 44th, 56th, 88th, 120th, 172nd, 236th, 308th, 412th, 532nd, and 680th, respectively; the pixels of the 6th to 51st columns which form the 29th row of the partly lacking pattern are turned on 637th, 497th, 393rd, 313th, 257th, 225th, 193rd, 177th, 185th, 209th, 233rd, 285th, 333rd, 397th, 469th, 557th, 645th, 725th, 822nd, 854th, 870th, 846th, 790th, 692nd, 588th, 508th, 420th, 348th, 264th, 196th, 140th, 92nd, 52nd, 28th, 20th, 24th, 32nd, 64th, 100th, 148th, 212th, 292nd, 380th, 492nd, 600th, and 772nd, respectively; the pixels of the 6th to 51st columns which form the 30th row of the partly lacking pattern are turned on 733rd, 577th, 465th, 385th, 321st, 297th, 265th, 241st, 261st, 289th, 305th, 369th, 433rd, 501st, 581st, 661st, 782nd, 890th, 926th, 962nd, 950th, 914th, 858th, 732nd, 628th, 516th, 424th, 332nd, 244th, 180th, 124th, 68th, 36th, 12th, 4th, 8th, 16th, 40th, 76th, 132nd, 188th, 268th, 356th, 452nd, 564th, and 660th, respectively; the pixels of the 7th to 52nd columns which form the 31st row of the partly lacking pattern are turned on 657th, 553rd, 457th, 401st, 361st, 345th, 337th, 353rd, 377th, 409th, 473rd, 549th, 641st, 737th, 874th, 954th, 990th, 1034th, 1046th, 1030th, 982nd, 934th, 830th, 670th, 566th, 454th, 358th, 274th, 190th, 134th, 82nd, 42nd, 18th, 2nd, 6th, 22nd, 46th, 78th, 126th, 182nd, 246th, 342nd, 438th, 522nd, 630th, and 742nd, respectively; the pixels of the 8th to 52nd columns which form the 32nd row of the partly lacking pattern are turned on 633rd, 537th, 481st, 441st, 417th, 421st, 445th, 485th, 529th, 601st, 709th, 838th, 942nd, 1022nd, 1062nd, 1102nd, 1126th, 1130th, 1110th, 1070th, 1014th, 910th, 774th, 590th, 490th, 382nd, 294th, 214th, 150th, 102nd, 58th, 26th, 10th, 14th, 30th, 54th, 94th, 142nd, 198th, 278th, 350th, 426th, 510th, 610th, and 702nd, respectively; the pixels of the 8th to 53rd columns which form the 33rd row of the partly lacking pattern are turned on 721st, 617th, 569th, 517th, 505th, 513th, 561st, 585th, 673rd, 814th, 906th, 1010th, 1078th, 1142nd, 1174th, 1198th, 1214th, 1206th, 1190th, 1150th, 1094th, 998th, 886th, 678th, 534th, 414th, 310th, 238th, 174th, 114th, 74th, 50th, 34th, 38th, 62nd, 86th, 110th, 166th, 230th, 302nd, 366th, 450th, 526th, 614th, 686th, and 754th, respectively; the pixels of the 9th to 53rd columns which form the 34th row of the partly lacking pattern are turned on 689th, 649th, 597th, 593rd, 625th, 665th, 765th, 894th, 978th, 1058th, 1122nd, 1182nd, 1242nd, 1262nd, 1282nd, 1310th, 1278th, 1254th, 1230th, 1166th, 1086th, 974th, 810th, 606th, 478th, 374th, 282nd, 218th, 154th, 106th, 90th, 66th, 70th, 98th, 118th, 158th, 206th, 270th, 326th, 406th, 494th, 574th, 654th, 718th, and 758th, respectively; the pixels of the 9th to 52nd columns which form the 35th row of the partly lacking pattern are turned on 761st, 705th, 681st, 697th, 729th, 834th, 918th, 1002nd, 1090th, 1162nd, 1222nd, 1274th, 1318th, 1342nd, 1366th, 1374th, 1358th, 1326th, 1286th, 1238th, 1158th, 1054th, 902nd, 714th, 546th, 430th, 330th, 250th, 202nd, 162nd, 138th, 122nd, 130th, 146th, 170th, 222nd, 254th, 318th, 390th, 462nd, 542nd, 622nd, 694th, and 770th, respectively; the pixels of the 10th to 50th columns which form the 36th row of the partly lacking pattern are turned on 749th, 745th, 794th, 862nd, 938th, 1018th, 1098th, 1170th, 1246th, 1306th, 1338th, 1382nd, 1406th, 1422nd, 1430th, 1414th, 1390th, 1350th, 1298th, 1218th, 1118th, 1006th, 842nd, 638th, 498th, 394th, 314th, 258th, 226th, 194th, 178th, 186th, 210th, 234th, 286th, 334th, 398th, 470th, 558th, 646th, and 726th, respectively; the pixels of the 10th to 48th columns which form the 37th row of the partly lacking pattern are turned on 777th, 802nd, 850th, 922nd, 986th, 1074th, 1154th, 1234th, 1302nd, 1354th, 1402nd, 1442nd, 1454th, 1474th, 1486th, 1462nd, 1446th, 1398th, 1334th, 1270th, 1186th, 1082nd, 946th, 734th, 578th, 466th, 386th, 322nd, 298th, 266th, 242nd, 262nd, 290th, 306th, 370th, 434th, 502nd, 582nd, and 662nd, respectively; the pixels of the 11th to 47th columns which form the 38th row of the partly lacking pattern are turned on 818th, 882nd, 966th, 1038th, 1114th, 1194th, 1258th, 1330th, 1394th, 1450th, 1478th, 1498th, 1510th, 1514th, 1502nd, 1470th, 1438th, 1386th, 1322nd, 1250th, 1146th, 1026th, 878th, 658th, 554th, 458th, 402nd, 362nd, 346th, 338th, 354th, 378th, 410th, 474th, 550th, 642nd, and 738th, respectively; the pixels of the 12th to 45th columns which form the 39th row of the partly lacking pattern are turned on 866th, 970th, 1050th, 1138th, 1210th, 1294th, 1362nd, 1418th, 1466th, 1506th, 1530th, 1538th, 1534th, 1526th, 1494th, 1458th, 1410th, 1346th, 1266th, 1178th, 1066th, 958th, 786th, 634th, 538th, 482nd, 442nd, 418th, 422nd, 446th, 486th, 530th, 602nd, and 710th, respectively; the pixels of the 12th to 43rd columns which form the 40th row of the partly lacking pattern are turned on 826th, 930th, 1042nd, 1134th, 1226th, 1314th, 1378th, 1434th, 1490th, 1522nd, 1546th, 1554th, 1550th, 1542nd, 1518th, 1482nd, 1426th, 1370th, 1290th, 1202nd, 1106th, 994th, 898th, 722nd, 618th, 570th, 518th, 506th, 514th, 562nd, 586th, and 674th, respectively; the pixels of the 13th to 42nd columns which form the 41st row of the partly lacking pattern are turned on 888th, 992nd, 1104th, 1200th, 1284th, 1368th, 1424th, 1476th, 1516th, 1540th, 1556th, 1552nd, 1536th, 1512th, 1480th, 1432nd, 1376th, 1312th, 1216th, 1120th, 1036th, 928th, 816th, 690th, 650th, 598th, 594th, 626th, 666th, and 766th, respectively; the pixels of the 13th to 40th columns which form the 42nd row of the partly lacking pattern are turned on 784th, 968th, 1068th, 1176th, 1264th, 1344th, 1408th, 1456th, 1500th, 1532nd, 1548th, 1544th, 1528th, 1504th, 1464th, 1416th, 1360th, 1280th, 1208th, 1132nd, 1048th, 948th, 856th, 762nd, 706th, 682nd, 698th, and 730th, respectively; the pixels of the 14th to 38th columns which form the 43rd row of the partly lacking pattern are turned on 880th, 1024th, 1144th, 1248th, 1320th, 1384th, 1444th, 1484th, 1508th, 1524th, 1520th, 1496th, 1472nd, 1448th, 1392nd, 1328th, 1256th, 1192nd, 1108th, 1032nd, 944th, 872nd, 804th, 750th, and 746th, respectively; the pixels of the 15th to 37th columns which form the 44th row of the partly lacking pattern are turned on 952nd, 1080th, 1184th, 1276th, 1340th, 1404th, 1452nd, 1468th, 1492nd, 1488th, 1460th, 1440th, 1400th, 1352nd, 1288th, 1232nd, 1152nd, 1064th, 984th, 904th, 840th, 800th, and 778th, respectively; the pixels of the 15th to 35th columns which form the 45th row of the partly lacking pattern are turned on 844th, 1012th, 1128th, 1228th, 1308th, 1356th, 1396th, 1420th, 1436th, 1428th, 1412th, 1388th, 1336th, 1304th, 1240th, 1168th, 1096th, 1016th, 936th, 864th, and 788th, respectively; the pixels of the 16th to 33rd columns which form the 46th row of the partly lacking pattern are turned on 920th, 1060th, 1164th, 1244th, 1300th, 1332nd, 1364th, 1380th, 1372nd, 1348th, 1324th, 1272nd, 1224th, 1160th, 1088th, 1000th, 912th, and 832nd, respectively; the pixels of the 16th to 31st columns which form the 47th row of the partly lacking pattern are turned on 824th, 980th, 1092nd, 1172nd, 1236th, 1260th, 1292nd, 1316th, 1296th, 1268th, 1252nd, 1188th, 1124th, 1056th, 976th, and 896th, respectively; the pixels of the 17th to 30th columns which form the 48th row of the partly lacking pattern are turned on 900th, 1004th, 1100th, 1156th, 1196th, 1212th, 1220th, 1204th, 1180th, 1148th, 1084th, 1008th, 916th, and 820th, respectively; the pixels of the 18th to 28th columns which form the 49th row of the partly lacking pattern are turned on 924th, 1020th, 1076th, 1116th, 1140th, 1136th, 1112th, 1072nd, 1028th, 956th, and 848th, respectively; the pixels of the 18th to 26th columns which form the 50th row of the partly lacking pattern are turned on 836th, 940th, 988th, 1040th, 1052nd, 1044th, 996th, 972nd, and 884th, respectively; the pixels of the 19th to 25th columns which form the 51st row of the partly lacking pattern are turned on 868th, 908th, 960th, 964th, 932nd, 892nd, and 792nd, respectively; the pixels of the 19th to 23rd columns which form the 52nd row of the partly lacking pattern are turned on 796th, 852nd, 876th, 860th, and 828th, respectively; the pixels of the 20th to 21st columns which form the 53rd row of the partly lacking pattern are turned on 808th, and 812th, respectively; and the pixel of the 20th column which forms the 54th row of the partly lacking pattern is turned on 780th.

The binarization dither matrix pattern may be configured by exchanging the turn-on order set to arbitrary pixels in the binarization dither matrix pattern and a turn-on order set to pixels at point symmetric positions to the arbitrary pixels with respect to a specific point regarding halftone dots to which the arbitrary pixels belong for each other.

At the image forming step, the binarization dither matrix pattern may be used after rotated 90 degrees or 270 degrees.

The printing method may further comprise an image forming order changing step of changing an image forming order based on a lookup table, the image being formed, at the image forming step, based on the image forming order changed at the image forming order changing step.

According to another aspect of the present invention, there is provided a printing method, comprising a step of producing a binarization dither matrix pattern configured by arranging a plurality of pixels to be successively turned on in a matrix and having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order, and an image forming step of forming, based on inputted pixel values of a multi-value image, a color material for pixels of an object of formation of a color material decided by selecting pixels from the starting pixel of the turn-on order to a pixel to which a predetermined turn-on order number is set in the binarization dither matrix pattern in accordance with the turn-on order to form an image.

According to a further aspect of the present invention to provide a printing system, comprising a binarization processing section for performing a binarization process of a multi-value image based on a binarization dither matrix pattern, and a printing apparatus having an image forming section for forming an image on a medium based on a result of the binarization process performed by the binarization processing section, the binarization dither matrix pattern being configured by arranging a plurality of pixels to be successively turned on in a matrix, the binarization dither matrix pattern having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order.

The printing system may further comprise an image forming order changing section for changing an image forming order based on a lookup table, the image forming section forming the image based on the image forming order changed in the image forming order changing section.

According to a still further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, the binarization dither matrix pattern being configured by arranging a plurality of pixels to be successively turned on in a matrix, the binarization dither matrix pattern having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order.

According to a yet further aspect of the present invention, there is provided a printing apparatus, comprising a storage area for expanding a multi-value image, a binarization dither matrix pattern setting section for setting a binarization dither matrix pattern configured by arranging a plurality of pixels to be successively turned on in a matrix and having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order, a binarization processing section for selecting, in accordance with the turn-on order, pixels from the starting pixel of the turn-on order to a pixel to which a predetermined turn-on order number is set in the binarization dither matrix pattern set by the binarization dither matrix pattern setting section based on the pixel values of the multi-value image expanded in the storage area to decide pixels of an object of formation of a color material, and an image forming section for forming a color material for the pixels selected by the binarization processing section to form an image.

The printing method may further comprise an image forming order changing section for changing an image forming order based on a lookup table, the image forming section forming the image based on the image forming order changed by the image forming order changing section.

According to a yet further aspect of the present invention, there is provided a binarization dither matrix pattern for use for binarization of a multi-value image, comprising a plurality of pixels arranged in a matrix to be successively turned on, a plurality of specific points being provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order.

The binarization dither matrix pattern may be configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixel of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the 1st to 19th columns and the 21st to 53rd columns which form the 54th row of the rectangular pattern are cut out, a turn on order of the 1556 pixels being set such that the pixels of the 33rd to 34th columns which form the 1st row of the partly lacking pattern are turned on 403rd, and 399th, respectively; the pixels of the 31st to 35th columns which form the 2nd row of the partly lacking pattern are turned on 411th, 427th, 435th, 423rd, and 395th, respectively; the pixels of the 29th to 35th columns which form the 3rd row of the partly lacking pattern are turned on 391st, 445th, 463rd, 481st, 475th, 457th, and 429th, respectively; the pixels of the 28th to 36th columns which form the 4th row of the partly lacking pattern are turned on 437th, 477th, 495th, 517th, 523rd, 515th, 491st, 467th, and 415th, respectively; the pixels of the 26th to 36th columns which form the 5th row of the partly lacking pattern are turned on 419th, 471st, 511th, 531st, 551st, 563rd, 565th, 555th, 535th, 507th, and 455th, respectively; the pixels of the 24th to 37th columns which form the 6th row of the partly lacking pattern are turned on 407th, 453rd, 505th, 539th, 571st, 587th, 599th, 607th, 603rd, 595th, 575th, 547th, 499th, and 443rd, respectively; the pixels of the 23rd to 38th columns which form the 7th row of the partly lacking pattern are turned on 447th, 489th, 529th, 561st, 591st, 621st, 631st, 641st, 655th, 639th, 627th, 615th, 583rd, 543rd, 487th, and 405th, respectively; the pixels of the 21st to 38th columns which form the 8th row of the partly lacking pattern are turned on 417th, 459th, 501st, 545th, 581st, 611th, 637th, 659th, 671st, 683rd, 687th, 679th, 663rd, 643rd, 619th, 579th, 527th, and 451st, respectively; the pixels of the 19th to 39th columns which form the 9th row of the partly lacking pattern are turned on 397th, 431st, 469th, 509th, 549th, 585th, 1623rd, 653rd, 669th, 691st, 703rd, 711th, 715th, 707th, 695th, 675th, 649th, 609th, 559th, 503rd, and 421st, respectively; the pixels of the 18th to 39th columns which form the 10th row of the partly lacking pattern are turned on 401st, 425th, 461st, 493rd, 537th, 577th, 617th, 651st, 677th, 701st, 721st, 727th, 737th, 743rd, 731st, 723rd, 699th, 667th, 635th, 593rd, 541st, and 473rd, respectively; the pixels of the 16th to 40th columns which form the 11th row of the partly lacking pattern are turned on 376th, 380th, 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, and 439th, respectively; the pixels of the 14th to 41st columns which form the 12th row of the partly lacking pattern are turned on 368th, 352nd, 344th, 356th, 384th, 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, and 393rd, respectively; the pixels of the 12th to 41st columns which form the 13th row of the partly lacking pattern are turned on 388th, 334th, 316th, 298th, 304th, 322nd, 350th, 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, and 449th, respectively; the pixels of the 11th to 42nd columns which form the 14th row of the partly lacking pattern are turned on 342nd, 302nd, 284th, 262nd, 256th, 264th, 288th, 312th, 364th, 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, and 408th, respectively; the pixels of the 9th to 42nd columns which form the 15th row of the partly lacking pattern are turned on 360th, 308th, 268th, 248th, 228th, 216th, 214th, 224th, 244th, 272nd, 324th, 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, and 428th, respectively; the pixels of the 7th to 43rd columns which form the 16th row of the partly lacking pattern are turned on 372nd, 326th, 274th, 240th, 208th, 192nd, 180th, 172nd, 176th, 184th, 204th, 232nd, 280th, 336th, 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, and 402nd, respectively; the pixels of the 6th to 43rd columns which form the 17th row of the partly lacking pattern are turned on 332nd, 290th, 250th, 218th, 188th, 158th, 148th, 138th, 124th, 140th, 152nd, 164th, 196th, 236th, 292nd, 374th, 476th, 540th, 592nd, 638th, 670th, 702nd, 726th, 734th, 746th, 744th, 730th, 720th, 700th, 676th, 644th, 616th, 576th, 532nd, 492nd, 452nd, 420th, and 400th, respectively; the pixels of the 4th to 44th columns which form the 18th row of the partly lacking pattern are turned on 362nd, 320th, 278th, 234th, 198th, 168th, 142nd, 120th, 108th, 96th, 92nd, 100th, 116th, 136th, 160th, 200th, 252nd, 328th, 422nd, 506th, 564th, 614th, 654th, 678th, 698th, 710th, 718th, 714th, 706th, 694th, 668th, 652nd, 620th, 584th, 548th, 508th, 468th, 432nd, 394th, 376th, and 380th, respectively; the pixels of the 2nd to 45th columns which form the 19th row of the partly lacking pattern are turned on 382nd, 348th, 310th, 270th, 230th, 194th, 156th, 126th, 110th, 88th, 76th, 68th, 64th, 72nd, 84th, 104th, 130th, 170th, 220th, 276th, 358th, 460th, 530th, 582nd, 622nd, 650th, 666th, 682nd, 690th, 686th, 674th, 662nd, 636th, 612th, 580th, 544th, 500th, 456th, 416th, 368th, 352nd, 344th, 356th, and 384th, respectively; the pixels of the 1st to 45th columns which form the 20th row of the partly lacking pattern are turned on 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, 306th, 412th, 490th, 546th, 586th, 618th, 630th, 646th, 658th, 648th, 634th, 626th, 594th, 562nd, 528th, 488th, 448th, 388th, 334th, 316th, 298th, 304th, 322nd, and 350th, respectively; the pixels of the 1st to 46th columns which form the 21st row of the partly lacking pattern are turned on 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, 340th, 450th, 502nd, 550th, 578th, 598th, 606th, 610th, 602nd, 590th, 574th, 542nd, 504th, 458th, 410th, 342nd, 302nd, 284th, 262nd, 256th, 264th, 288th, 312th, and 364th, respectively; the pixels of the 2nd to 46th columns which form the 22nd row of the partly lacking pattern are turned on 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, 386th, 462nd, 510th, 538th, 558th, 570th, 568th, 556th, 536th, 514th, 478th, 424th, 360th, 308th, 268th, 248th, 228th, 216th, 214th, 224th, 244th, 272nd, and 324th, respectively; the pixels of the 2nd to 47th columns which form the 23rd row of the partly lacking pattern are turned on 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, 330th, 418th, 470th, 494th, 520th, 526th, 522nd, 498th, 486th, 442nd, 372nd, 326th, 274th, 240th, 208th, 192nd, 180th, 172nd, 176th, 184th, 204th, 232nd, 280th, and 336th, respectively; the pixels of the 3rd to 48th columns which form the 24th row of the partly lacking pattern are turned on 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, 371st, 434th, 454th, 480th, 482nd, 466th, 446th, 396th, 332nd, 290th, 250th, 218th, 188th, 158th, 148th, 138th, 124th, 140th, 152nd, 164th, 196th, 236th, 292nd, and 374th, respectively; the pixels of the 3rd to 48th columns which form the 25th row of the partly lacking pattern are turned on 387th, 295th, 245th, 191st, 147th, 107th, 75th, 51st, 29th, 13th, 5th, 7th, 15th, 27th, 47th, 71st, 99th, 139th, 175th, 213th, 255th, 305th, 351st, 398th, 426th, 438th, 430th, 414th, 362nd, 320th, 278th, 234th, 198th, 168th, 142nd, 120th, 108th, 96th, 92nd, 100th, 116th, 136th, 160th, 200th, 252nd, and 328th, respectively; the pixels of the 4th to 49th columns which form the 26th row of the partly lacking pattern are turned on 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, 377th, 404th, 406th, 382nd, 348th, 310th, 270th, 230th, 194th, 156th, 126th, 110th, 88th, 76th, 68th, 64th, 72nd, 84th, 104th, 130th, 170th, 220th, 276th, and 358th, respectively; the pixels of the 5th to 49th columns which form the 27th row of the partly lacking pattern are turned on 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, 379th, 390th, 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, and 306th, respectively; the pixels of the 5th to 50th columns which form the 28th row of the partly lacking pattern are turned on 357th, 273rd, 215th, 165th, 125th, 101st, 81st, 69th, 61st, 65th, 73rd, 85th, 111th, 127th, 159th, 195th, 231st, 271st, 311th, 347th, 385th, 403rd, 399th, 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, and 340th, respectively; the pixels of the 6th to 51st columns which form the 29th row of the partly lacking pattern are turned on 319th, 249th, 197th, 157th, 129th, 113th, 97th, 89th, 93rd, 105th, 117th, 143rd, 167th, 199th, 235th, 279th, 323rd, 363rd, 411th, 427th, 435th, 423rd, 395th, 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, and 386th, respectively; the pixels of the 6th to 51st columns which form the 30th row of the partly lacking pattern are turned on 367th, 289th, 233rd, 193rd, 161st, 149th, 133rd, 121st, 131st, 145th, 153rd, 185th, 217th, 251st, 291st, 331st, 391st, 445th, 463rd, 481st, 475th, 457th, 429th, 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, and 330th, respectively; the pixels of the 7th to 52nd columns which form the 31st row of the partly lacking pattern are turned on 329th, 277th, 229th, 201st, 181st, 173rd, 169th, 177th, 189th, 205th, 237th, 275th, 321st, 369th, 437th, 477th, 495th, 517th, 523rd, 515th, 491st, 467th, 415th, 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, and 371st, respectively; the pixels of the 8th to 52nd columns which form the 32nd row of the partly lacking pattern are turned on 317th, 269th, 241st, 221st, 209th, 211th, 223rd, 243rd, 265th, 301st, 355th, 419th, 471st, 511th, 531st, 551st, 563rd, 565th, 555th, 535th, 507th, 455th, 387th, 295th, 245th, 191st, 147th, 107th, 75th, 51st, 29th, 13th, 5th, 7th, 15th, 27th, 47th, 71st, 99th, 139th, 175th, 213th, 255th, 305th, and 351st, respectively; the pixels of the 8th to 53rd columns which form the 33rd row of the partly lacking pattern are turned on 361st, 309th, 285th, 259th, 253rd, 257th, 281st, 293rd, 337th, 407th, 453rd, 505th, 539th, 571st, 587th, 599th, 607th, 603rd, 595th, 575th, 547th, 499th, 443rd, 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, and 377th, respectively; the pixels of the 9th to 53rd columns which form the 34th row of the partly lacking pattern are turned on 345th, 325th, 299th, 297th, 313th, 333rd, 383rd, 447th, 489th, 529th, 561st, 591st, 621st, 631st, 641st, 655th, 639th, 627th, 615th, 583rd, 543rd, 487th, 405th, 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, and 379th, respectively; the pixels of the 9th to 52nd columns which form the 35th row of the partly lacking pattern are turned on 381st, 353rd, 341st, 349th, 365th, 417th, 459th, 501st, 545th, 581st, 611th, 637th, 659th, 671st, 683rd, 687th, 679th, 663rd, 643rd, 619th, 579th, 527th, 451st, 357th, 273rd, 215th, 165th, 125th, 101st, 81st, 69th, 61st, 65th, 73rd, 85th, 111th, 127th, 159th, 195th, 231st, 271st, 311th, 347th, and 385th, respectively; the pixels of the 10th to 50th columns which form the 36th row of the partly lacking pattern are turned on 375th, 373rd, 397th, 431st, 469th, 509th, 549th, 585th, 623rd, 653rd, 669th, 691st, 703rd, 711th, 715th, 707th, 695th, 675th, 649th, 609th, 559th, 503rd, 421st, 319th, 249th, 197th, 157th, 129th, 113th, 97th, 89th, 93rd, 105th, 117th, 143rd, 167th, 199th, 235th, 279th, 323rd, and 363rd, respectively; the pixels of the 10th to 48th columns which form the 37th row of the partly lacking pattern are turned on 389th, 401st, 425th, 461st, 493rd, 537th, 577th, 617th, 651st, 677th, 701st, 721st, 727th, 737th, 743rd, 731st, 723rd, 699th, 667th, 635th, 593rd, 541st, 473rd, 367th, 289th, 233rd, 193rd, 161st, 149th, 133rd, 121st, 131st, 145th, 153rd, 185th, 217th, 251st, 291st, and 331st, respectively; the pixels of the 11th to 47th columns which form the 38th row of the partly lacking pattern are turned on 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, 439th, 329th, 277th, 229th, 201st, 181st, 173rd, 169th, 177th, 189th, 205th, 237th, 275th, 321st, and 369th, respectively; the pixels of the 12th to 45th columns which form the 39th row of the partly lacking pattern are turned on 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, 393rd, 317th, 269th, 241st, 221st, 209th, 211th, 223rd, 243rd, 265th, 301st, and 355th, respectively; the pixels of the 12th to 43rd columns which form the 40th row of the partly lacking pattern are turned on 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, 449th, 361st, 309th, 285th, 259th, 253rd, 257th, 281st, 293rd, and 337th, respectively; the pixels of the 13th to 42nd columns which form the 41st row of the partly lacking pattern are turned on 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, 408th, 345th, 325th, 299th, 297th, 313th, 333rd, and 383rd, respectively; the pixels of the 13th to 40th columns which form the 42nd row of the partly lacking pattern are turned on 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, 428th, 381st, 353rd, 341st, 349th, and 365th, respectively; the pixels of the 14th to 38th columns which form the 43rd row of the partly lacking pattern are turned on 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, 402nd, 375th, and 373rd, respectively; the pixels of the 15th to 37th columns which form the 44th row of the partly lacking pattern are turned on 476th, 540th, 592nd, 638th, 670th, 702nd, 726th, 734th, 746th, 744th, 730th, 720th, 700th, 676th, 644th, 616th, 576th, 532nd, 492nd, 452nd, 420th, 400th, and 389th, respectively; the pixels of the 15th to 35th columns which form the 45th row of the partly lacking pattern are turned on 422nd, 506th, 564th, 614th, 654th, 678th, 698th, 710th, 718th, 714th, 706th, 694th, 668th, 652nd, 620th, 584th, 548th, 508th, 468th, 432nd, and 394th, respectively; the pixels of the 16th to 33rd columns which form the 46th row of the partly lacking pattern are turned on 460th, 530th, 582nd, 622nd, 650th, 666th, 682nd, 690th, 686th, 674th, 662nd, 636th, 612th, 580th, 544th, 500th, 456th, and 416th, respectively; the pixels of the 16th to 31st columns which form the 47th row of the partly lacking pattern are turned on 412th, 490th, 546th, 586th, 618th, 630th, 646th, 658th, 648th, 634th, 626th, 594th, 562nd, 528th, 488th, and 448th, respectively; the pixels of the 17th to 30th columns which form the 48th row of the partly lacking pattern are turned on 450th, 502nd, 550th, 578th, 598th, 606th, 610th, 602nd, 590th, 574th, 542nd, 504th, 458th, and 410th, respectively; the pixels of the 18th to 28th columns which form the 49th row of the partly lacking pattern are turned on 462nd, 510th, 538th, 558th, 570th, 568th, 556th, 536th, 514th, 478th, and 424th, respectively; the pixels of the 18th to 26th columns which form the 50th row of the partly lacking pattern are turned on 418th, 470th, 494th, 520th, 526th, 522nd, 498th, 486th, and 442nd, respectively; the pixels of the 19th to 25th columns which form the 51st row of the partly lacking pattern are turned on 434th, 454th, 480th, 482nd, 466th, 446th, and 396th, respectively; the pixels of the 19th to 23rd columns which form the 52nd row of the partly lacking pattern are turned on 398th, 426th, 438th, 430th, and 414th, respectively; the pixels of the 20th to 21st columns which form the 53rd row of the partly lacking pattern are turned on 404th, and 406th, respectively; and the pixel of the 20th column which forms the 54th row of the partly lacking pattern is turned on 390th.

Alternatively, the binarization dither matrix pattern may be configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixels of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the pixels of the 1st to 19th columns and the 21st to 53rd columns which form the 54th row of the rectangular pattern are cut out, a turn on order of the 1556 pixels being set such that the pixels of the 33rd to 34th columns which form the 1st row of the partly lacking pattern are turned on 805th, and 797th, respectively; the pixels of the 31st to 35th columns which form the 2nd row of the partly lacking pattern are turned on 821st, 853rd, 869th, 845th, and 789th, respectively; the pixels of the 29th to 35th columns which form the 3rd row of the partly lacking pattern are turned on 781st, 889th, 925th, 961st, 949th, 913th, and 857th, respectively; the pixels of the 28th to 36th columns which form the 4th row of the partly lacking pattern are turned on 873rd, 953rd, 989th, 1033rd, 1045th, 1029th, 981st, 933rd, and 829th, respectively; the pixels of the 26th to 36th columns which form the 5th row of the partly lacking pattern are turned on 837th, 941st, 1021st, 1061st, 1101st, 1125th, 1129th, 1109th, 1069th, 1013th, and 909th, respectively; the pixels of the 24th to 37th columns which form the 6th row of the partly lacking pattern are turned on 813th, 905th, 1009th, 1077th, 1141st, 1173rd, 1197th, 1213th, 1205th, 1189th, 1149th, 1093rd, 997th, and 885th, respectively; the pixels of the 23rd to 38th columns which form the 7th row of the partly lacking pattern are turned on 893rd, 977th, 1057th, 1121st, 1181st, 1241st, 1261st, 1281st, 1309th, 1277th, 1253rd, 1229th, 1165th, 1085th, 973rd, and 809th, respectively; the pixels of the 21st to 38th columns which form the 8th row of the partly lacking pattern are turned on 833rd, 917th, 1001st, 1089th, 1161st, 1221st, 1273rd, 1317th, 1341st, 1365th, 1373rd, 1357th, 1325th, 1285th, 1237th, 1157th, 1053rd, and 901st, respectively; the pixels of the 19th to 39th columns which form the 9th row of the partly lacking pattern are turned on 793rd, 861st, 937th, 1017th, 1097th, 1169th, 1245th, 1305th, 1337th, 1381st, 1405th, 1421st, 1429th, 1413th, 1389th, 1349th, 1297th, 1217th, 1117th, 1005th, and 841st, respectively; the pixels of the 18th to 39th columns which form the 10th row of the partly lacking pattern are turned on 801st, 849th, 921st, 985th, 1073rd, 1153rd, 1233rd, 1301st, 1353rd, 1401st, 1441st, 1453rd, 1473rd, 1485th, 1461st, 1445th, 1397th, 1333rd, 1269th, 1185th, 1081st, and 945th, respectively; the pixels of the 16th to 40th columns which form the 11th row of the partly lacking pattern are turned on 751st, 759th, 817th, 881st, 965th, 1037th, 1113th, 1193rd, 1257th, 1329th, 1393rd, 1449th, 1477th, 1497th, 1509th, 1513th, 1501st, 1469th, 1437th, 1385th, 1321st, 1249th, 1145th, 1025th, and 877th, respectively; the pixels of the 14th to 41st columns which form the 12th row of the partly lacking pattern are turned on 735th, 703rd, 687th, 711th, 767th, 865th, 969th, 1049th, 1137th, 1209th, 1293rd, 1361st, 1417th, 1465th, 1505th, 1529th, 1537th, 1533rd, 1525th, 1493rd, 1457th, 1409th, 1345th, 1265th, 1177th, 1065th, 957th, and 785th, respectively; the pixels of the 12th to 41st columns which form the 13th row of the partly lacking pattern are turned on 775th, 667th, 631st, 595th, 607th, 643rd, 699th, 825th, 929th, 1041st, 1133rd, 1225th, 1313th, 1377th, 1433rd, 1489th, 1521st, 1545th, 1553rd, 1549th, 1541st, 1517th, 1481st, 1425th, 1369th, 1289th, 1201st, 1105th, 993rd, and 897th, respectively; the pixels of the 11th to 42nd columns which form the 14th row of the partly lacking pattern are turned on 683rd, 603rd, 567th, 523rd, 511th, 527th, 575th, 623rd, 727th, 887th, 991st, 1103rd, 1199th, 1283rd, 1367th, 1423rd, 1475th, 1515th, 1539th, 1555th, 1551st, 1535th, 1511th, 1479th, 1431st, 1375th, 1311th, 1215th, 1119th, 1035th, 927th, and 815th, respectively; the pixels of the 9th to 42nd columns which form the 15th row of the partly lacking pattern are turned on 719th, 615th, 535th, 495th, 455th, 431st, 427th, 447th, 487th, 543rd, 647th, 783rd, 967th, 1067th, 1175th, 1263rd, 1343rd, 1407th, 1455th, 1499th, 1531st, 1547th, 1543rd, 1527th, 1503rd, 1463rd, 1415th, 1359th, 1279th, 1207th, 1131st, 1047th, 947th, and 855th, respectively; the pixels of the 7th to 43rd columns which form the 16th row of the partly lacking pattern are turned on 743rd, 651st, 547th, 479th, 415th, 383rd, 359th, 343rd, 351st, 367th, 407th, 463rd, 559th, 671st, 879th, 1023rd, 1143rd, 1247th, 1319th, 1383rd, 1443rd, 1483rd, 1507th, 1523rd, 1519th, 1495th, 1471st, 1447th, 1391st, 1327th, 1255th, 1191st, 1107th, 1031st, 943rd, 871st, and 803rd, respectively; the pixels of the 6th to 43rd columns which form the 17th row of the partly lacking pattern are turned on 663rd, 579th, 499th, 435th, 375th, 315th, 295th, 275th, 247th, 279th, 303rd, 327th, 391st, 471st, 583rd, 747th, 951st, 1079th, 1183rd, 1275th, 1339th, 1403rd, 1451st, 1467th, 1491st, 1487th, 1459th, 1439th, 1399th, 1351st, 1287th, 1231st, 1151st, 1063rd, 983rd, 903rd, 839th, and 799th, respectively; the pixels of the 4th to 44th columns which form the 18th row of the partly lacking pattern are turned on 723rd, 639th, 555th, 467th, 395th, 335th, 283rd, 239th, 215th, 191st, 183rd, 199th, 231st, 271st, 319th, 399th, 503rd, 655th, 843rd, 1011th, 1127th, 1227th, 1307th, 1355th, 1395th, 1419th, 1435th, 1427th, 1411th, 1387th, 1335th, 1303rd, 1239th, 1167th, 1095th, 1015th, 935th, 863rd, 787th, 752nd, and 760th, respectively; the pixels of the 2nd to 45th columns which form the 19th row of the partly lacking pattern are turned on 763rd, 695th, 619th, 539th, 459th, 387th, 311th, 251st, 219th, 175th, 151st, 135th, 127th, 143rd, 167th, 207th, 259th, 339th, 439th, 551st, 715th, 919th, 1059th, 1163rd, 1243rd, 1299th, 1331st, 1363rd, 1379th, 1371st, 1347th, 1323rd, 1271st, 1223rd, 1159th, 1087th, 999th, 911th, 831st, 736th, 704th, 688th, 712th, and 768th, respectively; the pixels of the 1st to 45th columns which form the 20th row of the partly lacking pattern are turned on 755th, 707th, 635th, 571st, 483rd, 403rd, 323rd, 255th, 203rd, 155th, 115th, 103rd, 83rd, 71st, 95th, 111th, 159th, 223rd, 287th, 371st, 475th, 611th, 823rd, 979th, 1091st, 1171st, 1235th, 1259th, 1291st, 1315th, 1295th, 1267th, 1251st, 1187th, 1123rd, 1055th, 975th, 895th, 776th, 668th, 632nd, 596th, 608th, 644th, and 700th, respectively; the pixels of the 1st to 46th columns which form the 21st row of the partly lacking pattern are turned on 739th, 675th, 591st, 519th, 443rd, 363rd, 299th, 227th, 163rd, 107th, 79th, 59th, 47th, 43rd, 55th, 87th, 119th, 171st, 235th, 307th, 411th, 531st, 679th, 899th, 1003rd, 1099th, 1155th, 1195th, 1211th, 1219th, 1203rd, 1179th, 1147th, 1083rd, 1007th, 915th, 819th, 684th, 604th, 568th, 524th, 512th, 528th, 576th, 624th, and 728th, respectively; the pixels of the 2nd to 46th columns which form the 22nd row of the partly lacking pattern are turned on 691st, 587th, 507th, 419th, 347th, 263rd, 195th, 139th, 91st, 51st, 27th, 19th, 23rd, 31st, 63rd, 99th, 147th, 211th, 291st, 379th, 491st, 599th, 771st, 923rd, 1019th, 1075th, 1115th, 1139th, 1135th, 1111th, 1071st, 1027th, 955th, 847th, 720th, 616th, 536th, 496th, 456th, 432nd, 428th, 448th, 488th, 544th, and 648th, respectively; the pixels of the 2nd to 47th columns which form the 23rd row of the partly lacking pattern are turned on 731st, 627th, 515th, 423rd, 331st, 243rd, 179th, 123rd, 67th, 35th, 11th, 3rd, 7th, 15th, 39th, 75th, 131st, 187th, 267th, 355th, 451st, 563rd, 659th, 835th, 939th, 987th, 1039th, 1051st, 1043rd, 995th, 971st, 883rd, 744th, 652nd, 548th, 480th, 416th, 384th, 360th, 344th, 352nd, 368th, 408th, 464th, 560th, and 672nd, respectively; the pixels of the 3rd to 48th columns which form the 24th row of the partly lacking pattern are turned on 669th, 565th, 453rd, 357th, 273rd, 189th, 133rd, 81st, 41st, 17th, 1st, 5th, 21st, 45th, 77th, 125th, 181st, 245th, 341st, 437th, 521st, 629th, 741st, 867th, 907th, 959th, 963rd, 931st, 891st, 791st, 664th, 580th, 500th, 436th, 376th, 316th, 296th, 276th, 248th, 280th, 304th, 328th, 392nd, 472nd, 584th, and 748th, respectively; the pixels of the 3rd to 48th columns which form the 25th row of the partly lacking pattern are turned on 773rd, 589th, 489th, 381st, 293rd, 213th, 149th, 101st, 57th, 25th, 9th, 13th, 29th, 53rd, 93rd, 141st, 197th, 277th, 349th, 425th, 509th, 609th, 701st, 795th, 851st, 875th, 859th, 827th, 724th, 640th, 556th, 468th, 396th, 336th, 284th, 240th, 216th, 192nd, 184th, 200th, 232nd, 272nd, 320th, 400th, 504th, and 656th, respectively; the pixels of the 4th to 49th columns which form the 26th row of the partly lacking pattern are turned on 677th, 533rd, 413th, 309th, 237th, 173rd, 113th, 73rd, 49th, 33rd, 37th, 61st, 85th, 109th, 165th, 229th, 301st, 365th, 449th, 525th, 613th, 685th, 753rd, 807th, 811th, 764th, 696th, 620th, 540th, 460th, 388th, 312th, 252nd, 220th, 176th, 152nd, 136th, 128th, 144th, 168th, 208th, 260th, 340th, 440th, 552nd, and 716th, respectively; the pixels of the 5th to 49th columns which form the 27th row of the partly lacking pattern are turned on 605th, 477th, 373rd, 281st, 217th, 153rd, 105th, 89th, 65th, 69th, 97th, 117th, 157th, 205th, 269th, 325th, 405th, 493rd, 573rd, 653rd, 717th, 757th, 779th, 756th, 708th, 636th, 572nd, 484th, 404th, 324th, 256th, 204th, 156th, 116th, 104th, 84th, 72nd, 96th, 112th, 160th, 224th, 288th, 372nd, 476th, and 612th, respectively; the pixels of the 5th to 50th columns which form the 28th row of the partly lacking pattern are turned on 713th, 545th, 429th, 329th, 249th, 201st, 161st, 137th, 121st, 129th, 145th, 169th, 221st, 253rd, 317th, 389th, 461st, 541st, 621st, 693rd, 769th, 806th, 798th, 740th, 676th, 592nd, 520th, 444th, 364th, 300th, 228th, 164th, 108th, 80th, 60th, 48th, 44th, 56th, 88th, 120th, 172nd, 236th, 308th, 412th, 532nd, and 680th, respectively; the pixels of the 6th to 51st columns which form the 29th row of the partly lacking pattern are turned on 637th, 497th, 393rd, 313th, 257th, 225th, 193rd, 177th, 185th, 209th, 233rd, 285th, 333rd, 397th, 469th, 557th, 645th, 725th, 822nd, 854th, 870th, 846th, 790th, 692nd, 588th, 508th, 420th, 348th, 264th, 196th, 140th, 92nd, 52nd, 28th, 20th, 24th, 32nd, 64th, 100th, 148th, 212th, 292nd, 380th, 492nd, 600th, and 772nd, respectively; the pixels of the 6th to 51st columns which form the 30th row of the partly lacking pattern are turned on 733rd, 577th, 465th, 385th, 321st, 297th, 265th, 241st, 261st, 289th, 305th, 369th, 433rd, 501st, 581st, 661st, 782nd, 890th, 926th, 962nd, 950th, 914th, 858th, 732nd, 628th, 516th, 424th, 332nd, 244th, 180th, 124th, 68th, 36th, 12th, 4th, 8th, 16th, 40th, 76th, 132nd, 188th, 268th, 356th, 452nd, 564th, and 660th, respectively; the pixels of the 7th to 52nd columns which form the 31st row of the partly lacking pattern are turned on 657th, 553rd, 457th, 401st, 361st, 345th, 337th, 353rd, 377th, 409th, 473rd, 549th, 641st, 737th, 874th, 954th, 990th, 1034th, 1046th, 1030th, 982nd, 934th, 830th, 670th, 566th, 454th, 358th, 274th, 190th, 134th, 82nd, 42nd, 18th, 2nd, 6th, 22nd, 46th, 78th, 126th, 182nd, 246th, 342nd, 438th, 522nd, 630th, and 742nd, respectively; the pixels of the 8th to 52nd columns which form the 32nd row of the partly lacking pattern are turned on 633rd, 537th, 481st, 441st, 417th, 421st, 445th, 485th, 529th, 601st, 709th, 838th, 942nd, 1022nd, 1062nd, 1102nd, 1126th, 1130th, 1110th, 1070th, 1014th, 910th, 774th, 590th, 490th, 382nd, 294th, 214th, 150th, 102nd, 58th, 26th, 10th, 14th, 30th, 54th, 94th, 142nd, 198th, 278th, 350th, 426th, 510th, 610th, and 702nd, respectively; the pixels of the 8th to 53rd columns which form the 33rd row of the partly lacking pattern are turned on 721st, 617th, 569th, 517th, 505th, 513th, 561st, 585th, 673rd, 814th, 906th, 1010th, 1078th, 1142nd, 1174th, 1198th, 1214th, 1206th, 1190th, 1150th, 1094th, 998th, 886th, 678th, 534th, 414th, 310th, 238th, 174th, 114th, 74th, 50th, 34th, 38th, 62nd, 86th, 110th, 166th, 230th, 302nd, 366th, 450th, 526th, 614th, 686th, and 754th, respectively; the pixels of the 9th to 53rd columns which form the 34th row of the partly lacking pattern are turned on 689th, 649th, 597th, 593rd, 625th, 665th, 765th, 894th, 978th, 1058th, 1122nd, 1182nd, 1242nd, 1262nd, 1282nd, 1310th, 1278th, 1254th, 1230th, 1166th, 1086th, 974th, 810th, 606th, 478th, 374th, 282nd, 218th, 154th, 106th, 90th, 66th, 70th, 98th, 118th, 158th, 206th, 270th, 326th, 406th, 494th, 574th, 654th, 718th, and 758th, respectively; the pixels of the 9th to 52nd columns which form the 35th row of the partly lacking pattern are turned on 761st, 705th, 681st, 697th, 729th, 834th, 918th, 1002nd, 1090th, 1162nd, 1222nd, 1274th, 1318th, 1342nd, 1366th, 1374th, 1358th, 1326th, 1286th, 1238th, 1158th, 1054th, 902nd, 714th, 546th, 430th, 330th, 250th, 202nd, 162nd, 138th, 122nd, 130th, 146th, 170th, 222nd, 254th, 318th, 390th, 462nd, 542nd, 622nd, 694th, and 770th, respectively; the pixels of the 10th to 50th columns which form the 36th row of the partly lacking pattern are turned on 749th, 745th, 794th, 862nd, 938th, 1018th, 1098th, 1170th, 1246th, 1306th, 1338th, 1382nd, 1406th, 1422nd, 1430th, 1414th, 1390th, 1350th, 1298th, 1218th, 1118th, 1006th, 842nd, 638th, 498th, 394th, 314th, 258th, 226th, 194th, 178th, 186th, 210th, 234th, 286th, 334th, 398th, 470th, 558th, 646th, and 726th, respectively; the pixels of the 10th to 48th columns which form the 37th row of the partly lacking pattern are turned on 777th, 802nd, 850th, 922nd, 986th, 1074th, 1154th, 1234th, 1302nd, 1354th, 1402nd, 1442nd, 1454th, 1474th, 1486th, 1462nd, 1446th, 1398th, 1334th, 1270th, 1186th, 1082nd, 946th, 734th, 578th, 466th, 386th, 322nd, 298th, 266th, 242nd, 262nd, 290th, 306th, 370th, 434th, 502nd, 582nd, and 662nd, respectively; the pixels of the 11th to 47th columns which form the 38th row of the partly lacking pattern are turned on 818th, 882nd, 966th, 1038th, 1114th, 1194th, 1258th, 1330th, 1394th, 1450th, 1478th, 1498th, 1510th, 1514th, 1502nd, 1470th, 1438th, 1386th, 1322nd, 1250th, 1146th, 1026th, 878th, 658th, 554th, 458th, 402nd, 362nd, 346th, 338th, 354th, 378th, 410th, 474th, 550th, 642nd, and 738th, respectively; the pixels of the 12th to 45th columns which form the 39th row of the partly lacking pattern are turned on 866th, 970th, 1050th, 1138th, 1210th, 1294th, 1362nd, 1418th, 1466th, 1506th, 1530th, 1538th, 1534th, 1526th, 1494th, 1458th, 1410th, 1346th, 1266th, 1178th, 1066th, 958th, 786th, 634th, 538th, 482nd, 442nd, 418th, 422nd, 446th, 486th, 530th, 602nd, and 710th, respectively; the pixels of the 12th to 43rd columns which form the 40th row of the partly lacking pattern are turned on 826th, 930th, 1042nd, 1134th, 1226th, 1314th, 1378th, 1434th, 1490th, 1522nd, 1546th, 1554th, 1550th, 1542nd, 1518th, 1482nd, 1426th, 1370th, 1290th, 1202nd, 1106th, 994th, 898th, 722nd, 618th, 570th, 518th, 506th, 514th, 562nd, 586th, and 674th, respectively; the pixels of the 13th to 42nd columns which form the 41st row of the partly lacking pattern are turned on 888th, 992nd, 1104th, 1200th, 1284th, 1368th, 1424th, 1476th, 1516th, 1540th, 1556th, 1552nd, 1536th, 1512th, 1480th, 1432nd, 1376th, 1312th, 1216th, 1120th, 1036th, 928th, 816th, 690th, 650th, 598th, 594th, 626th, 666th, and 766th, respectively; the pixels of the 13th to 40th columns which form the 42nd row of the partly lacking pattern are turned on 784th, 968th, 1068th, 1176th, 1264th, 1344th, 1408th, 1456th, 1500th, 1532nd, 1548th, 1544th, 1528th, 1504th, 1464th, 1416th, 1360th, 1280th, 1208th, 1132nd, 1048th, 948th, 856th, 762nd, 706th, 682nd, 698th, and 730th, respectively; the pixels of the 14th to 38th columns which form the 43rd row of the partly lacking pattern are turned on 880th, 1024th, 1144th, 1248th, 1320th, 1384th, 1444th, 1484th, 1508th, 1524th, 1520th, 1496th, 1472nd, 1448th, 1392nd, 1328th, 1256th, 1192nd, 1108th, 1032nd, 944th, 872nd, 804th, 750th, and 746th, respectively; the pixels of the 15th to 37th columns which form the 44th row of the partly lacking pattern are turned on 952nd, 1080th, 1184th, 1276th, 1340th, 1404th, 1452nd, 1468th, 1492nd, 1488th, 1460th, 1440th, 1400th, 1352nd, 1288th, 1232nd, 1152nd, 1064th, 984th, 904th, 840th, 800th, and 778th, respectively; the pixels of the 15th to 35th columns which form the 45th row of the partly lacking pattern are turned on 844th, 1012th, 1128th, 1228th, 1308th, 1356th, 1396th, 1420th, 1436th, 1428th, 1412th, 1388th, 1336th, 1304th, 1240th, 1168th, 1096th, 1016th, 936th, 864th, and 788th, respectively; the pixels of the 16th to 33rd columns which form the 46th row of the partly lacking pattern are turned on 920th, 1060th, 1164th, 1244th, 1300th, 1332nd, 1364th, 1380th, 1372nd, 1348th, 1324th, 1272nd, 1224th, 1160th, 1088th, 1000th, 912th, and 832nd, respectively; the pixels of the 16th to 31st columns which form the 47th row of the partly lacking pattern are turned on 824th, 980th, 1092nd, 1172nd, 1236th, 1260th, 1292nd, 1316th, 1296th, 1268th, 1252nd, 1188th, 1124th, 1056th, 976th, and 896th, respectively; the pixels of the 17th to 30th columns which form the 48th row of the partly lacking pattern are turned on 900th, 1004th, 1100th, 1156th, 1196th, 1212th, 1220th, 1204th, 1180th, 1148th, 1084th, 1008th, 916th, and 820th, respectively; the pixels of the 18th to 28th columns which form the 49th row of the partly lacking pattern are turned on 924th, 1020th, 1076th, 1116th, 1140th, 1136th, 1112th, 1072nd, 1028th, 956th, and 848th, respectively; the pixels of the 18th to 26th columns which form the 50th row of the partly lacking pattern are turned on 836th, 940th, 988th, 1040th, 1052nd, 1044th, 996th, 972nd, and 884th, respectively; the pixels of the 19th to 25th columns which form the 51st row of the partly lacking pattern are turned on 868th, 908th, 960th, 964th, 932nd, 892nd, and 792nd, respectively; the pixels of the 19th to 23rd columns which form the 52nd row of the partly lacking pattern are turned on 796th, 852nd, 876th, 860th, and 828th, respectively; the pixels of the 20th to 21st columns which form the 53rd row of the partly lacking pattern are turned on 808th, and 812th, respectively; and the pixel of the 20th column which forms the 54th row of the partly lacking pattern is turned on 780th.

The turn-on order set to arbitrary pixels in the binarization dither matrix pattern and a turn-on order set to pixels at point symmetric positions to the arbitrary pixels with respect to a specific point regarding halftone dots to which the arbitrary pixels belong may be exchanged for each other.

The pixels to which the turn-on order is set may be rotated by a predetermined angle around the center of figure of the binarization dither matrix pattern.

In the binarization dither matrix pattern, the pixels to which the same turn-on order numbers are set from among the pixels to which the turn-on order is set may be formed by exchanging the turn-on order numbers thereof for different numbers.

According to a yet further aspect of the present invention, there is provided a computer-readable recording medium on or in which a printing program for causing a computer to execute a printing function for binarizing a multi-value image and forming an image on a medium is recorded, the printing program causing the computer to execute a step of producing a binarization dither matrix pattern configured by arranging a plurality of pixels to be successively turned on in a matrix and having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order, and an image forming step of forming, based on inputted pixel values of a multi-value image, a color material for pixels of an object of formation of a color material decided by selecting pixels from the starting pixel of the turn-on order to a pixel to which a predetermined turn-on order number is set in the binarization dither matrix pattern in accordance with the turn-on order to form an image.

The binarization dither matrix pattern may be configured by exchanging the turn-on order set to arbitrary pixels in the binarization dither matrix pattern and a turn-on order set to pixels at point symmetric positions to the arbitrary pixels with respect to a specific point regarding halftone dots to which the arbitrary pixels belong for each other.

When the computer executes the image forming step, the printing program may cause the computer to execute the image forming step such that the binarization dither matrix pattern is used after rotated 90 degrees or 270 degrees.

The printing program may cause the computer to execute an image forming order changing step of changing an image forming order based on a lookup table, the computer executing, when the printing program causes the computer to executes the image forming step, the image forming step such that the image is formed based on the image forming order changed at the image forming order changing step.

According to a yet further aspect of the present invention, there is provided a computer-readable recording medium on or in which a binarization program for causing a computer to execute a binarization function for binarizing a multi-value image, the binarization program causing the computer to execute a step of producing a binarization dither matrix pattern configured by arranging a plurality of pixels to be successively turned on in a matrix and having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order, and a binarizing step of selecting, based on inputted pixel values of a multi-value image, pixels from the starting pixel of the turn-on order to a pixel to which a predetermined turn-on order number is set in the binarization dither matrix pattern in accordance with the turn-on order to perform the binarization process.

The binarization dither matrix pattern may be configured by exchanging the turn-on order set to arbitrary pixels in the binarization dither matrix pattern and a turn-on order set to pixels at point symmetric positions to the arbitrary pixels with respect to a specific point regarding halftone dots to which the arbitrary pixels belong for each other.

When the computer executes the binarizing step, the printing program may cause the computer to execute the image forming step such that the binarization dither matrix pattern is used after rotated 90 degrees or 270 degrees.

With the printing methods, the printing system, the printing apparatus, the binarization dither matrix pattern, the computer readable recording medium having a printing program recorded thereon or therein and the computer-readable recording medium having a binarization program recorded thereon or therein, the following effects or advantages can be anticipated.

(1) Since the dither matrix pattern wherein the turn on order of pixels is set such that the turned on pixels and unturned on pixels form a checkered pattern in the binarization dither matrix pattern when a number of pixels substantially equal to one half the number of pixels which form the binarization dither matrix pattern are turned on in order is used for binarization and an image is formed based on a result of the binarization, moirés and artifacts can be reduced.

(2) With the binary dither matrix pattern, also where the turn-on order set to arbitrary pixels in the binarization dither matrix pattern and a turn-on order set to pixels at point symmetric positions to the arbitrary pixels with respect to a specific point regarding halftone dots to which the arbitrary pixels belong are exchanged for each other, moirés and artifacts can be reduced.

(3) With the binary dither matrix pattern, also where the rectangular pattern to which a turn order number is set is used after rotated 90 degrees or 270 degrees, moirés and artifacts can be reduced.

(4) Also where the image forming order is changed based on a lookup table, moirés and artifacts can be reduced.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a block diagram showing part of a dot production section of a printing apparatus as an embodiment of the present invention;

FIG. 2 is a view showing an example of a binarization pattern used in the printing apparatus as the embodiment of the present invention;

FIG. 3 is a similar view but showing a state wherein a number of pixels substantially equal to one half that of pixels which form the binarization pattern shown in FIG. 2 are turned on in order;

FIG. 4 is a view showing an example of a one-dimensional lookup table used in the printing apparatus as the embodiment of the present invention;

FIGS. 5 and 6 are views illustrating a binarization process by the printing apparatus as the embodiment of the present invention;

FIG. 7 is a view showing a modification to the binarization pattern used in the printing apparatus as the embodiment of the present invention; and

FIG. 8 is a similar view but showing a state wherein a number of pixels substantially equal to one half that of pixels which form the binarization pattern shown in FIG. 7 are turned on in order.

### DESCRIPTION OF THE PREFERRED EMBODIMENT

In the following, an embodiment of the present invention is described with reference to the drawings.

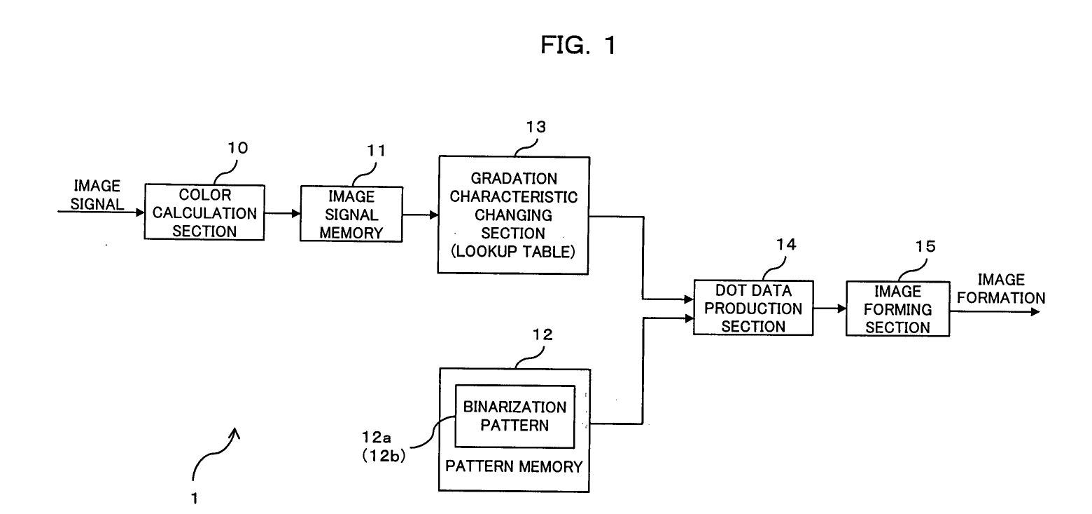

FIG. 1 is a block diagram showing part of a dot production section 1 of a printing apparatus as an embodiment of the present invention.

The printing apparatus of the present embodiment binarizes a multi-value image using a binarization dither matrix pattern (binarization pattern; details of which are hereinafter described) to control an ON/OFF state of a color material, and forms (prints) an image based on a result of the binarization. The printing apparatus represents the multi-value image in accordance with the size of a microscopic dot (halftone, halftone dot) of a color material which is to be placed on the surface of paper, a film, a printing plate and so forth. Further, the printing apparatus represents the density of an image in accordance with the area ratio of dots per a unit area.

The printing apparatus of the present embodiment is, for example, an ink-jet printer, a laser beam printer, a thermal transfer printer, a sublimation printer, an LED printer or the like printing apparatus which forms (dots) a color material (toner, ink or the like) on a medium such as printing paper to form (print) an image, and represents a gradation of a multi-value image (continuous color tone image) in accordance with the area of the color material (dots) formed on the printing medium.

It is to be noted that, in the present embodiment, pixels of an object of a binarization process individually have a value (multi-value) from among, for example, 0 to 255, and further, the pixels after the binarization (half-toning) process individually have a value (binary value) from between 0 and 255. Even if the pixel values are defined as just described, the generality is not lost.

The printing apparatus includes a CPU (Central Processing Unit), a ROM (Read Only Memory), and a RAM (Random Access Memory), which are not shown. The ROM stores application programs (a binarization program and a printing program) for implementing a color calculation section 10, a gradation characteristic changing section 13, and a dot data production section 14 which are hereinafter described. If the CPU executes the application program from the ROM, then functions (details thereof are hereinafter described) as the color calculation section 10, gradation characteristic changing section 13 and dot data production section 14 are implemented thereby to implement the printing method and the printing apparatus of the present invention.

Here, a computer is a concept including hardware and an operation system, and signifies hardware which operates under the control of an operation system. Further, where an operation system is unnecessary and hardware is operated only by an application program, the hardware itself corresponds to a computer. The hardware includes at least a microprocessor such as a CPU (Central Processing Unit) and means for reading out a computer program recorded on a recording medium.

It is to be noted that the programs (binarization program and printing program) for implementing the functions as the color calculation section 10, gradation characteristic changing section 13 and dot data production section 14 are provided in a form wherein they are recorded on a computer-readable recording medium such as, for example, a flexible disk, a CD-ROM, a CD-R, a CD-R/W, a DVD, a DVD-R, a DVD-R/W, a magnetic disk, an optical disk, a magneto-optical disk or the like. The computer reads out the programs from the recording medium, and transfers and stores them to and into an internal storage apparatus or an external storage apparatus before it uses them. Further, the programs may be recorded in advance on a storage apparatus (recording medium) such as, for example, a magnetic disk, an optical disk, a magneto-optical disk or the like and may be provided from the storage apparatus to the computer through a communication line.

In order to implement the functions as the color calculation section 10, gradation characteristic changing section 13 and dot data production section 14, the programs stored in the internal storage apparatus (in the present embodiment, the RAM or ROM of the printer) are executed by the microprocessor (in the present embodiment, the CPU of the printer) of the computer. At this time, the computer may read out and execute the programs recorded on the recording medium.

It is to be noted that, in the present embodiment, the computer is a concept including hardware and an operating system, and signifies hardware which operates under the control of an operating system. Further, where an operation system is not necessary and hardware is operated only by an application program, the hardware itself corresponds to a computer. The hardware includes at least a microprocessor such as a CPU and means for reading out a computer program recorded on a recording medium. In the present embodiment, a control circuit (not shown) provided in the printing apparatus and several information processing apparatus for providing a printing image to the printing apparatus have the function as the computer.

Further, as the recording medium in the present embodiment, not only a flexible disk, a CD-ROM, a CD-R, a CD-R/W, a DVD, a DVD-R, a DVD-R/W, a magnetic disk, an optical disk, and a magneto-optical disk but also various computer-readable recording media such as an IC card, a ROM cartridge, a magnetic tape, a punch card, an internal storage apparatus (a memory such as a RAM or a ROM) of the computer, an external storage apparatus, a printed matter on which a code such as a bar code or the like is printed and so forth can be utilized.

The dot production section 1 produces dots on the surface of paper, a film, a printing plate or the like based on an image signal of a multi-value image. The dot production section 1 includes a color calculation section 10, an image signal memory (storage area) 11, a pattern memory (binarization dither matrix pattern setting section) 12, a gradation characteristic changing section 13, a dot data production section (binarization processing section) 14 and an image forming section 15.

The color calculation section 10 performs a color calculation process regarding an image signal of a multi-value image, and performs various processes such as color modification, gradation correction, black print formation, under color removal, sharpness emphasis and so forth for an inputted image signal (represented, for example, by pixel values from 0 to 255).

The image signal memory 11 stores an image signal processed by the color calculation section 10, and functions as a storage area for expanding a multi-value image.

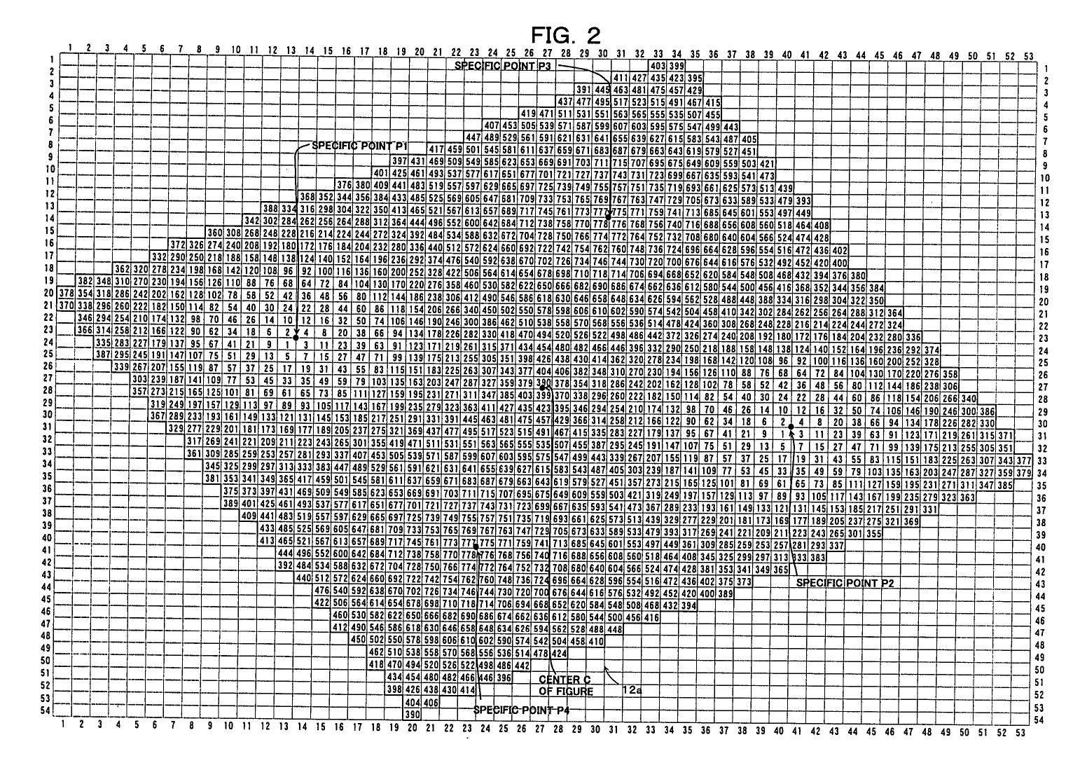

The pattern memory 12 stores such a binarization dither matrix pattern (hereinafter referred to sometimes as binarization pattern) as shown in FIG. 2. It is to be noted that actually the binarization program and the printing program are stored in the pattern memory 12, RAM (Random Access Memory), ROM (Read Only Memory), or/and storage medium (not shown) such as a magnetic storage apparatus, and as a result, it can be considered that a binarization pattern 12a is stored in the pattern memory 12.

FIG. 2 is a view showing a binarization pattern (binarization dither matrix pattern) used in the printing apparatus of the embodiment of the present invention. The binarization pattern 12a is formed by arranging a plurality of pixels to be successively turned on in a matrix. An order (hereinafter referred to as turn-on order) wherein a color material (toner, ink or the like) is formed (turned on) is set to the pixels, that is, each pixel has a turn-on order number set thereto.

In particular, as shown in FIG. 2, the binarization pattern 12a used in the printing apparatus is formed as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixel of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the 1st to 19th columns and the 21st to 53rd columns which form the 54th row of the rectangular pattern are cut out.

In the binarization pattern 12a, the turn-on order of 1556 pixels is set such that:
(1) the pixels of the 33rd to 34th columns which form the 1st row of the partly lacking pattern are turned on 403rd, and 399th, respectively;
(2) the pixels of the 31st to 35th columns which form the 2nd row of the partly lacking pattern are turned on 411th, 427th, 435th, 423rd, and 395th, respectively;
(3) the pixels of the 29th to 35th columns which form the 3rd row of the partly lacking pattern are turned on 391st, 445th, 463rd, 481st, 475th, 457th, and 429th, respectively;
(4) the pixels of the 28th to 36th columns which form the 4th row of the partly lacking pattern are turned on 437th, 477th, 495th, 517th, 523rd, 515th, 491st, 467th, and 415th, respectively;
(5) the pixels of the 26th to 36th columns which form the 5th row of the partly lacking pattern are turned on 419th, 471st, 511th, 531st, 551st, 563rd, 565th, 555th, 535th, 507th, and 455th, respectively;
(6) the pixels of the 24th to 37th columns which form the 6th row of the partly lacking pattern are turned on 407th, 453rd, 505th, 539th, 571st, 587th, 599th, 607th, 603rd, 595th, 575th, 547th, 499th, and 443rd, respectively;
(7) the pixels of the 23rd to 38th columns which form the 7th row of the partly lacking pattern are turned on 447th, 489th, 529th, 561st, 591st, 621st, 631st, 641st, 655th, 639th, 627th, 615th, 583rd, 543rd, 487th, and 405th, respectively;
(8) the pixels of the 21st to 38th columns which form the 8th row of the partly lacking pattern are turned on 417th, 459th, 501st, 545th, 581st, 611th, 637th, 659th, 671st, 683rd, 687th, 679th, 663rd, 643rd, 619th, 579th, 527th, and 451st, respectively;
(9) the pixels of the 19th to 39th columns which form the 9th row of the partly lacking pattern are turned on 397th, 431st, 469th, 509th, 549th, 585th, 1623rd, 653rd, 669th, 691st, 703rd, 711th, 715th, 707th, 695th, 675th, 649th, 609th, 559th, 503rd, and 421st, respectively;
(10) the pixels of the 18th to 39th columns which form the 10th row of the partly lacking pattern are turned on 401st, 425th, 461st, 493rd, 537th, 577th, 617th, 651st, 677th, 701st, 721st, 727th, 737th, 743rd, 731st, 723rd, 699th, 667th, 635th, 593rd, 541st, and 473rd, respectively;
(11) the pixels of the 16th to 40th columns which form the 11th row of the partly lacking pattern are turned on 376th, 380th, 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, and 439th, respectively;
(12) the pixels of the 14th to 41st columns which form the 12th row of the partly lacking pattern are turned on 368th, 352nd, 344th, 356th, 384th, 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, and 393rd, respectively;
(13) the pixels of the 12th to 41st columns which form the 13th row of the partly lacking pattern are turned on 388th, 334th, 316th, 298th, 304th, 322nd, 350th, 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, and 449th, respectively;
(14) the pixels of the 11th to 42nd columns which form the 14th row of the partly lacking pattern are turned on 342nd, 302nd, 284th, 262nd, 256th, 264th, 288th, 312th, 364th, 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, and 408th, respectively;
(15) the pixels of the 9th to 42nd columns which form the 15th row of the partly lacking pattern are turned on 360th, 308th, 268th, 248th, 228th, 216th, 214th, 224th, 244th, 272nd, 324th, 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, and 428th, respectively;
(16) the pixels of the 7th to 43rd columns which form the 16th row of the partly lacking pattern are turned on 372nd, 326th, 274th, 240th, 208th, 192nd, 180th, 172nd, 176th, 184th, 204th, 232nd, 280th, 336th, 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, and 402nd, respectively;
(17) the pixels of the 6th to 43rd columns which form the 17th row of the partly lacking pattern are turned on 332nd, 290th, 250th, 218th, 188th, 158th, 148th, 138th, 124th, 140th, 152nd, 164th, 196th, 236th, 292nd, 374th, 476th, 540th, 592nd, 638th, 670th, 702nd, 726th, 734th, 746th, 744th, 730th, 720th, 700th, 676th, 644th, 616th, 576th, 532nd, 492nd, 452nd, 420th, and 400th, respectively;
(18) the pixels of the 4th to 44th columns which form the 18th row of the partly lacking pattern are turned on 362nd, 320th, 278th, 234th, 198th, 168th, 142nd, 120th, 108th, 96th, 92nd, 100th, 116th, 136th, 160th, 200th, 252nd, 328th, 422nd, 506th, 564th, 614th, 654th, 678th, 698th, 710th, 718th, 714th, 706th, 694th, 668th, 652nd, 620th, 584th, 548th, 508th, 468th, 432nd, 394th, 376th, and 380th, respectively;
(19) the pixels of the 2nd to 45th columns which form the 19th row of the partly lacking pattern are turned on 382nd, 348th, 310th, 270th, 230th, 194th, 156th, 126th, 110th, 88th, 76th, 68th, 64th, 72nd, 84th, 104th, 130th, 170th, 220th, 276th, 358th, 460th, 530th, 582nd, 622nd, 650th, 666th, 682nd, 690th, 686th, 674th, 662nd, 636th, 612th, 580th, 544th, 500th, 456th, 416th, 368th, 352nd, 344th, 356th, and 384th, respectively;
(20) the pixels of the 1st to 45th columns which form the 20th row of the partly lacking pattern are turned on 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, 306th, 412th, 490th, 546th, 586th, 618th, 630th, 646th, 658th, 648th, 634th, 626th, 594th, 562nd, 528th, 488th, 448th, 388th, 334th, 316th, 298th, 304th, 322nd, and 350th, respectively;
(21) the pixels of the 1st to 46th columns which form the 21st row of the partly lacking pattern are turned on 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, 340th, 450th, 502nd, 550th, 578th, 598th, 606th, 610th, 602nd, 590th, 574th, 542nd, 504th, 458th, 410th, 342nd, 302nd, 284th, 262nd, 256th, 264th, 288th, 312th, and 364th, respectively;
(22) the pixels of the 2nd to 46th columns which form the 22nd row of the partly lacking pattern are turned on 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, 386th, 462nd, 510th, 538th, 558th, 570th, 568th, 556th, 536th, 514th, 478th, 424th, 360th, 308th, 268th, 248th, 228th, 216th, 214th, 224th, 244th, 272nd, and 324th, respectively;
(23) the pixels of the 2nd to 47th columns which form the 23rd row of the partly lacking pattern are turned on 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, 330th, 418th, 470th, 494th, 520th, 526th, 522nd, 498th, 486th, 442nd, 372nd, 326th, 274th, 240th, 208th, 192nd, 180th, 172nd, 176th, 184th, 204th, 232nd, 280th, and 336th, respectively;
(24) the pixels of the 3rd to 48th columns which form the 24th row of the partly lacking pattern are turned on 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, 371st, 434th, 454th, 480th, 482nd, 466th, 446th, 396th, 332nd, 290th, 250th, 218th, 188th, 158th, 148th, 138th, 124th, 140th, 152nd, 164th, 196th, 236th, 292nd, and 374th, respectively;
(25) the pixels of the 3rd to 48th columns which form the 25th row of the partly lacking pattern are turned on 387th, 295th, 245th, 191st, 147th, 107th, 75th, 51st, 29th, 13th, 5th, 7th, 15th, 27th, 47th, 71st, 99th, 139th, 175th, 213th, 255th, 305th, 351st, 398th, 426th, 438th, 430th, 414th, 362nd, 320th, 278th, 234th, 198th, 168th, 142nd, 120th, 108th, 96th, 92nd, 100th, 116th, 136th, 160th, 200th, 252nd, and 328th, respectively;
(26) the pixels of the 4th to 49th columns which form the 26th row of the partly lacking pattern are turned on 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, 377th, 404th, 406th, 382nd, 348th, 310th, 270th, 230th, 194th, 156th, 126th, 110th, 88th, 76th, 68th, 64th, 72nd, 84th, 104th, 130th, 170th, 220th, 276th, and 358th, respectively;
(27) the pixels of the 5th to 49th columns which form the 27th row of the partly lacking pattern are turned on 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, 379th, 390th, 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, and 306th, respectively;
(28) the pixels of the 5th to 50th columns which form the 28th row of the partly lacking pattern are turned on 357th, 273rd, 215th, 165th, 125th, 101st, 81st, 69th, 61st, 65th, 73rd, 85th, 111th, 127th, 159th, 195th, 231st, 271st, 311th, 347th, 385th, 403rd, 399th, 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, and 340th, respectively;
(29) the pixels of the 6th to 51st columns which form the 29th row of the partly lacking pattern are turned on 319th, 249th, 197th, 157th, 129th, 113th, 97th, 89th, 93rd, 105th, 117th, 143rd, 167th, 199th, 235th, 279th, 323rd, 363rd, 411th, 427th, 435th, 423rd, 395th, 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, and 386th, respectively;
(30) the pixels of the 6th to 51st columns which form the 30th row of the partly lacking pattern are turned on 367th, 289th, 233rd, 193rd, 161st, 149th, 133rd, 121st, 131st, 145th, 153rd, 185th, 217th, 251st, 291st, 331st, 391st, 445th, 463rd, 481st, 475th, 457th, 429th, 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, and 330th, respectively;
(31) the pixels of the 7th to 52nd columns which form the 31st row of the partly lacking pattern are turned on 329th, 277th, 229th, 201st, 181st, 173rd, 169th, 177th, 189th, 205th, 237th, 275th, 321st, 369th, 437th, 477th, 495th, 517th, 523rd, 515th, 491st, 467th, 415th, 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, and 371st, respectively;
(32) the pixels of the 8th to 52nd columns which form the 32nd row of the partly lacking pattern are turned on 317th, 269th, 241st, 221st, 209th, 211th, 223rd, 243rd, 265th, 301st, 355th, 419th, 471st, 511th, 531st, 551st, 563rd, 565th, 555th, 535th, 507th, 455th, 387th, 295th, 245th, 191st, 147th, 107th, 75th, 51st, 29th, 13th, 5th, 7th, 15th, 27th, 47th, 71st, 99th, 139th, 175th, 213th, 255th, 305th, and 351st, respectively;
(33) the pixels of the 8th to 53rd columns which form the 33rd row of the partly lacking pattern are turned on 361st, 309th, 285th, 259th, 253rd, 257th, 281st, 293rd, 337th, 407th, 453rd, 505th, 539th, 571st, 587th, 599th, 607th, 603rd, 595th, 575th, 547th, 499th, 443rd, 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, and 377th, respectively;
(34) the pixels of the 9th to 53rd columns which form the 34th row of the partly lacking pattern are turned on 345th, 325th, 299th, 297th, 313th, 333rd, 383rd, 447th, 489th, 529th, 561st, 591st, 621st, 631st, 641st, 655th, 639th, 627th, 615th, 583rd, 543rd, 487th, 405th, 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, and 379th, respectively;
(35) the pixels of the 9th to 52nd columns which form the 35th row of the partly lacking pattern are turned on 381st, 353rd, 341st, 349th, 365th, 417th, 459th, 501st, 545th, 581st, 611th, 637th, 659th, 671st, 683rd, 687th, 679th, 663rd, 643rd, 619th, 579th, 527th, 451st, 357th, 273rd, 215th, 165th, 125th, 101st, 81st, 69th, 61st, 65th, 73rd, 85th, 111th, 127th, 159th, 195th, 231st, 271st, 311th, 347th, and 385th, respectively;
(36) the pixels of the 10th to 50th columns which form the 36th row of the partly lacking pattern are turned on 375th, 373rd, 397th, 431st, 469th, 509th, 549th, 585th, 623rd, 653rd, 669th, 691st, 703rd, 711th, 715th, 707th, 695th, 675th, 649th, 609th, 559th, 503rd, 421st, 319th, 249th, 197th, 157th, 129th, 113th, 97th, 89th, 93rd, 105th, 117th, 143rd, 167th, 199th, 235th, 279th, 323rd, and 363rd, respectively;
(37) the pixels of the 10th to 48th columns which form the 37th row of the partly lacking pattern are turned on 389th, 401st, 425th, 461st, 493rd, 537th, 577th, 617th, 651st, 677th, 701st, 721st, 727th, 737th, 743rd, 731st, 723rd, 699th, 667th, 635th, 593rd, 541st, 473rd, 367th, 289th, 233rd, 193rd, 161st, 149th, 133rd, 121st, 131st, 145th, 153rd, 185th, 217th, 251st, 291st, and 331st, respectively;
(38) the pixels of the 11th to 47th columns which form the 38th row of the partly lacking pattern are turned on 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, 439th, 329th, 277th, 229th, 201st, 181st, 173rd, 169th, 177th, 189th, 205th, 237th, 275th, 321st, and 369th, respectively;
(39) the pixels of the 12th to 45th columns which form the 39th row of the partly lacking pattern are turned on 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, 393rd, 317th, 269th, 241st, 221st, 209th, 211th, 223rd, 243rd, 265th, 301st, and 355th, respectively;
(40) the pixels of the 12th to 43rd columns which form the 40th row of the partly lacking pattern are turned on 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, 449th, 361st, 309th, 285th, 259th, 253rd, 257th, 281st, 293rd, and 337th, respectively;
(41) the pixels of the 13th to 42nd columns which form the 41st row of the partly lacking pattern are turned on 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, 408th, 345th, 325th, 299th, 297th, 313th, 333rd, and 383rd, respectively;
(42) the pixels of the 13th to 40th columns which form the 42nd row of the partly lacking pattern are turned on 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, 428th, 381st, 353rd, 341st, 349th, and 365th, respectively;
(43) the pixels of the 14th to 38th columns which form the 43rd row of the partly lacking pattern are turned on 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, 402nd, 375th, and 373rd, respectively;
(44) the pixels of the 15th to 37th columns which form the 44th row of the partly lacking pattern are turned on 476th, 540th, 592nd, 638th, 670th, 702nd, 726th, 734th, 746th, 744th, 730th, 720th, 700th, 676th, 644th, 616th, 576th, 532nd, 492nd, 452nd, 420th, 400th, and 389th, respectively;
(45) the pixels of the 15th to 35th columns which form the 45th row of the partly lacking pattern are turned on 422nd, 506th, 564th, 614th, 654th, 678th, 698th, 710th, 718th, 714th, 706th, 694th, 668th, 652nd, 620th, 584th, 548th, 508th, 468th, 432nd, and 394th, respectively;
(46) the pixels of the 16th to 33rd columns which form the 46th row of the partly lacking pattern are turned on 460th, 530th, 582nd, 622nd, 650th, 666th, 682nd, 690th, 686th, 674th, 662nd, 636th, 612th, 580th, 544th, 500th, 456th, and 416th, respectively;
(47) the pixels of the 16th to 31st columns which form the 47th row of the partly lacking pattern are turned on 412th, 490th, 546th, 586th, 618th, 630th, 646th, 658th, 648th, 634th, 626th, 594th, 562nd, 528th, 488th, and 448th, respectively;
(48) the pixels of the 17th to 30th columns which form the 48th row of the partly lacking pattern are turned on 450th, 502nd, 550th, 578th, 598th, 606th, 610th, 602nd, 590th, 574th, 542nd, 504th, 458th, and 410th, respectively;
(49) the pixels of the 18th to 28th columns which form the 49th row of the partly lacking pattern are turned on 462nd, 510th, 538th, 558th, 570th, 568th, 556th, 536th, 514th, 478th, and 424th, respectively;
(50) the pixels of the 18th to 26th columns which form the 50th row of the partly lacking pattern are turned on 418th, 470th, 494th, 520th, 526th, 522nd, 498th, 486th, and 442nd, respectively;
(51) the pixels of the 19th to 25th columns which form the 51st row of the partly lacking pattern are turned on 434th, 454th, 480th, 482nd, 466th, 446th, and 396th, respectively;
(52) the pixels of the 19th to 23rd columns which form the 52nd row of the partly lacking pattern are turned on 398th, 426th, 438th, 430th, and 414th, respectively;
(53) the pixels of the 20th to 21st columns which form the 53rd row of the partly lacking pattern are turned on 404th, and 406th, respectively; and
(54) the pixel of the 20th column which forms the 54th row of the partly lacking pattern is turned on 390th.

Further, the binarization pattern 12a has a plurality of specific points (divergence specific points) P1 and P2 provided at substantially point symmetric positions with respect to the position C of the center of figure thereof as shown in FIG. 2, and those of the pixels which are adjacent to turned on pixels are preferentially turned on in order beginning with those of the pixels which are positioned near to the specific points P1 and P2 to individually form successive halftone dots, thereby to form a concentrated dither.

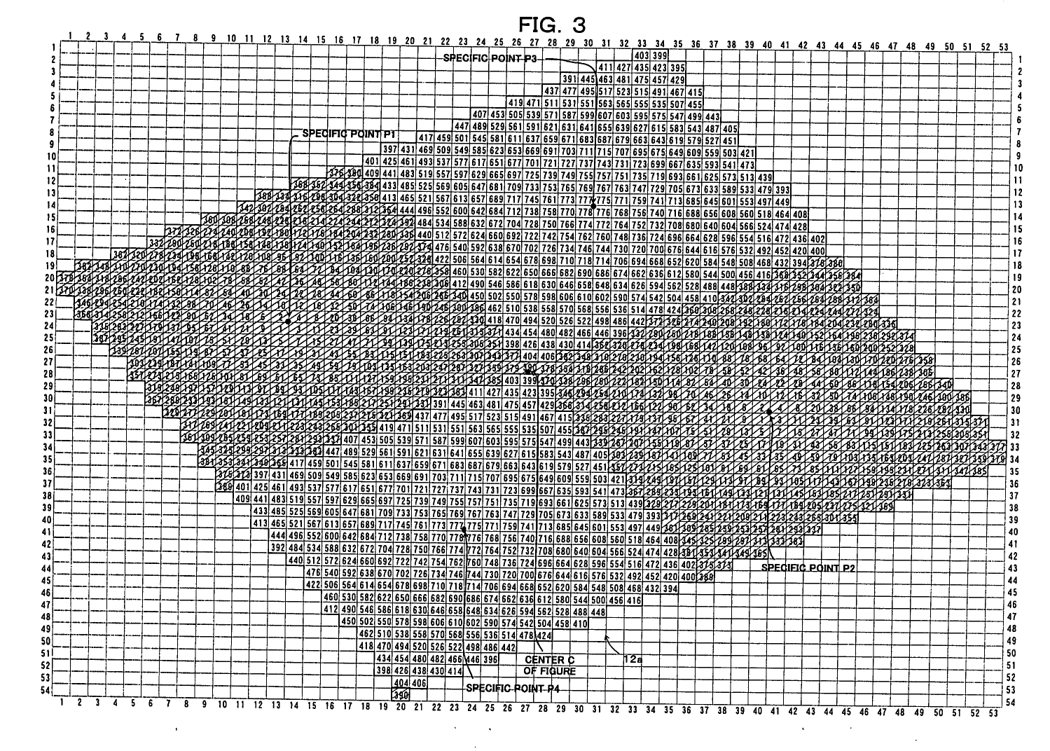

FIG. 3 is a view showing a state wherein a number of pixels substantially equal to one half that of the pixels which form the binarization pattern shown in FIG. 2 (that is, those pixels which have the turn on order numbers 1 to 390) are turned on in order. It is to be noted that, in FIG. 3, the turned on pixels are indicated by slanting lines. As seen in FIG. 3, the turn on order of the binarization pattern 12a is set so that dots (halftone dots) of shapes same as each other grow in order individually from the specific points P1 and P2, and when a number of pixels substantially equal to one half that of the pixels which form the binarization pattern 12a (in FIG. 3, those pixels which have the turn on order numbers 1 to 390) are turned on in order, the turned on pixels and unturned on pixels form a checkered pattern in the binarization pattern 12a.

Further, in the binarization pattern 12a, where a pixel positioned nearest to each of the specific points P1 and P2 is turned on already (that is, a turned on pixel), an unturned on pixel adjacent to the turned on pixel is turned on and then a pixel at a point symmetric position with respect to the specific point of the basic pattern 121 is turned on. Consequently, the turn-on order is set so that each dot grows in a substantially circular form.

Further, in the binarization pattern 12a shown in FIGS. 2 and 3, a color material is placed on the pixels in order from a pixel having a low order number to another pixel having a higher order number. Consequently, a dot grows in a substantially circular form centered at each of the specific points P1 and P2, and the binarization pattern 12a functions as a binarization pattern (binarization dither matrix pattern; dither pattern) of the dot concentration type.

The binarization pattern 12a further has another plurality of specific points (convergence specific points) P3 and P4 at point symmetrical positions substantially with respect to the position C of the center of figure thereof but different from the above-described specific points P1 and P2 as seen in FIG. 2. The specific points P3 and P4 are provided at positions coincident with the positions of the specific points P1 and P2 when the binarization pattern 12a is rotated by approximately 90 degrees or 270 degrees around the position C of the center of figure. The specific points P3 and P4 are positioned substantially at the centers of regions formed from unturned on pixels in a state wherein a number of pixels substantially equal to one half that of the pixels which form the binarization pattern 12a (that is, those pixels which have the turn on order numbers 1 to 390 in FIG. 3) are turned on in order as seen in FIG. 3, that is, in a state wherein a checkered pattern is formed from the halftone dots (turned on pixels) of the binarization pattern 12a including the specific points P1 and P2 and pixels (unturned on pixels) other than the halftone dots in the binarization pattern 12a.

Further, in the binarization pattern 12a, the turn on order of the pixels is set such that, after a state wherein a number of pixels substantially equal to one half that of the pixels which form the binarization pattern 12a (that is, those pixels which have the turn on order numbers 1 to 390 in FIG. 3) are turned on in order is established, that is, after a checkered pattern is formed from the halftone dots (turned on pixels) of the binarization pattern 12a including the specific points P1 and P2 and the pixels (unturned on pixels) other than the halftone dots in the binarization pattern 12a, the unturned on pixels are successively turned on beginning with an unturned pixel remotest from each of the specific points P3 and P4 and ending with the specific point P3 or P4.

In particular, if the pixels of the binarization pattern 12a are successively turned on in the descending order of the turn on order number beginning with a pixel having the highest turn on order number (a pixel having the turn on order number 778 applied thereto) and ending with another pixel having the lowest turn on order number, then halftone dots grow up at positions of the binarization pattern 12a rotated by approximately 90 degrees or 270 degrees substantially around the position C of the center of figure when compared with those where the pixels of the binarization pattern 12a are successively turned on in the ascending order of the turn on order number beginning with a pixel having the lowest turn on order number and ending with another pixel having the highest turn on order number (a pixel having the turn on order number 778 applied thereto).

In this manner, the binarization pattern 12a has regions in which a turn on order is set to the pixels so that halftone dots are generated and grow (diverge) individually around the specific points P1 and P2 and regions in which a turn order is set to the pixels so that halftone dots are generated and grow (converge) individually from points remote from the specific points P3 and P4 toward the specific points P3 and P4, and the four regions are arranged alternately in the binarization pattern 12a to form a checkered pattern.

Accordingly, the present binarization pattern 12a exhibits similar operations and advantages whether it is used such that the pixels are successively turned on in the descending order of the turn on order number beginning with a pixel having the highest turn on order number (a pixel having the turn on order number 778 applied thereto) and ending with another pixel having the lowest turn on order number or the pixels are successively turned on in the ascending order of the turn on order number beginning with a pixel having the lowest turn on order number and ending with another pixel having the highest turn on order number (a pixel having the turn on order number 778 applied thereto). The following description is given of a case wherein the pixels are successively turned on in the ascending order of the turn on order number beginning with a pixel having the lowest turn on order number and ending with another pixel having the highest turn on order number.

Further, a plurality of such binarization patterns 12a can be arranged repetitively in a vertical direction (in a direction along a column) and a horizontal direction (in a direction along a row) such that no gap appears between adjacent ones of them.

It is to be noted that, where the binarization pattern 12a having such a configuration as described above is used, a pixel value (for example, 0 to 255) of each of pixels which form a multi-value image (original image) to be printed can be represented with 778 stages (gradations).

Furthermore, in the binarization pattern 12a, two dots including a dot (halftone dot) centered at the specific point P1 and another dot (halftone dote) centered at the specific point P2 are generated and grow.

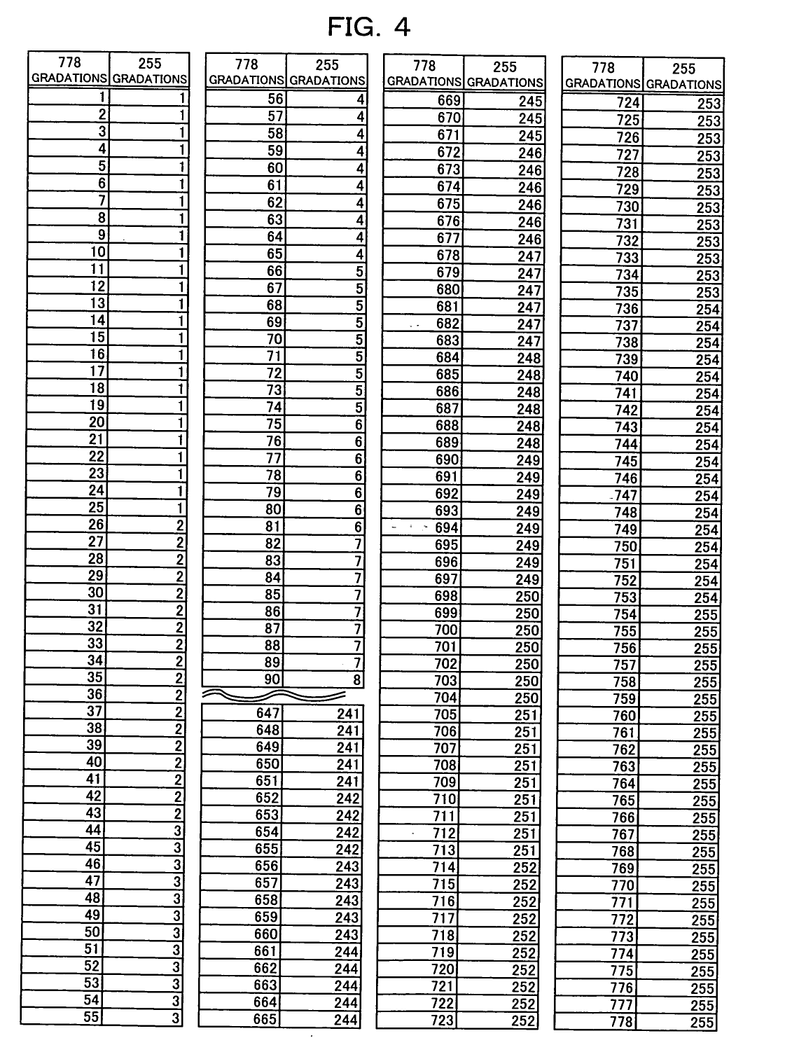

The gradation characteristic changing section 13 converts the pixel value of each pixel of an image signal based on a one-dimensional lookup table (refer to FIG. 4) provided in advance therein. FIG. 4 shows an example of a one-dimensional lookup table used in the printing apparatus as the embodiment of the present invention and shows a partial excerpt of a one-dimensional lookup table for converting 778 gradations into 255 gradations.

The gradation characteristic changing section 13 converts each pixel value of an image signal based on such a one-dimensional lookup table as shown in FIG. 4 and passes a resulting pixel value to the dot data production section 14 thereby to change the turn on order.

Thus, it is possible to convert an image prior to conversion into an image of arbitrary gradations (gradation conversion) or convert a characteristic (gradation characteristic) of an image arbitrarily by arbitrarily changing the values of the one-dimensional lookup table. It is to be noted that the gradation characteristic changing section 13 functions as a turn on order changing section for changing the turn on order based on a lookup table.

It is to be noted that the lookup table may be used to fix a color material to a plurality of pixels of the binarization pattern 12a at a time or not to fix a color material.

Upon such changing of the turn on order based on the lookup table, if the turn on order is set so that a color material is fixed to a pixel adjacent to another pixel to which the color material is fixed already (which is turned on already), then the color material is liable to be fixed readily, and consequently, the printing quality can be improved.

Further, while, in the present embodiment, the gradation characteristic changing section 13 converts each pixel value of an image signal, the pixel value change is not limited to this but can be carried out in various forms without departing from the spirit and scope of the present invention. For example, the gradation characteristic changing section 13 may perform the pixel value change based on a lookup table other than that shown in FIG. 4 or the pixel value change by the gradation characteristic changing section 13 may not be performed.

The dot data production section (binarization processing section) 14 uses the binarization pattern 12a recorded in the pattern memory 12 to binarize an image signal inputted thereto from the gradation characteristic changing section 13 to produced at a (dot data) for printing dots by means of the image forming section 15.

More particularly, the dot data production section 14 compares each pixel value (for example, 0 to 255) of the image signal with a threshold value set in advance to determine the number of pixels to be lit in the binarization pattern 12a and then produces dot data with which a number of pixels equal to the determined number of pixels are turned on in accordance with the turn on order set for the binarization pattern 12a.

In particular, the dot data production section 14 successively selects those pixels beginning with a pixel at the start of the turn on order (in FIG. 2, the pixel to which the turn on order number 1 is set) and ending with another pixel to which a turn on order number equal to the determined pixel number is set in accordance with the turn on order (ascending order) set to the binarization pattern 12a to determine those pixels on which a color material is to be formed, and then produces data based on the information of the determined pixels.

The image forming section 15 prints the dot data produced by the dot data production section 14. For example, in a printing apparatus of the electrostatic printing type, an exposure apparatus or the like functions as the image forming section 15, and in this instance, data for light exposure are produced as the dot data by the dot data production section 14.

In other words, the dot data production section 14 binarizes a multi-value image expanded on the image signal memory 11, and the image forming section 15 forms an image based on a result of the binarization.

In the printing apparatus of the embodiment of the present invention having the configuration described above, such a binarization pattern 12a as shown in FIG. 2 is prepared in the pattern memory 12 in advance (preparation step), and an image signal inputted to the dot production section 1 is processed by various processes such as color modification, gradation correction, black print formation, under color removal, sharpness emphasis and so forth by the color calculation section 10. Then, the image signal processed in this manner is expanded in the image signal memory 11 (expansion step of expanding a multi-value image in a storage area). Further, in the printing apparatus, conversion of pixel values is performed for the image signal expanded in the image signal memory 11 by means of the gradation characteristic changing section 13 as occasion demands.

Then, the dot data production section 14 uses the binarization pattern 12a recorded in the pattern memory 12 to binarize the image signal (binarizing step) to produce dot data and inputs the dot data to the image forming section 15.

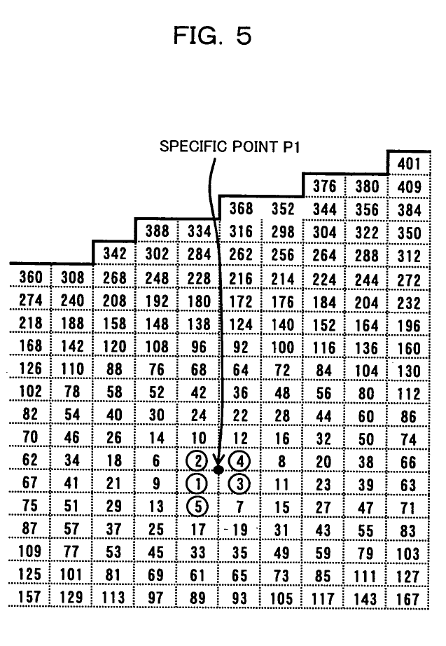

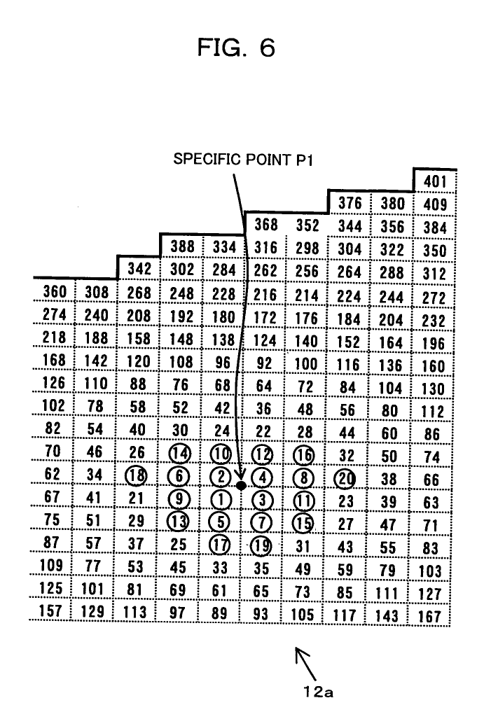

FIGS. 5 and 6 are views illustrating different binarization processes in the printing apparatus as the embodiment of the present invention and show an example of a procedure wherein a portion around the specific point P1 of the binarization pattern 12a shown in FIG. 2 is partially extracted to determine pixels on which a color material is to be formed. FIG. 5 shows an example wherein five pixels in the binarization pattern 12a are turned on, and FIG. 6 shows another example wherein 20 pixels in the binarization pattern 12a are turned on. In FIGS. 5 and 6, those pixels selected (turned on) in the binarization pattern 12a are indicated by a mark “o”.

The dot data production section 14 selects the pixels of the binarization pattern 12a beginning with a pixel at the start of the turn on order and ending with another pixel to which a predetermined turn on order number is set in the turn on order (in the present embodiment, in an ascending order from a lower turn on order number to a higher turn on order number) to determine those pixels on which a color material is to be formed to produce dot data. Then, the image forming section 15 performs formation (printing) of an image in accordance with the produced dot data (image forming step).

In this manner, according to the printing apparatus (binarization dither matrix pattern) as the embodiment of the present invention, printing of the dot concentration type can be performed, and in this instance, an image which includes reduced moirés or artifacts (artificial striped patterns) can be printed.

The present invention is not limited to the embodiment described above but can be carried out in various modified forms without departing from the spirit and scope of the present invention.

For example, in the embodiment described above, the dot data production section 14 uses the binarization pattern 12a shown in FIG. 2 to perform a binarization process. However, the binarization pattern to be used is not limited to this, but it can be carried out in various modified forms without departing from the spirit and scope of the present invention.

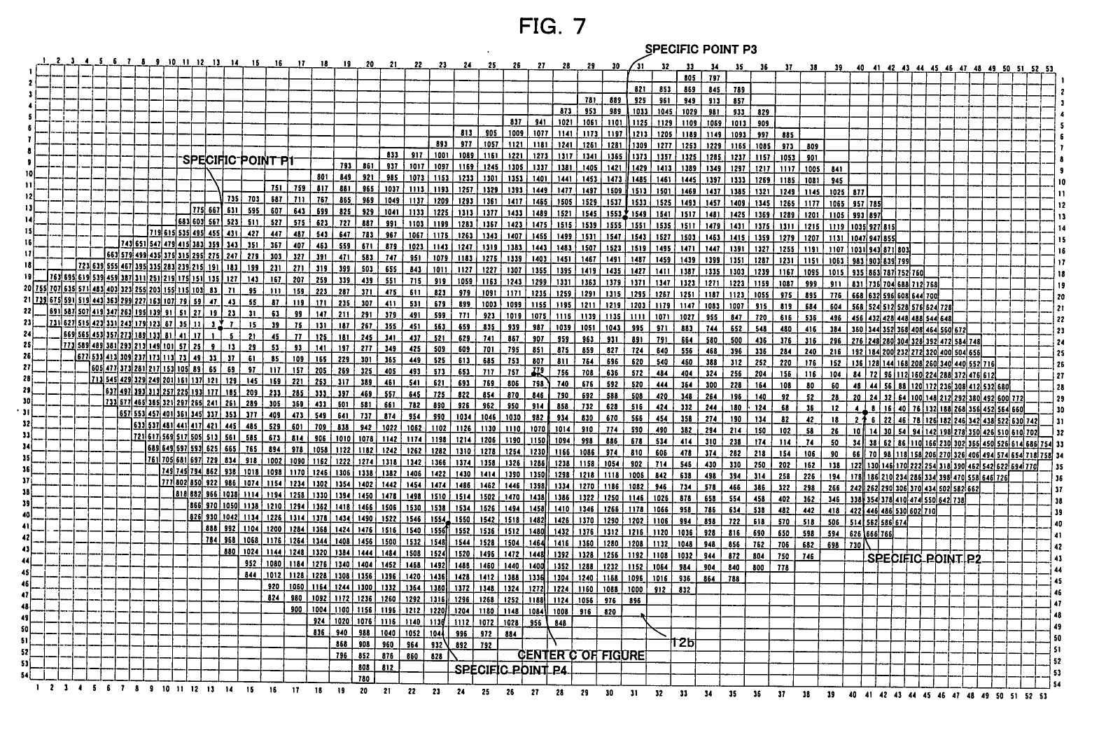

FIG. 7 is a view showing a modified binarization pattern which can be used in the printing apparatus of the embodiment of the present invention, and the dot data production section 14 may use the binarization pattern 12b shown in FIG. 7 to perform a binarization process. It is to be noted that, where the binarization pattern 12b is used, the pixel value (for example, 0 to 255) of each pixel which form a multi-value image (original image) to be printed can be represented in 1556 stages (gradations).

The binarization pattern 12b shown in FIG. 7 is produced as a modification to the binarization pattern 12a shown in FIG. 2 wherein no same turn on order number appears such that the pixels thereof have different turn on order numbers (1 to 1556) from one another.

In particular, as shown in FIG. 7, the binarization pattern 12b is formed as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixels of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the pixels of the 1st to 19th columns and the 21st to 53rd columns which form the 54th row of the rectangular pattern are cut out.

Further, in the binarization pattern 12b, the turn-on order of 1556 pixels is set such that:
(1) the pixels of the 33rd to 34th columns which form the 1st row of the partly lacking pattern are turned on 805th, and 797th, respectively;
(2) the pixels of the 31st to 35th columns which form the 2nd row of the partly lacking pattern are turned on 821st, 853rd, 869th, 845th, and 789th, respectively;
(3) the pixels of the 29th to 35th columns which form the 3rd row of the partly lacking pattern are turned on 781st, 889th, 925th, 961st, 949th, 913th, and 857th, respectively;
(4) the pixels of the 28th to 36th columns which form the 4th row of the partly lacking pattern are turned on 873rd, 953rd, 989th, 1033rd, 1045th, 1029th, 981st, 933rd, and 829th, respectively;
(5) the pixels of the 26th to 36th columns which form the 5th row of the partly lacking pattern are turned on 837th, 941st, 1021st, 1061st, 1101st, 1125th, 1129th, 1109th, 1069th, 1013th, and 909th, respectively;
(6) the pixels of the 24th to 37th columns which form the 6th row of the partly lacking pattern are turned on 813th, 905th, 1009th, 1077th, 1141st, 1173rd, 1197th, 1213th, 1205th, 1189th, 1149th, 1093rd, 997th, and 885th, respectively;
(7) the pixels of the 23rd to 38th columns which form the 7th row of the partly lacking pattern are turned on 893rd, 977th, 1057th, 1121st, 1181st, 1241st, 1261st, 1281st, 1309th, 1277th, 1253rd, 1229th, 1165th, 1085th, 973rd, and 809th, respectively;
(8) the pixels of the 21st to 38th columns which form the 8th row of the partly lacking pattern are turned on 833rd, 917th, 1001st, 1089th, 1161st, 1221st, 1273rd, 1317th, 1341st, 1365th, 1373rd, 1357th, 1325th, 1285th, 1237th, 1157th, 1053rd, and 901st, respectively;
(9) the pixels of the 19th to 39th columns which form the 9th row of the partly lacking pattern are turned on 793rd, 861st, 937th, 1017th, 1097th, 1169th, 1245th, 1305th, 1337th, 1381st, 1405th, 1421st, 1429th, 1413th, 1389th, 1349th, 1297th, 1217th, 1117th, 1005th, and 841st, respectively;
(10) the pixels of the 18th to 39th columns which form the 10th row of the partly lacking pattern are turned on 801st, 849th, 921st, 985th, 1073rd, 1153rd, 1233rd, 1301st, 1353rd, 1401st, 1441st, 1453rd, 1473rd, 1485th, 1461st, 1445th, 1397th, 1333rd, 1269th, 1185th, 1081st, and 945th, respectively;
(11) the pixels of the 16th to 40th columns which form the 11th row of the partly lacking pattern are turned on 751st, 759th, 817th, 881st, 965th, 1037th, 1113th, 1193rd, 1257th, 1329th, 1393rd, 1449th, 1477th, 1497th, 1509th, 1513th, 1501st, 1469th, 1437th, 1385th, 1321st, 1249th, 1145th, 1025th, and 877th, respectively;
(12) the pixels of the 14th to 41st columns which form the 12th row of the partly lacking pattern are turned on 735th, 703rd, 687th, 711th, 767th, 865th, 969th, 1049th, 1137th, 1209th, 1293rd, 1361st, 1417th, 1465th, 1505th, 1529th, 1537th, 1533rd, 1525th, 1493rd, 1457th, 1409th, 1345th, 1265th, 1177th, 1065th, 957th, and 785th, respectively;
(13) the pixels of the 12th to 41st columns which form the 13th row of the partly lacking pattern are turned on 775th, 667th, 631st, 595th, 607th, 643rd, 699th, 825th, 929th, 1041st, 1133rd, 1225th, 1313th, 1377th, 1433rd, 1489th, 1521st, 1545th, 1553rd, 1549th, 1541st, 1517th, 1481st, 1425th, 1369th, 1289th, 1201st, 1105th, 993rd, and 897th, respectively;
(14) the pixels of the 11th to 42nd columns which form the 14th row of the partly lacking pattern are turned on 683rd, 603rd, 567th, 523rd, 511th, 527th, 575th, 623rd, 727th, 887th, 991st, 1103rd, 1199th, 1283rd, 1367th, 1423rd, 1475th, 1515th, 1539th, 1555th, 1551st, 1535th, 1511th, 1479th, 1431st, 1375th, 1311th, 1215th, 1119th, 1035th, 927th, and 815th, respectively;
(15) the pixels of the 9th to 42nd columns which form the 15th row of the partly lacking pattern are turned on 719th, 615th, 535th, 495th, 455th, 431st, 427th, 447th, 487th, 543rd, 647th, 783rd, 967th, 1067th, 1175th, 1263rd, 1343rd, 1407th, 1455th, 1499th, 1531st, 1547th, 1543rd, 1527th, 1503rd, 1463rd, 1415th, 1359th, 1279th, 1207th, 1131st, 1047th, 947th, and 855th, respectively;
(16) the pixels of the 7th to 43rd columns which form the 16th row of the partly lacking pattern are turned on 743rd, 651st, 547th, 479th, 415th, 383rd, 359th, 343rd, 351st, 367th, 407th, 463rd, 559th, 671st, 879th, 1023rd, 1143rd, 1247th, 1319th, 1383rd, 1443rd, 1483rd, 1507th, 1523rd, 1519th, 1495th, 1471st, 1447th, 1391st, 1327th, 1255th, 1191st, 1107th, 1031st, 943rd, 871st, and 803rd, respectively;
(17) the pixels of the 6th to 43rd columns which form the 17th row of the partly lacking pattern are turned on 663rd, 579th, 499th, 435th, 375th, 315th, 295th, 275th, 247th, 279th, 303rd, 327th, 391st, 471st, 583rd, 747th, 951st, 1079th, 1183rd, 1275th, 1339th, 1403rd, 1451st, 1467th, 1491st, 1487th, 1459th, 1439th, 1399th, 1351st, 1287th, 1231st, 1151st, 1063rd, 983rd, 903rd, 839th, and 799th, respectively;
(18) the pixels of the 4th to 44th columns which form the 18th row of the partly lacking pattern are turned on 723rd, 639th, 555th, 467th, 395th, 335th, 283rd, 239th, 215th, 191st, 183rd, 199th, 231st, 271st, 319th, 399th, 503rd, 655th, 843rd, 1011th, 1127th, 1227th, 1307th, 1355th, 1395th, 1419th, 1435th, 1427th, 1411th, 1387th, 1335th, 1303rd, 1239th, 1167th, 1095th, 1015th, 935th, 863rd, 787th, 752nd, and 760th, respectively;
(19) the pixels of the 2nd to 45th columns which form the 19th row of the partly lacking pattern are turned on 763rd, 695th, 619th, 539th, 459th, 387th, 311th, 251st, 219th, 175th, 151st, 135th, 127th, 143rd, 167th, 207th, 259th, 339th, 439th, 551st, 715th, 919th, 1059th, 1163rd, 1243rd, 1299th, 1331st, 1363rd, 1379th, 1371st, 1347th, 1323rd, 1271st, 1223rd, 1159th, 1087th, 999th, 911th, 831st, 736th, 704th, 688th, 712th, and 768th, respectively;
(20) the pixels of the 1st to 45th columns which form the 20th row of the partly lacking pattern are turned on 755th, 707th, 635th, 571st, 483rd, 403rd, 323rd, 255th, 203rd, 155th, 115th, 103rd, 83rd, 71st, 95th, 111th, 159th, 223rd, 287th, 371st, 475th, 611th, 823rd, 979th, 1091st, 1171st, 1235th, 1259th, 1291st, 1315th, 1295th, 1267th, 1251st, 1187th, 1123rd, 1055th, 975th, 895th, 776th, 668th, 632nd, 596th, 608th, 644th, and 700th, respectively;
(21) the pixels of the 1st to 46th columns which form the 21st row of the partly lacking pattern are turned on 739th, 675th, 591st, 519th, 443rd, 363rd, 299th, 227th, 163rd, 107th, 79th, 59th, 47th, 43rd, 55th, 87th, 119th, 171st, 235th, 307th, 411th, 531st, 679th, 899th, 1003rd, 1099th, 1155th, 1195th, 1211th, 1219th, 1203rd, 1179th, 1147th, 1083rd, 1007th, 915th, 819th, 684th, 604th, 568th, 524th, 512th, 528th, 576th, 624th, and 728th, respectively;
(22) the pixels of the 2nd to 46th columns which form the 22nd row of the partly lacking pattern are turned on 691st, 587th, 507th, 419th, 347th, 263rd, 195th, 139th, 91st, 51st, 27th, 19th, 23rd, 31st, 63rd, 99th, 147th, 211th, 291st, 379th, 491st, 599th, 771st, 923rd, 1019th, 1075th, 1115th, 1139th, 1135th, 1111th, 1071st, 1027th, 955th, 847th, 720th, 616th, 536th, 496th, 456th, 432nd, 428th, 448th, 488th, 544th, and 648th, respectively;
(23) the pixels of the 2nd to 47th columns which form the 23rd row of the partly lacking pattern are turned on 731st, 627th, 515th, 423rd, 331st, 243rd, 179th, 123rd, 67th, 35th, 11th, 3rd, 7th, 15th, 39th, 75th, 131st, 187th, 267th, 355th, 451st, 563rd, 659th, 835th, 939th, 987th, 1039th, 1051st, 1043rd, 995th, 971st, 883rd, 744th, 652nd, 548th, 480th, 416th, 384th, 360th, 344th, 352nd, 368th, 408th, 464th, 560th, and 672nd, respectively;
(24) the pixels of the 3rd to 48th columns which form the 24th row of the partly lacking pattern are turned on 669th, 565th, 453rd, 357th, 273rd, 189th, 133rd, 81st, 41st, 17th, 1st, 5th, 21st, 45th, 77th, 125th, 181st, 245th, 341st, 437th, 521st, 629th, 741st, 867th, 907th, 959th, 963rd, 931st, 891st, 791st, 664th, 580th, 500th, 436th, 376th, 316th, 296th, 276th, 248th, 280th, 304th, 328th, 392nd, 472nd, 584th, and 748th, respectively;
(25) the pixels of the 3rd to 48th columns which form the 25th row of the partly lacking pattern are turned on 773rd, 589th, 489th, 381st, 293rd, 213th, 149th, 101st, 57th, 25th, 9th, 13th, 29th, 53rd, 93rd, 141st, 197th, 277th, 349th, 425th, 509th, 609th, 701st, 795th, 851st, 875th, 859th, 827th, 724th, 640th, 556th, 468th, 396th, 336th, 284th, 240th, 216th, 192nd, 184th, 200th, 232nd, 272nd, 320th, 400th, 504th, and 656th, respectively;
(26) the pixels of the 4th to 49th columns which form the 26th row of the partly lacking pattern are turned on 677th, 533rd, 413th, 309th, 237th, 173rd, 113th, 73rd, 49th, 33rd, 37th, 61st, 85th, 109th, 165th, 229th, 301st, 365th, 449th, 525th, 613th, 685th, 753rd, 807th, 811th, 764th, 696th, 620th, 540th, 460th, 388th, 312th, 252nd, 220th, 176th, 152nd, 136th, 128th, 144th, 168th, 208th, 260th, 340th, 440th, 552nd, and 716th, respectively;
(27) the pixels of the 5th to 49th columns which form the 27th row of the partly lacking pattern are turned on 605th, 477th, 373rd, 281st, 217th, 153rd, 105th, 89th, 65th, 69th, 97th, 117th, 157th, 205th, 269th, 325th, 405th, 493rd, 573rd, 653rd, 717th, 757th, 779th, 756th, 708th, 636th, 572nd, 484th, 404th, 324th, 256th, 204th, 156th, 116th, 104th, 84th, 72nd, 96th, 112th, 160th, 224th, 288th, 372nd, 476th, and 612th, respectively;
(28) the pixels of the 5th to 50th columns which form the 28th row of the partly lacking pattern are turned on 713th, 545th, 429th, 329th, 249th, 201st, 161st, 137th, 121st, 129th, 145th, 169th, 221st, 253rd, 317th, 389th, 461st, 541st, 621st, 693rd, 769th, 806th, 798th, 740th, 676th, 592nd, 520th, 444th, 364th, 300th, 228th, 164th, 108th, 80th, 60th, 48th, 44th, 56th, 88th, 120th, 172nd, 236th, 308th, 412th, 532nd, and 680th, respectively;
(29) the pixels of the 6th to 51st columns which form the 29th row of the partly lacking pattern are turned on 637th, 497th, 393rd, 313th, 257th, 225th, 193rd, 177th, 185th, 209th, 233rd, 285th, 333rd, 397th, 469th, 557th, 645th, 725th, 822nd, 854th, 870th, 846th, 790th, 692nd, 588th, 508th, 420th, 348th, 264th, 196th, 140th, 92nd, 52nd, 28th, 20th, 24th, 32nd, 64th, 100th, 148th, 212th, 292nd, 380th, 492nd, 600th, and 772nd, respectively;
(30) the pixels of the 6th to 51st columns which form the 30th row of the partly lacking pattern are turned on 733rd, 577th, 465th, 385th, 321st, 297th, 265th, 241st, 261st, 289th, 305th, 369th, 433rd, 501st, 581st, 661st, 782nd, 890th, 926th, 962nd, 950th, 914th, 858th, 732nd, 628th, 516th, 424th, 332nd, 244th, 180th, 124th, 68th, 36th, 12th, 4th, 8th, 16th, 40th, 76th, 132nd, 188th, 268th, 356th, 452nd, 564th, and 660th, respectively;
(31) the pixels of the 7th to 52nd columns which form the 31st row of the partly lacking pattern are turned on 657th, 553rd, 457th, 401st, 361st, 345th, 337th, 353rd, 377th, 409th, 473rd, 549th, 641st, 737th, 874th, 954th, 990th, 1034th, 1046th, 1030th, 982nd, 934th, 830th, 670th, 566th, 454th, 358th, 274th, 190th, 134th, 82nd, 42nd, 18th, 2nd, 6th, 22nd, 46th, 78th, 126th, 182nd, 246th, 342nd, 438th, 522nd, 630th, and 742nd, respectively;
(32) the pixels of the 8th to 52nd columns which form the 32nd row of the partly lacking pattern are turned on 633rd, 537th, 481st, 441st, 417th, 421st, 445th, 485th, 529th, 601st, 709th, 838th, 942nd, 1022nd, 1062nd, 1102nd, 1126th, 1130th, 1110th, 1070th, 1014th, 910th, 774th, 590th, 490th, 382nd, 294th, 214th, 150th, 102nd, 58th, 26th, 10th, 14th, 30th, 54th, 94th, 142nd, 198th, 278th, 350th, 426th, 510th, 610th, and 702nd, respectively;
(33) the pixels of the 8th to 53rd columns which form the 33rd row of the partly lacking pattern are turned on 721st, 617th, 569th, 517th, 505th, 513th, 561st, 585th, 673rd, 814th, 906th, 1010th, 1078th, 1142nd, 1174th, 1198th, 1214th, 1206th, 1190th, 1150th, 1094th, 998th, 886th, 678th, 534th, 414th, 310th, 238th, 174th, 114th, 74th, 50th, 34th, 38th, 62nd, 86th, 110th, 166th, 230th, 302nd, 366th, 450th, 526th, 614th, 686th, and 754th, respectively;
(34) the pixels of the 9th to 53rd columns which form the 34th row of the partly lacking pattern are turned on 689th, 649th, 597th, 593rd, 625th, 665th, 765th, 894th, 978th, 1058th, 1122nd, 1182nd, 1242nd, 1262nd, 1282nd, 1310th, 1278th, 1254th, 1230th, 1166th, 1086th, 974th, 810th, 606th, 478th, 374th, 282nd, 218th, 154th, 106th, 90th, 66th, 70th, 98th, 118th, 158th, 206th, 270th, 326th, 406th, 494th, 574th, 654th, 718th, and 758th, respectively;
(35) the pixels of the 9th to 52nd columns which form the 35th row of the partly lacking pattern are turned on 761st, 705th, 681st, 697th, 729th, 834th, 918th, 1002nd, 1090th, 1162nd, 1222nd, 1274th, 1318th, 1342nd, 1366th, 1374th, 1358th, 1326th, 1286th, 1238th, 1158th, 1054th, 902nd, 714th, 546th, 430th, 330th, 250th, 202nd, 162nd, 138th, 122nd, 130th, 146th, 170th, 222nd, 254th, 318th, 390th, 462nd, 542nd, 622nd, 694th, and 770th, respectively;
(36) the pixels of the 10th to 50th columns which form the 36th row of the partly lacking pattern are turned on 749th, 745th, 794th, 862nd, 938th, 1018th, 1098th, 1170th, 1246th, 1306th, 1338th, 1382nd, 1406th, 1422nd, 1430th, 1414th, 1390th, 1350th, 1298th, 1218th, 1118th, 1006th, 842nd, 638th, 498th, 394th, 314th, 258th, 226th, 194th, 178th, 186th, 210th, 234th, 286th, 334th, 398th, 470th, 558th, 646th, and 726th, respectively;
(37) the pixels of the 10th to 48th columns which form the 37th row of the partly lacking pattern are turned on 777th, 802nd, 850th, 922nd, 986th, 1074th, 1154th, 1234th, 1302nd, 1354th, 1402nd, 1442nd, 1454th, 1474th, 1486th, 1462nd, 1446th, 1398th, 1334th, 1270th, 1186th, 1082nd, 946th, 734th, 578th, 466th, 386th, 322nd, 298th, 266th, 242nd, 262nd, 290th, 306th, 370th, 434th, 502nd, 582nd, and 662nd, respectively;
(38) the pixels of the 11th to 47th columns which form the 38th row of the partly lacking pattern are turned on 818th, 882nd, 966th, 1038th, 1114th, 1194th, 1258th, 1330th, 1394th, 1450th, 1478th, 1498th, 1510th, 1514th, 1502nd, 1470th, 1438th, 1386th, 1322nd, 1250th, 1146th, 1026th, 878th, 658th, 554th, 458th, 402nd, 362nd, 346th, 338th, 354th, 378th, 410th, 474th, 550th, 642nd, and 738th, respectively;
(39) the pixels of the 12th to 45th columns which form the 39th row of the partly lacking pattern are turned on 866th, 970th, 1050th, 1138th, 1210th, 129.4th, 1362nd, 1418th, 1466th, 1506th, 1530th, 1538th, 1534th, 1526th, 1494th, 1458th, 1410th, 1346th, 1266th, 1178th, 1066th, 958th, 786th, 634th, 538th, 482nd, 442nd, 418th, 422nd, 446th, 486th, 530th, 602nd, and 710th, respectively;
(40) the pixels of the 12th to 43rd columns which form the 40th row of the partly lacking pattern are turned on 826th, 930th, 1042nd, 1134th, 1226th, 1314th, 1378th, 1434th, 1490th, 1522nd, 1546th, 1554th, 1550th, 1542nd, 1518th, 1482nd, 1426th, 1370th, 1290th, 1202nd, 1106th, 994th, 898th, 722nd, 618th, 570th, 518th, 506th, 514th, 562nd, 586th, and 674th, respectively;
(41) the pixels of the 13th to 42nd columns which form the 41st row of the partly lacking pattern are turned on 888th, 992nd, 1104th, 1200th, 1284th, 1368th, 1424th, 1476th, 1516th, 1540th, 1556th, 1552nd, 1536th, 1512th, 1480th, 1432nd, 1376th, 1312th, 1216th, 1120th, 1036th, 928th, 816th, 690th, 650th, 598th, 594th, 626th, 666th, and 766th, respectively;
(42) the pixels of the 13th to 40th columns which form the 42nd row of the partly lacking pattern are turned on 784th, 968th, 1068th, 1176th, 1264th, 1344th, 1408th, 1456th, 1500th, 1532nd, 1548th, 1544th, 1528th, 1504th, 1464th, 1416th, 1360th, 1280th, 1208th, 1132nd, 1048th, 948th, 856th, 762nd, 706th, 682nd, 698th, and 730th, respectively;
(43) the pixels of the 14th to 38th columns which form the 43rd row of the partly lacking pattern are turned on 880th, 1024th, 1144th, 1248th, 1320th, 1384th, 1444th, 1484th, 1508th, 1524th, 1520th, 1496th, 1472nd, 1448th, 1392nd, 1328th, 1256th, 1192nd, 1108th, 1032nd, 944th, 872nd, 804th, 750th, and 746th, respectively;
(44) the pixels of the 15th to 37th columns which form the 44th row of the partly lacking pattern are turned on 952nd, 1080th, 1184th, 1276th, 1340th, 1404th, 1452nd, 1468th, 1492nd, 1488th, 1460th, 1440th, 1400th, 1352nd, 1288th, 1232nd, 1152nd, 1064th, 984th, 904th, 840th, 800th, and 778th, respectively;
(45) the pixels of the 15th to 35th columns which form the 45th row of the partly lacking pattern are turned on 844th, 1012th, 1128th, 1228th, 1308th, 1356th, 1396th, 1420th, 1436th, 1428th, 1412th, 1388th, 1336th, 1304th, 1240th, 1168th, 1096th, 1016th, 936th, 864th, and 788th, respectively;
(46) the pixels of the 16th to 33rd columns which form the 46th row of the partly lacking pattern are turned on 920th, 1060th, 1164th, 1244th, 1300th, 1332nd, 1364th, 1380th, 1372nd, 1348th, 1324th, 1272nd, 1224th, 1160th, 1088th, 1000th, 912th, and 832nd, respectively;
(47) the pixels of the 16th to 31st columns which form the 47th row of the partly lacking pattern are turned on 824th, 980th, 1092nd, 1172nd, 1236th, 1260th, 1292nd, 1316th, 1296th, 1268th, 1252nd, 1188th, 1124th, 1056th, 976th, and 896th, respectively;
(48) the pixels of the 17th to 30th columns which form the 48th row of the partly lacking pattern are turned on 900th, 1004th, 1100th, 1156th, 1196th, 1212th, 1220th, 1204th, 1180th, 1148th, 1084th, 1008th, 916th, and 820th, respectively;
(49) the pixels of the 18th to 28th columns which form the 49th row of the partly lacking pattern are turned on 924th, 1020th, 1076th, 1116th, 1140th, 1136th, 1112th, 1072nd, 1028th, 956th, and 848th, respectively;
(50) the pixels of the 18th to 26th columns which form the 50th row of the partly lacking pattern are turned on 836th, 940th, 988th, 1040th, 1052nd, 1044th, 996th, 972nd, and 884th, respectively;
(51) the pixels of the 19th to 25th columns which form the 51st row of the partly lacking pattern are turned on 868th, 908th, 960th, 964th, 932nd, 892nd, and 792nd, respectively;
(52) the pixels of the 19th to 23rd columns which form the 52nd row of the partly lacking pattern are turned on 796th, 852nd, 876th, 860th, and 828th, respectively;
(53) the pixels of the 20th to 21st columns which form the 53rd row of the partly lacking pattern are turned on 808th, and 812th, respectively; and
(54) the pixel of the 20th column which forms the 54th row of the partly lacking pattern is turned on 780th.

Also the binarization pattern 12b has a plurality of specific points P1 and P2 provided at substantially point symmetric positions with respect to the position C of the center of figure thereof as shown in FIG. 7, and those of the pixels which are adjacent to turned on pixels are preferentially turned on in order beginning with those of the pixels which are positioned near to the specific points P1 and P2 to individually form successive halftone dots, thereby to form a concentrated dither.

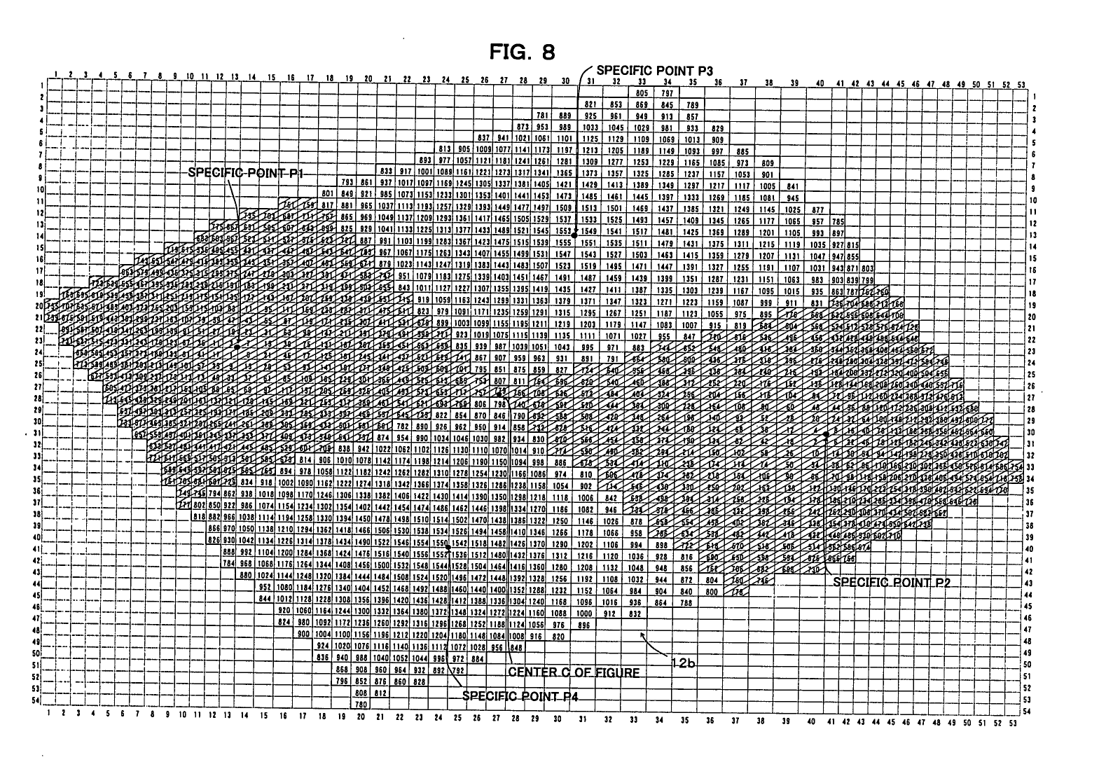

FIG. 8 is a view showing a state wherein a number of pixels substantially equal to one half that of the pixels which form the binarization pattern shown in FIG. 7 (that is, those pixels which have the turn on order numbers 1 to 779) are turned on in order. It is to be noted that, in FIG. 8, the turned on pixels are indicated by slanting lines. As seen in FIG. 8, the turn on order also of the binarization pattern 12b is set similarly to that of the binarization pattern 12a so that dots (halftone dots) of shapes same as each other grow in order individually from the specific points P1 and P2, and when a number of pixels substantially equal to one half that of the pixels which form the binarization pattern 12b (in FIG. 8, those pixels which have the turn on order numbers 1 to 779) are turned on in order, the turned on pixels and unturned on pixels form a checkered pattern in the binarization pattern 12b.

Further, also in the binarization pattern 12b, where a pixel positioned nearest to each of the specific points P1 and P2 is turned on already (that is, a turned on pixel), an unturned on pixel adjacent to the turned on pixel is turned on and then a pixel at a point symmetric position with respect to the specific point of the basic pattern 121 is turned on. Consequently, the turn-on order is set so that each dot grows in a substantially circular form.

Further, also in the binarization pattern 12b shown in FIGS. 7 and 8, a color material is placed on the pixels in order from a pixel having a low order number to another pixel having a higher order number. Consequently, a dot grows in a substantially circular form centered at each of the specific points P1 and P2, and the binarization pattern 12b functions as a binarization pattern (binarization dither matrix pattern; dither pattern) of the dot concentration type.

Also the binarization pattern 12b further has another plurality of specific points P3 and P4 at point symmetrical positions substantially with respect to the position C of the center of figure thereof but different from the above-described specific points P1 and P2 as seen in FIG. 7. The specific points P3 and P4 are provided at positions coincident with the positions of the specific points P1 and P2 when the binarization pattern 12b is rotated by approximately 90 degrees or 270 degrees around the position C of the center of figure. The specific points P3 and P4 are positioned substantially at the centers of regions formed from unturned on pixels in a state wherein a number of pixels substantially equal to one half that of the pixels which form the binarization pattern 12b (that is, those pixels which have the turn on order numbers 1 to 779 in FIG. 8) are turned on in order as seen in FIG. 8, that is, in a state wherein a checkered pattern is formed from the halftone dots (turned on pixels) of the binarization pattern 12b including the specific points P1 and P2 and pixels (unturned on pixels) other than the halftone dots in the binarization pattern 12b.

Further, in the binarization pattern 12b, the turn on order of the pixels is set such that, after a state wherein a number of pixels substantially equal to one half that of the pixels which form the binarization pattern 12b (that is, those pixels which have the turn on order numbers 1 to 779 in FIG. 8) are turned on in order is established, that is, after a checkered pattern is formed from the halftone dots (turned on pixels) of the binarization pattern 12b including the specific points P1 and P2 and the pixels (unturned on pixels) other than the halftone dots in the binarization pattern 12b, the unturned on pixels are successively turned on beginning with an unturned pixel remotest from each of the specific points P3 and P4 and ending with the specific point P3 or P4.

In particular, if the pixels of the binarization pattern 12b are successively turned on in the descending order of the turn on order number beginning with a pixel having the highest turn on order number (a pixel having the turn on order number 1556 applied thereto) and ending with another pixel having the lowest turn on order number, then halftone dots grow up at positions of the binarization pattern 12b rotated by approximately 90 degrees substantially around the position C of the center of figure when compared with those where the pixels of the binarization pattern 12b are successively turned on in the ascending order of the turn on order number beginning with a pixel having the lowest turn on order number and ending with another pixel having the highest turn on order number (a pixel having the turn on order number 1556 applied thereto).

In this manner, similarly to the binarization pattern 12a, also the binarization pattern 12b has regions in which a turn on order is set to the pixels so that halftone dots are generated and grow (diverge) individually around the specific points P1 and P2 and regions in which a turn order is set to the pixels so that halftone dots are generated and grow (converge) individually from points remote from the specific points P3 and P4 toward the specific points P3 and P4, and the four regions are arranged alternately in the binarization pattern 12b to form a checkered pattern.

Accordingly, the present binarization pattern 12b exhibits similar operations and advantages whether it is used such that the pixels are successively turned on in the descending order of the turn on order number beginning with a pixel having the highest turn on order number (a pixel having the turn on order number 1556 applied thereto) and ending with another pixel having the lowest turn on order number or the pixels are successively turned on in the ascending order of the turn on order number beginning with a pixel having the lowest turn on order number and ending with another pixel having the highest turn on order number (a pixel having the turn on order number 1556 applied thereto). The following description is given of a case wherein the pixels are successively turned on in the ascending order of the turn on order number beginning with a pixel having the lowest turn on order number and ending with another pixel having the highest turn on order number.

Further, a plurality of such binarization patterns 12b can be arranged repetitively in a vertical direction (in a direction along a column) and a horizontal direction (in a direction along a row) such that no gap appears between adjacent ones of them similarly to the binarization patterns 12a described hereinabove.

It is to be noted that, where the binarization pattern 12b having such a configuration as described above is used, a pixel value (for example, 0 to 255) of each of pixels which form a multi-value image (original image) to be printed can be represented with 1556 stages (gradations).

Furthermore, also in the binarization pattern 12b, two dots including a dot (halftone dot) centered at the specific point P1 and another dot (halftone dote) centered at the specific point P2 are generated and grow.

Further, while, in the binarization patterns 12a and 12b described above, a color material is successively fixed to the pixels from a pixel having a lower turn on order number to another pixel having a higher turn on order number, the order in which a color material is to be fixed is not limited to this, but alternatively the turn order number may be set reversely to that in the binarization patterns 12a and 12b described above such that a color material is successively fixed to the pixels from a pixel having a lower turn on order number to another pixel having a higher turn on order number.

It is to be noted that the turn on order number set arbitrarily to an arbitrary pixel in each of the binarization patterns 12a and 12b described above and the turn on order number set to a pixel at a point symmetrical position to the arbitrary pixel with respect to the specific point P1, P2, P3 or P4 of the halftone dot to which the arbitrary pixel belongs may be exchanged for each other. More particularly, the turn on order number set to an arbitrary pixel in each of the binarization patterns 12a and 12b may be exchanged for the turn on order number set to a pixel at a point symmetrical position to the arbitrary pixel with respect to that one of the specific point P1, P2, P3 or P4 in the binarization pattern 12a or 12b which is positioned nearest to the arbitrary pixel. Also in this instance, similar operation and advantages can be anticipated.

Thus, it can be considered that, if an arbitrary pixel in the binarization pattern 12a or 12b in a state wherein a number of pixels substantially equal to one half the number of pixels which form the binarization pattern 12a or 12b (in FIG. 3, the pixels having the turn on order numbers 1 to 779 applied thereto) are turned on in order, that is, in a state wherein a checkered pattern is formed from the halftone dots (turned on pixels) including the specific points P1 and P2 and the pixels (unturned on pixels) other than the halftone dots in the binarization pattern 12a or 12b is a turned on pixel, then the specific point P1 or the specific point P2 which is positioned at the center of the halftone dot to which the arbitrary pixel belongs serves as the reference to the point symmetry described above, but if the arbitrary pixel in the binarization pattern 12a or 12b is an unturned on pixel, then the specific point P3 or the specific point P4 which is positioned at the center of the set of unturned pixels to which the arbitrary pixel belongs serves as the reference to the point symmetry described above.

Also where the binarization pattern 12b having such a configuration as described above is used, the dot data production section 14 performs a process similar to that performed using the binarization pattern 12a described hereinabove to select the pixels of the binarization pattern 12b beginning with a pixel at the start of the turn on order and ending with another pixel to which a predetermined turn on order number is set in the turn on order to determine those pixels on which a color material is to be formed to produce dot data. Then, the image forming section 15 performs formation (printing) of an image in accordance with the produced dot data (image forming step).

Consequently, also where the binarization pattern 12b is used, similar operation and effects to those achieved where the binarization pattern 12a is used can be achieved.

In other words, whichever one of the binarization patterns 12a and 12b is used as a binarization dither matrix patter, the printing method, printing system, printing apparatus, binarization dither matrix pattern, computer readable recording medium having a printing program recorded thereon or therein and computer-readable recording medium having a binarization program recorded thereon or therein according to the present invention can be implemented.

Furthermore, the color calculation section 10, image signal memory 11, gradation characteristic changing section 13, pattern memory 12 and dot data production section 14 described hereinabove may be provided outside the present printing apparatus (for example, in a computer or the like (not shown) connected to the printing apparatus) such that the computer executes programs (including a program for producing the binarization pattern 12a or 12b described hereinabove) to implement at least some of the functions of the color calculation section 10, image signal memory 11, gradation characteristic changing section 13, pattern memory 12 and dot data production section 14.

It is to be noted that, where the embodiment of the present invention is disclosed, those skilled in the art could produce the present apparatus and could carry out the method of the present invention.

### INDUSTRIAL APPLICABILITY

The present invention can be applied to printing of various multi-value images (continuous tone images) such as a natural image, a graphic image and a color character image using a printing apparatus such as, for example, an ink jet printer.

1. A printing method, comprising:
an expansion step of expanding a multi-value image in a storage area; and
an image forming step of binarizing the multi-value image expanded in said storage area based on a binarization dither matrix pattern and forming an image based on a result of the binarization;
the binarization dither matrix pattern being configured by arranging a plurality of pixels to be successively turned on in a matrix;
the binarization dither matrix pattern having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots;
the turned on pixels and unturned on pixels forming a checkered pattern in the binarization dither matrix pattern when a number of pixels substantially equal to one half the number of pixels which form the binarization dither matrix pattern are turned on in order.

2. The printing method as claimed in claim 1, wherein the binarization dither matrix pattern is configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixel of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the 1st to 19th columns and the 21st to 53rd columns which form the 54th row of the rectangular pattern are cut out,
a turn on order of the 1556 pixels being set such that:
the pixels of the 33rd to 34th columns which form the 1st row of the partly lacking pattern are turned on 403rd, and 399th, respectively;
the pixels of the 31st to 35th columns which form the 2nd row of the partly lacking pattern are turned on 411th, 427th, 435th, 423rd, and 395th, respectively;
the pixels of the 29th to 35th columns which form the 3rd row of the partly lacking pattern are turned on 391st, 445th, 463rd, 481st, 475th, 457th, and 429th, respectively;
the pixels of the 28th to 36th columns which form the 4th row of the partly lacking pattern are turned on 437th, 477th, 495th, 517th, 523rd, 515th, 491st, 467th, and 415th, respectively;
the pixels of the 26th to 36th columns which form the 5th row of the partly lacking pattern are turned on 419th, 471st, 511th, 531st, 551st, 563rd, 565th, 555th, 535th, 507th, and 455th, respectively;
the pixels of the 24th to 37th columns which form the 6th row of the partly lacking pattern are turned on 407th, 453rd, 505th, 539th, 571st, 587th, 599th, 607th, 603rd, 595th, 575th, 547th, 499th, and 443rd, respectively;
the pixels of the 23rd to 38th columns which form the 7th row of the partly lacking pattern are turned on 447th, 489th, 529th, 561st, 591st, 621st, 631st, 641st, 655th, 639th, 627th, 615th, 583rd, 543rd, 487th, and 405th, respectively;
the pixels of the 21st to 38th columns which form the 8th row of the partly lacking pattern are turned on 417th, 459th, 501st, 545th, 581st, 611th, 637th, 659th, 671st, 683rd, 687th, 679th, 663rd, 643rd, 619th, 579th, 527th, and 451st, respectively;
the pixels of the 19th to 39th columns which form the 9th row of the partly lacking pattern are turned on 397th, 431st, 469th, 509th, 549th, 585th, 1623rd, 653rd, 669th, 691st, 703rd, 711th, 715th, 707th, 695th, 675th, 649th, 609th, 559th, 503rd, and 421st, respectively;
the pixels of the 18th to 39th columns which form the 10th row of the partly lacking pattern are turned on 401st, 425th, 461st, 493rd, 537th, 577th, 617th, 651st, 677th, 701st, 721st, 727th, 737th, 743rd, 731st, 723rd, 699th, 667th, 635th, 593rd, 541st, and 473rd, respectively;
the pixels of the 16th to 40th columns which form the 11th row of the partly lacking pattern are turned on 376th, 380th, 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, and 439th, respectively;
the pixels of the 14th to 41st columns which form the 12th row of the partly lacking pattern are turned on 368th, 352nd, 344th, 356th, 384th, 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, and 393rd, respectively;
the pixels of the 12th to 41st columns which form the 13th row of the partly lacking pattern are turned on 388th, 334th, 316th, 298th, 304th, 322nd, 350th, 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, and 449th, respectively;
the pixels of the 11th to 42nd columns which form the 14th row of the partly lacking pattern are turned on 342nd, 302nd, 284th, 262nd, 256th, 264th, 288th, 312th, 364th, 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, and 408th, respectively;
the pixels of the 9th to 42nd columns which form the 15th row of the partly lacking pattern are turned on 360th, 308th, 268th, 248th, 228th, 216th, 214th, 224th, 244th, 272nd, 324th, 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, and 428th, respectively;
the pixels of the 7th to 43rd columns which form the 16th row of the partly lacking pattern are turned on 372nd, 326th, 274th, 240th, 208th, 192nd, 180th, 172nd, 176th, 184th, 204th, 232nd, 280th, 336th, 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, and 402nd, respectively;
the pixels of the 6th to 43rd columns which form the 17th row of the partly lacking pattern are turned on 332nd, 290th, 250th, 218th, 188th, 158th, 148th, 138th, 124th, 140th, 152nd, 164th, 196th, 236th, 292nd, 374th, 476th, 540th, 592nd, 638th, 670th, 702nd, 726th, 734th, 746th, 744th, 730th, 720th, 700th, 676th, 644th, 616th, 576th, 532nd, 492nd, 452nd, 420th, and 400th, respectively;
the pixels of the 4th to 44th columns which form the 18th row of the partly lacking pattern are turned on 362nd, 320th, 278th, 234th, 198th, 168th, 142nd, 120th, 108th, 96th, 92nd, 100th, 116th, 136th, 160th, 200th, 252nd, 328th, 422nd, 506th, 564th, 614th, 654th, 678th, 698th, 710th, 718th, 714th, 706th, 694th, 668th, 652nd, 620th, 584th, 548th, 508th, 468th, 432nd, 394th, 376th, and 380th, respectively;
the pixels of the 2nd to 45th columns which form the 19th row of the partly lacking pattern are turned on 382nd, 348th, 310th, 270th, 230th, 194th, 156th, 126th, 110th, 88th, 76th, 68th, 64th, 72nd, 84th, 104th, 130th, 170th, 220th, 276th, 358th, 460th, 530th, 582nd, 622nd, 650th, 666th, 682nd, 690th, 686th, 674th, 662nd, 636th, 612th, 580th, 544th, 500th, 456th, 416th, 368th, 352nd, 344th, 356th, and 384th, respectively;
the pixels of the 1st to 45th columns which form the 20th row of the partly lacking pattern are turned on 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, 306th, 412th, 490th, 546th, 586th, 618th, 630th, 646th, 658th, 648th, 634th, 626th, 594th, 562nd, 528th, 488th, 448th, 388th, 334th, 316th, 298th, 304th, 322nd, and 350th, respectively;
the pixels of the 1st to 46th columns which form the 21st row of the partly lacking pattern are turned on 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, 340th, 450th, 502nd, 550th, 578th, 598th, 606th, 610th, 602nd, 590th, 574th, 542nd, 504th, 458th, 410th, 342nd, 302nd, 284th, 262nd, 256th, 264th, 288th, 312th, and 364th, respectively;
the pixels of the 2nd to 46th columns which form the 22nd row of the partly lacking pattern are turned on 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, 386th, 462nd, 510th, 538th, 558th, 570th, 568th, 556th, 536th, 514th, 478th, 424th, 360th, 308th, 268th, 248th, 228th, 216th, 214th, 224th, 244th, 272nd, and 324th, respectively;
the pixels of the 2nd to 47th columns which form the 23rd row of the partly lacking pattern are turned on 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, 330th, 418th, 470th, 494th, 520th, 526th, 522nd, 498th, 486th, 442nd, 372nd, 326th, 274th, 240th, 208th, 192nd, 180th, 172nd, 176th, 184th, 204th, 232nd, 280th, and 336th, respectively;
the pixels of the 3rd to 48th columns which form the 24th row of the partly lacking pattern are turned on 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, 371st, 434th, 454th, 480th, 482nd, 466th, 446th, 396th, 332nd, 290th, 250th, 218th, 188th, 158th, 148th, 138th, 124th, 140th, 152nd, 164th, 196th, 236th, 292nd, and 374th, respectively;
the pixels of the 3rd to 48th columns which form the 25th row of the partly lacking pattern are turned on 387th, 295th, 245th, 191st, 147th, 107th, 75th, 51st, 29th, 13th, 5th, 7th, 15th, 27th, 47th, 71st, 99th, 139th, 175th, 213th, 255th, 305th, 351st, 398th, 426th, 438th, 430th, 414th, 362nd, 320th, 278th, 234th, 198th, 168th, 142nd, 120th, 108th, 96th, 92nd, 100th, 116th, 136th, 160th, 200th, 252nd, and 328th, respectively;
the pixels of the 4th to 49th columns which form the 26th row of the partly lacking pattern are turned on 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, 377th, 404th, 406th, 382nd, 348th, 310th, 270th, 230th, 194th, 156th, 126th, 110th, 88th, 76th, 68th, 64th, 72nd, 84th, 104th, 130th, 170th, 220th, 276th, and 358th, respectively;
the pixels of the 5th to 49th columns which form the 27th row of the partly lacking pattern are turned on 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, 379th, 390th, 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, and 306th, respectively;
the pixels of the 5th to 50th columns which form the 28th row of the partly lacking pattern are turned on 357th, 273rd, 215th, 165th, 125th, 101st, 81st, 69th, 61st, 65th, 73rd, 85th, 111th, 127th, 159th, 195th, 231st, 271st, 311th, 347th, 385th, 403rd, 399th, 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, and 340th, respectively;
the pixels of the 6th to 51st columns which form the 29th row of the partly lacking pattern are turned on 319th, 249th, 197th, 157th, 129th, 113th, 97th, 89th, 93rd, 105th, 117th, 143rd, 167th, 199th, 235th, 279th, 323rd, 363rd, 411th, 427th, 435th, 423rd, 395th, 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, and 386th, respectively;
the pixels of the 6th to 51st columns which form the 30th row of the partly lacking pattern are turned on 367th, 289th, 233rd, 193rd, 161st, 149th, 133rd, 121st, 131st, 145th, 153rd, 185th, 217th, 251st, 291st, 331st, 391st, 445th, 463rd, 481st, 475th, 457th, 429th, 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, and 330th, respectively;
the pixels of the 7th to 52nd columns which form the 31st row of the partly lacking pattern are turned on 329th, 277th, 229th, 201st, 181st, 173rd, 169th, 177th, 189th, 205th, 237th, 275th, 321st, 369th, 437th, 477th, 495th, 517th, 523rd, 515th, 491st, 467th, 415th, 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, and 371st, respectively;
the pixels of the 8th to 52nd columns which form the 32nd row of the partly lacking pattern are turned on 317th, 269th, 241st, 221st, 209th, 211th, 223rd, 243rd, 265th, 301st, 355th, 419th, 471st, 511th, 531st, 551st, 563rd, 565th, 555th, 535th, 507th, 455th, 387th, 295th, 245th, 191st, 147th, 107th, 75th, 51st, 29th, 13th, 5th, 7th, 15th, 27th, 47th, 71st, 99th, 139th, 175th, 213th, 255th, 305th, and 351st, respectively;
the pixels of the 8th to 53rd columns which form the 33rd row of the partly lacking pattern are turned on 361st, 309th, 285th, 259th, 253rd, 257th, 281st, 293rd, 337th, 407th, 453rd, 505th, 539th, 571st, 587th, 599th, 607th, 603rd, 595th, 575th, 547th, 499th, 443rd, 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, and 377th, respectively;
the pixels of the 9th to 53rd columns which form the 34th row of the partly lacking pattern are turned on 345th, 325th, 299th, 297th, 313th, 333rd, 383rd, 447th, 489th, 529th, 561st, 591st, 621st, 631st, 641st, 655th, 639th, 627th, 615th, 583rd, 543rd, 487th, 405th, 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, and 379th, respectively;
the pixels of the 9th to 52nd columns which form the 35th row of the partly lacking pattern are turned on 381st, 353rd, 341st, 349th, 365th, 417th, 459th, 501st, 545th, 581st, 611th, 637th, 659th, 671st, 683rd, 687th, 679th, 663rd, 643rd, 619th, 579th, 527th, 451st, 357th, 273rd, 215th, 165th, 125th, 101st, 81st, 69th, 61st, 65th, 73rd, 85th, 111th, 127th, 159th, 195th, 231st, 271st, 311th, 347th, and 385th, respectively;
the pixels of the 10th to 50th columns which form the 36th row of the partly lacking pattern are turned on 375th, 373rd, 397th, 431st, 469th, 509th, 549th, 585th, 623rd, 653rd, 669th, 691st, 703rd, 711th, 715th, 707th, 695th, 675th, 649th, 609th, 559th, 503rd, 421st, 319th, 249th, 197th, 157th, 129th, 113th, 97th, 89th, 93rd, 105th, 117th, 143rd, 167th, 199th, 235th, 279th, 323rd, and 363rd, respectively;
the pixels of the 10th to 48th columns which form the 37th row of the partly lacking pattern are turned on 389th, 401st, 425th, 461st, 493rd, 537th, 577th, 617th, 651st, 677th, 701st, 721st, 727th, 737th, 743rd, 731st, 723rd, 699th, 667th, 635th, 593rd, 541st, 473rd, 367th, 289th, 233rd, 193rd, 161st, 149th, 133rd, 121st, 131st, 145th, 153rd, 185th, 217th, 251st, 291st, and 331st, respectively;
the pixels of the 11th to 47th columns which form the 38th row of the partly lacking pattern are turned on 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, 439th, 329th, 277th, 229th, 201st, 181st, 173rd, 169th, 177th, 189th, 205th, 237th, 275th, 321st, and 369th, respectively;
the pixels of the 12th to 45th columns which form the 39th row of the partly lacking pattern are turned on 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, 393rd, 317th, 269th, 241st, 221st, 209th, 211th, 223rd, 243rd, 265th, 301st, and 355th, respectively;
the pixels of the 12th to 43rd columns which form the 40th row of the partly lacking pattern are turned on 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, 449th, 361st, 309th, 285th, 259th, 253rd, 257th, 281st, 293rd, and 337th, respectively;
the pixels of the 13th to 42nd columns which form the 41st row of the partly lacking pattern are turned on 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, 408th, 345th, 325th, 299th, 297th, 313th, 333rd, and 383rd, respectively;
the pixels of the 13th to 40th columns which form the 42nd row of the partly lacking pattern are turned on 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, 428th, 381st, 353rd, 341st, 349th, and 365th, respectively;
the pixels of the 14th to 38th columns which form the 43rd row of the partly lacking pattern are turned on 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, 402nd, 375th, and 373rd, respectively;
the pixels of the 15th to 37th columns which form the 44th row of the partly lacking pattern are turned on 476th, 540th, 592nd, 638th, 670th, 702nd, 726th, 734th, 746th, 744th, 730th, 720th, 700th, 676th, 644th, 616th, 576th, 532nd, 492nd, 452nd, 420th, 400th, and 389th, respectively;
the pixels of the 15th to 35th columns which form the 45th row of the partly lacking pattern are turned on 422nd, 506th, 564th, 614th, 654th, 678th, 698th, 710th, 718th, 714th, 706th, 694th, 668th, 652nd, 620th, 584th, 548th, 508th, 468th, 432nd, and 394th, respectively;
the pixels of the 16th to 33rd columns which form the 46th row of the partly lacking pattern are turned on 460th, 530th, 582nd, 622nd, 650th, 666th, 682nd, 690th, 686th, 674th, 662nd, 636th, 612th, 580th, 544th, 500th, 456th, and 416th, respectively;
the pixels of the 16th to 31st columns which form the 47th row of the partly lacking pattern are turned on 412th, 490th, 546th, 586th, 618th, 630th, 646th, 658th, 648th, 634th, 626th, 594th, 562nd, 528th, 488th, and 448th, respectively;
the pixels of the 17th to 30th columns which form the 48th row of the partly lacking pattern are turned on 450th, 502nd, 550th, 578th, 598th, 606th, 610th, 602nd, 590th, 574th, 542nd, 504th, 458th, and 410th, respectively;
the pixels of the 18th to 28th columns which form the 49th row of the partly lacking pattern are turned on 462nd, 510th, 538th, 558th, 570th, 568th, 556th, 536th, 514th, 478th, and 424th, respectively;
the pixels of the 18th to 26th columns which form the 50th row of the partly lacking pattern are turned on 418th, 470th, 494th, 520th, 526th, 522nd, 498th, 486th, and 442nd, respectively;
the pixels of the 19th to 25th columns which form the 51st row of the partly lacking pattern are turned on 434th, 454th, 480th, 482nd, 466th, 446th, and 396th, respectively;
the pixels of the 19th to 23rd columns which form the 52nd row of the partly lacking pattern are turned on 398th, 426th, 438th, 430th, and 414th, respectively;
the pixels of the 20th to 21st columns which form the 53rd row of the partly lacking pattern are turned on 404th, and 406th, respectively; and
the pixel of the 20th column which forms the 54th row of the partly lacking pattern is turned on 390th.

3. The printing method as claimed in claim 1, wherein the binarization dither matrix pattern is configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixels of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the pixels of the 1st to 19th columns and the 21st to 53rd columns which form the 54th row of the rectangular pattern are cut out,
a turn on order of the 1556 pixels being set such that:
the pixels of the 33rd to 34th columns which form the 1st row of the partly lacking pattern are turned on 805th, and 797th, respectively;
the pixels of the 31st to 35th columns which form the 2nd row of the partly lacking pattern are turned on 821st, 853rd, 869th, 845th, and 789th, respectively;
the pixels of the 29th to 35th columns which form the 3rd row of the partly lacking pattern are turned on 781st, 889th, 925th, 961st, 949th, 913th, and 857th, respectively;
the pixels of the 28th to 36th columns which form the 4th row of the partly lacking pattern are turned on 873rd, 953rd, 989th, 1033rd, 1045th, 1029th, 981st, 933rd, and 829th, respectively;
the pixels of the 26th to 36th columns which form the 5th row of the partly lacking pattern are turned on 837th, 941st, 1021st, 1061st, 1101st, 1125th, 1129th, 1109th, 1069th, 1013th, and 909th, respectively;
the pixels of the 24th to 37th columns which form the 6th row of the partly lacking pattern are turned on 813th, 905th, 1009th, 1077th, 1141st, 1173rd, 1197th, 1213th, 1205th, 1189th, 1149th, 1093rd, 997th, and 885th, respectively;
the pixels of the 23rd to 38th columns which form the 7th row of the partly lacking pattern are turned on 893rd, 977th, 1057th, 1121st, 1181st, 1241st, 1261st, 1281st, 1309th, 1277th, 1253rd, 1229th, 1165th, 1085th, 973rd, and 809th, respectively;
the pixels of the 21st to 38th columns which form the 8th row of the partly lacking pattern are turned on 833rd, 917th, 1001st, 1089th, 1161st, 1221st, 1273rd, 1317th, 1341st, 1365th, 1373rd, 1357th, 1325th, 1285th, 1237th, 1157th, 1053rd, and 901st, respectively;
the pixels of the 19th to 39th columns which form the 9th row of the partly lacking pattern are turned on 793rd, 861st, 937th, 1017th, 1097th, 1169th, 1245th, 1305th, 1337th, 1381st, 1405th, 1421st, 1429th, 1413th, 1389th, 1349th, 1297th, 1217th, 1117th, 1005th, and 841st, respectively;
the pixels of the 18th to 39th columns which form the 10th row of the partly lacking pattern are turned on 801st, 849th, 921st, 985th, 1073rd, 1153rd, 1233rd, 1301st, 1353rd, 1401st, 1441st, 1453rd, 1473rd, 1485th, 1461st, 1445th, 1397th, 1333rd, 1269th, 1185th, 1081st, and 945th, respectively;
the pixels of the 16th to 40th columns which form the 11th row of the partly lacking pattern are turned on 751st, 759th, 817th, 881st, 965th, 1037th, 1113th, 1193rd, 1257th, 1329th, 1393rd, 1449th, 1477th, 1497th, 1509th, 1513th, 1501st, 1469th, 1437th, 1385th, 1321st, 1249th, 1145th, 1025th, and 877th, respectively;
the pixels of the 14th to 41st columns which form the 12th row of the partly lacking pattern are turned on 735th, 703rd, 687th, 711th, 767th, 865th, 969th, 1049th, 1137th, 1209th, 1293rd, 1361st, 1417th, 1465th, 1505th, 1529th, 1537th, 1533rd, 1525th, 1493rd, 1457th, 1409th, 1345th, 1265th, 1177th, 1065th, 957th, and 785th, respectively;
the pixels of the 12th to 41st columns which form the 13th row of the partly lacking pattern are turned on 775th, 667th, 631st, 595th, 607th, 643rd, 699th, 825th, 929th, 1041st, 1133rd, 1225th, 1313th, 1377th, 1433rd, 1489th, 1521st, 1545th, 1553rd, 1549th, 1541st, 1517th, 1481st, 1425th, 1369th, 1289th, 1201st, 1105th, 993rd, and 897th, respectively;
the pixels of the 11th to 42nd columns which form the 14th row of the partly lacking pattern are turned on 683rd, 603rd, 567th, 523rd, 511th, 527th, 575th, 623rd, 727th, 887th, 991st, 1103rd, 1199th, 1283rd, 1367th, 1423rd, 1475th, 1515th, 1539th, 1555th, 1551st, 1535th, 1511th, 1479th, 1431st, 1375th, 1311th, 1215th, 1119th, 1035th, 927th, and 815th, respectively;
the pixels of the 9th to 42nd columns which form the 15th row of the partly lacking pattern are turned on 719th, 615th, 535th, 495th, 455th, 431st, 427th, 447th, 487th, 543rd, 647th, 783rd, 967th, 1067th, 1175th, 1263rd, 1343rd, 1407th, 1455th, 1499th, 1531st, 1547th, 1543rd, 1527th, 1503rd, 1463rd, 1415th, 1359th, 1279th, 1207th, 1131st, 1047th, 947th, and 855th, respectively;
the pixels of the 7th to 43rd columns which form the 16th row of the partly lacking pattern are turned on 743rd, 651st, 547th, 479th, 415th, 383rd, 359th, 343rd, 351st, 367th, 407th, 463rd, 559th, 671st, 879th, 1023rd, 1143rd, 1247th, 1319th, 1383rd, 1443rd, 1483rd, 1507th, 1523rd, 1519th, 1495th, 1471st, 1447th, 1391st, 1327th, 1255th, 1191st, 1107th, 1031st, 943rd, 871st, and 803rd, respectively;
the pixels of the 6th to 43rd columns which form the 17th row of the partly lacking pattern are turned on 663rd, 579th, 499th, 435th, 375th, 315th, 295th, 275th, 247th, 279th, 303rd, 327th, 391st, 471st, 583rd, 747th, 951st, 1079th, 1183rd, 1275th, 1339th, 1403rd, 1451st, 1467th, 1491st, 1487th, 1459th, 1439th, 1399th, 1351st, 1287th, 1231st, 1151st, 1063rd, 983rd, 903rd, 839th, and 799th, respectively;
the pixels of the 4th to 44th columns which form the 18th row of the partly lacking pattern are turned on 723rd, 639th, 555th, 467th, 395th, 335th, 283rd, 239th, 215th, 191st, 183rd, 199th, 231st, 271st, 319th, 399th, 503rd, 655th, 843rd, 1011th, 1127th, 1227th, 1307th, 1355th, 1395th, 1419th, 1435th, 1427th, 1411th, 1387th, 1335th, 1303rd, 1239th, 1167th, 1095th, 1015th, 935th, 863rd, 787th, 752nd, and 760th, respectively;
the pixels of the 2nd to 45th columns which form the 19th row of the partly lacking pattern are turned on 763rd, 695th, 619th, 539th, 459th, 387th, 311th, 251st, 219th, 175th, 151st, 135th, 127th, 143rd, 167th, 207th, 259th, 339th, 439th, 551st, 715th, 919th, 1059th, 1163rd, 1243rd, 1299th, 1331st, 1363rd, 1379th, 1371st, 1347th, 1323rd, 1271st, 1223rd, 1159th, 1087th, 999th, 911th, 831st, 736th, 704th, 688th, 712th, and 768th, respectively;
the pixels of the 1st to 45th columns which form the 20th row of the partly lacking pattern are turned on 755th, 707th, 635th, 571st, 483rd, 403rd, 323rd, 255th, 203rd, 155th, 115th, 103rd, 83rd, 71st, 95th, 111th, 159th, 223rd, 287th, 371st, 475th, 611th, 823rd, 979th, 1091st, 1171st, 1235th, 1259th, 1291st, 1315th, 1295th, 1267th, 1251st, 1187th, 1123rd, 1055th, 975th, 895th, 776th, 668th, 632nd, 596th, 608th, 644th, and 700th, respectively;
the pixels of the 1st to 46th columns which form the 21st row of the partly lacking pattern are turned on 739th, 675th, 591st, 519th, 443rd, 363rd, 299th, 227th, 163rd, 107th, 79th, 59th, 47th, 43rd, 55th, 87th, 119th, 171st, 235th, 307th, 411th, 531st, 679th, 899th, 1003rd, 1099th, 1155th, 1195th, 1211th, 1219th, 1203rd, 1179th, 1147th, 1083rd, 1007th, 915th, 819th, 684th, 604th, 568th, 524th, 512th, 528th, 576th, 624th, and 728th, respectively;
the pixels of the 2nd to 46th columns which form the 22nd row of the partly lacking pattern are turned on 691st, 587th, 507th, 419th, 347th, 263rd, 195th, 139th, 91st, 51st, 27th, 19th, 23rd, 31st, 63rd, 99th, 147th, 211th, 291st, 379th, 491st, 599th, 771st, 923rd, 1019th, 1075th, 1115th, 1139th, 1135th, 1111th, 1071st, 1027th, 955th, 847th, 720th, 616th, 536th, 496th, 456th, 432nd, 428th, 448th, 488th, 544th, and 648th, respectively;
the pixels of the 2nd to 47th columns which form the 23rd row of the partly lacking pattern are turned on 731st, 627th, 515th, 423rd, 331st, 243rd, 179th, 123rd, 67th, 35th, 11th, 3rd, 7th, 15th, 39th, 75th, 131st, 187th, 267th, 355th, 451st, 563rd, 659th, 835th, 939th, 987th, 1039th, 1051st, 1043rd, 995th, 971st, 883rd, 744th, 652nd, 548th, 480th, 416th, 384th, 360th, 344th, 352nd, 368th, 408th, 464th, 560th, and 672nd, respectively;
the pixels of the 3rd to 48th columns which form the 24th row of the partly lacking pattern are turned on 669th, 565th, 453rd, 357th, 273rd, 189th, 133rd, 81st, 41st, 17th, 1st, 5th, 21st, 45th, 77th, 125th, 181st, 245th, 341st, 437th, 521st, 629th, 741st, 867th, 907th, 959th, 963rd, 931st, 891st, 791st, 664th, 580th, 500th, 436th, 376th, 316th, 296th, 276th, 248th, 280th, 304th, 328th, 392nd, 472nd, 584th, and 748th, respectively;
the pixels of the 3rd to 48th columns which form the 25th row of the partly lacking pattern are turned on 773rd, 589th, 489th, 381st, 293rd, 213th, 149th, 101st, 57th, 25th, 9th, 13th, 29th, 53rd, 93rd, 141st, 197th, 277th, 349th, 425th, 509th, 609th, 701st, 795th, 851st, 875th, 859th, 827th, 724th, 640th, 556th, 468th, 396th, 336th, 284th, 240th, 216th, 192nd, 184th, 200th, 232nd, 272nd, 320th, 400th, 504th, and 656th, respectively;
the pixels of the 4th to 49th columns which form the 26th row of the partly lacking pattern are turned on 677th, 533rd, 413th, 309th, 237th, 173rd, 113th, 73rd, 49th, 33rd, 37th, 61st, 85th, 109th, 165th, 229th, 301st, 365th, 449th, 525th, 613th, 685th, 753rd, 807th, 811th, 764th, 696th, 620th, 540th, 460th, 388th, 312th, 252nd, 220th, 176th, 152nd, 136th, 128th, 144th, 168th, 208th, 260th, 340th, 440th, 552nd, and 716th, respectively;
the pixels of the 5th to 49th columns which form the 27th row of the partly lacking pattern are turned on 605th, 477th, 373rd, 281st, 217th, 153rd, 105th, 89th, 65th, 69th, 97th, 117th, 157th, 205th, 269th, 325th, 405th, 493rd, 573rd, 653rd, 717th, 757th, 779th, 756th, 708th, 636th, 572nd, 484th, 404th, 324th, 256th, 204th, 156th, 116th, 104th, 84th, 72nd, 96th, 112th, 160th, 224th, 288th, 372nd, 476th, and 612th, respectively;
the pixels of the 5th to 50th columns which form the 28th row of the partly lacking pattern are turned on 713th, 545th, 429th, 329th, 249th, 201st, 161st, 137th, 121st, 129th, 145th, 169th, 221st, 253rd, 317th, 389th, 461st, 541st, 621st, 693rd, 769th, 806th, 798th, 740th, 676th, 592nd, 520th, 444th, 364th, 300th, 228th, 164th, 108th, 80th, 60th, 48th, 44th, 56th, 88th, 120th, 172nd, 236th, 308th, 412th, 532nd, and 680th, respectively;
the pixels of the 6th to 51st columns which form the 29th row of the partly lacking pattern are turned on 637th, 497th, 393rd, 313th, 257th, 225th, 193rd, 177th, 185th, 209th, 233rd, 285th, 333rd, 397th, 469th, 557th, 645th, 725th, 822nd, 854th, 870th, 846th, 790th, 692nd, 588th, 508th, 420th, 348th, 264th, 196th, 140th, 92nd, 52nd, 28th, 20th, 24th, 32nd, 64th, 100th, 148th, 212th, 292nd, 380th, 492nd, 600th, and 772nd, respectively;
the pixels of the 6th to 51st columns which form the 30th row of the partly lacking pattern are turned on 733rd, 577th, 465th, 385th, 321st, 297th, 265th, 241st, 261st, 289th, 305th, 369th, 433rd, 501st, 581st, 661st, 782nd, 890th, 926th, 962nd, 950th, 914th, 858th, 732nd, 628th, 516th, 424th, 332nd, 244th, 180th, 124th, 68th, 36th, 12th, 4th, 8th, 16th, 40th, 76th, 132nd, 188th, 268th, 356th, 452nd, 564th, and 660th, respectively;
the pixels of the 7th to 52nd columns which form the 31st row of the partly lacking pattern are turned on 657th, 553rd, 457th, 401st, 361st, 345th, 337th, 353rd, 377th, 409th, 473rd, 549th, 641st, 737th, 874th, 954th, 990th, 1034th, 1046th, 1030th, 982nd, 934th, 830th, 670th, 566th, 454th, 358th, 274th, 190th, 134th, 82nd, 42nd, 18th, 2nd, 6th, 22nd, 46th, 78th, 126th, 182nd, 246th, 342nd, 438th, 522nd, 630th, and 742nd, respectively;
the pixels of the 8th to 52nd columns which form the 32nd row of the partly lacking pattern are turned on 633rd, 537th, 481st, 441st, 417th, 421st, 445th, 485th, 529th, 601st, 709th, 838th, 942nd, 1022nd, 1062nd, 1102nd, 1126th, 1130th, 1110th, 1070th, 1014th, 910th, 774th, 590th, 490th, 382nd, 294th, 214th, 150th, 102nd, 58th, 26th, 10th, 14th, 30th, 54th, 94th, 142nd, 198th, 278th, 350th, 426th, 510th, 610th, and 702nd, respectively;
the pixels of the 8th to 53rd columns which form the 33rd row of the partly lacking pattern are turned on 721st, 617th, 569th, 517th, 505th, 513th, 561st, 585th, 673rd, 814th, 906th, 1010th, 1078th, 1142nd, 1174th, 1198th, 1214th, 1206th, 1190th, 1150th, 1094th, 998th, 886th, 678th, 534th, 414th, 310th, 238th, 174th, 114th, 74th, 50th, 34th, 38th, 62nd, 86th, 110th, 166th, 230th, 302nd, 366th, 450th, 526th, 614th, 686th, and 754th, respectively;
the pixels of the 9th to 53rd columns which form the 34th row of the partly lacking pattern are turned on 689th, 649th, 597th, 593rd, 625th, 665th, 765th, 894th, 978th, 1058th, 1122nd, 1182nd, 1242nd, 1262nd, 1282nd, 1310th, 1278th, 1254th, 1230th, 1166th, 1086th, 974th, 810th, 606th, 478th, 374th, 282nd, 218th, 154th, 106th, 90th, 66th, 70th, 98th, 118th, 158th, 206th, 270th, 326th, 406th, 494th, 574th, 654th, 718th, and 758th, respectively;
the pixels of the 9th to 52nd columns which form the 35th row of the partly lacking pattern are turned on 761st, 705th, 681st, 697th, 729th, 834th, 918th, 1002nd, 1090th, 1162nd, 1222nd, 1274th, 1318th, 1342nd, 1366th, 1374th, 1358th, 1326th, 1286th, 1238th, 1158th, 1054th, 902nd, 714th, 546th, 430th, 330th, 250th, 202nd, 162nd, 138th, 122nd, 130th, 146th, 170th, 222nd, 254th, 318th, 390th, 462nd, 542nd, 622nd, 694th, and 770th, respectively;
the pixels of the 10th to 50th columns which form the 36th row of the partly lacking pattern are turned on 749th, 745th, 794th, 862nd, 938th, 1018th, 1098th, 1170th, 1246th, 1306th, 1338th, 1382nd, 1406th, 1422nd, 1430th, 1414th, 1390th, 1350th, 1298th, 1218th, 1118th, 1006th, 842nd, 638th, 498th, 394th, 314th, 258th, 226th, 194th, 178th, 186th, 210th, 234th, 286th, 334th, 398th, 470th, 558th, 646th, and 726th, respectively;
the pixels of the 10th to 48th columns which form the 37th row of the partly lacking pattern are turned on 777th, 802nd, 850th, 922nd, 986th, 1074th, 1154th, 1234th, 1302nd, 1354th, 1402nd, 1442nd, 1454th, 1474th, 1486th, 1462nd, 1446th, 1398th, 1334th, 1270th, 1186th, 1082nd, 946th, 734th, 578th, 466th, 386th, 322nd, 298th, 266th, 242nd, 262nd, 290th, 306th, 370th, 434th, 502nd, 582nd, and 662nd, respectively;
the pixels of the 11th to 47th columns which form the 38th row of the partly lacking pattern are turned on 818th, 882nd, 966th, 1038th, 1114th, 1194th, 1258th, 1330th, 1394th, 1450th, 1478th, 1498th, 1510th, 1514th, 1502nd, 1470th, 1438th, 1386th, 1322nd, 1250th, 1146th, 1026th, 878th, 658th, 554th, 458th, 402nd, 362nd, 346th, 338th, 354th, 378th, 410th, 474th, 550th, 642nd, and 738th, respectively;
the pixels of the 12th to 45th columns which form the 39th row of the partly lacking pattern are turned on 866th, 970th, 1050th, 1138th, 1210th, 1294th, 1362nd, 1418th, 1466th, 1506th, 1530th, 1538th, 1534th, 1526th, 1494th, 1458th, 1410th, 1346th, 1266th, 1178th, 1066th, 958th, 786th, 634th, 538th, 482nd, 442nd, 418th, 422nd, 446th, 486th, 530th, 602nd, and 710th, respectively;
the pixels of the 12th to 43rd columns which form the 40th row of the partly lacking pattern are turned on 826th, 930th, 1042nd, 1134th, 1226th, 1314th, 1378th, 1434th, 1490th, 1522nd, 1546th, 1554th, 1550th, 1542nd, 1518th, 1482nd, 1426th, 1370th, 1290th, 1202nd, 1106th, 994th, 898th, 722nd, 618th, 570th, 518th, 506th, 514th, 562nd, 586th, and 674th, respectively;
the pixels of the 13th to 42nd columns which form the 41st row of the partly lacking pattern are turned on 888th, 992nd, 1104th, 1200th, 1284th, 1368th, 1424th, 1476th, 1516th, 1540th, 1556th, 1552nd, 1536th, 1512th, 1480th, 1432nd, 1376th, 1312th, 1216th, 1120th, 1036th, 928th, 816th, 690th, 650th, 598th, 594th, 626th, 666th, and 766th, respectively;
the pixels of the 13th to 40th columns which form the 42nd row of the partly lacking pattern are turned on 784th, 968th, 1068th, 1176th, 1264th, 1344th, 1408th, 1456th, 1500th, 1532nd, 1548th, 1544th, 1528th, 1504th, 1464th, 1416th, 1360th, 1280th, 1208th, 1132nd, 1048th, 948th, 856th, 762nd, 706th, 682nd, 698th, and 730th, respectively;
the pixels of the 14th to 38th columns which form the 43rd row of the partly lacking pattern are turned on 880th, 1024th, 1144th, 1248th, 1320th, 1384th, 1444th, 1484th, 1508th, 1524th, 1520th, 1496th, 1472nd, 1448th, 1392nd, 1328th, 1256th, 1192nd, 1108th, 1032nd, 944th, 872nd, 804th, 750th, and 746th, respectively;
the pixels of the 15th to 37th columns which form the 44th row of the partly lacking pattern are turned on 952nd, 1080th, 1184th, 1276th, 1340th, 1404th, 1452nd, 1468th, 1492nd, 1488th, 1460th, 1440th, 1400th, 1352nd, 1288th, 1232nd, 1152nd, 1064th, 984th, 904th, 840th, 800th, and 778th, respectively;
the pixels of the 15th to 35th columns which form the 45th row of the partly lacking pattern are turned on 844th, 1012th, 1128th, 1228th, 1308th, 1356th, 1396th, 1420th, 1436th, 1428th, 1412th, 1388th, 1336th, 1304th, 1240th, 1168th, 1096th, 1016th, 936th, 864th, and 788th, respectively;
the pixels of the 16th to 33rd columns which form the 46th row of the partly lacking pattern are turned on 920th, 1060th, 1164th, 1244th, 1300th, 1332nd, 1364th, 1380th, 1372nd, 1348th, 1324th, 1272nd, 1224th, 1160th, 1088th, 1000th, 912th, and 832nd, respectively;
the pixels of the 16th to 31st columns which form the 47th row of the partly lacking pattern are turned on 824th, 980th, 1092nd, 1172nd, 1236th, 1260th, 1292nd, 1316th, 1296th, 1268th, 1252nd, 1188th, 1124th, 1056th, 976th, and 896th, respectively;
the pixels of the 17th to 30th columns which form the 48th row of the partly lacking pattern are turned on 900th, 1004th, 1100th, 1156th, 1196th, 1212th, 1220th, 1204th, 1180th, 1148th, 1084th, 1008th, 916th, and 820th, respectively;
the pixels of the 18th to 28th columns which form the 49th row of the partly lacking pattern are turned on 924th, 1020th, 1076th, 1116th, 1140th, 1136th, 1112th, 1072nd, 1028th, 956th, and 848th, respectively;
the pixels of the 18th to 26th columns which form the 50th row of the partly lacking pattern are turned on 836th, 940th, 988th, 1040th, 1052nd, 1044th, 996th, 972nd, and 884th, respectively;
the pixels of the 19th to 25th columns which form the 51st row of the partly lacking pattern are turned on 868th, 908th, 960th, 964th, 932nd, 892nd, and 792nd, respectively;
the pixels of the 19th to 23rd columns which form the 52nd row of the partly lacking pattern are turned on 796th, 852nd, 876th, 860th, and 828th, respectively;
the pixels of the 20th to 21st columns which form the 53rd row of the partly lacking pattern are turned on 808th, and 812th, respectively; and
the pixel of the 20th column which forms the 54th row of the partly lacking pattern is turned on 780th.

4. The printing method as claimed in claim 2, wherein the binarization dither matrix pattern is configured by exchanging the turn-on order set to arbitrary pixels in the binarization dither matrix pattern and a turn-on order set to pixels at point symmetric positions to the arbitrary pixels with respect to a specific point regarding halftone dots to which the arbitrary pixels belong for each other.

5. The printing method as claimed in claim 3, wherein the binarization dither matrix pattern is configured by exchanging the turn-on order set to arbitrary pixels in the binarization dither matrix pattern and a turn-on order set to pixels at point symmetric positions to the arbitrary pixels with respect to a specific point regarding halftone dots to which the arbitrary pixels belong for each other.

6. The printing method as claimed in claim 2, wherein, at the image forming step, the binarization dither matrix pattern is used after rotated 90 degrees or 270 degrees.

7. The printing method as claimed in claim 3, wherein, at the image forming step, the binarization dither matrix pattern is used after rotated 90 degrees or 270 degrees.

8. The printing method as claimed in claim 1, further comprising:
an image forming order changing step of changing an image forming order based on a lookup table;
the image being formed, at the image forming step, based on the image forming order changed at the image forming order changing step.

9. The printing method as claimed in claim 2, further comprising:
an image forming order changing step of changing an image forming order based on a lookup table;
the image being formed, at the image forming step, based on the image forming order changed at the image forming order changing step.

10. A printing system, comprising:
a binarization processing section for performing a binarization process of a multi-value image based on a binarization dither matrix pattern; and
a printing apparatus having an image forming section for forming an image on a medium based on a result of the binarization process performed by said binarization processing section;
the binarization dither matrix pattern being configured by arranging a plurality of pixels to be successively turned on in a matrix;
the binarization dither matrix pattern having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots,
the turned on pixels and unturned on pixels forming a checkered pattern in the binarization dither matrix pattern when a number of pixels substantially equal to one half the number of pixels which form the binarization dither matrix pattern are turned on in order.

11. The printing system as claimed in claim 10, further comprising:
an image forming order changing section for changing an image forming order based on a lookup table;
said image forming section forming the image based on the image forming order changed in the image forming order changing section.

12. A printing apparatus, comprising:
a storage area for expanding a multi-value image;
a binarization dither matrix pattern setting section for setting a binarization dither matrix pattern configured by arranging a plurality of pixels to be successively turned on in a matrix and having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order;
a binarization processing section for selecting, in accordance with the turn-on order, pixels from the starting pixel of the turn-on order to a pixel to which a predetermined turn-on order number is set in the binarization dither matrix pattern set by said binarization dither matrix pattern setting section based on the pixel values of the multi-value image expanded in said storage area to decide pixels of an object of formation of a color material; and
an image forming section for forming a color material for the pixels selected by the binarization processing section to form an image.

13. The printing method as claimed in claim 12, further comprising:
an image forming order changing section for changing an image forming order based on a lookup table;
said image forming section forming the image based on the image forming order changed by said image forming order changing section.

14. A binarization dither matrix pattern for use for binarization of a multi-value image, comprising:
a plurality of pixels arranged in a matrix to be successively turned on;
a plurality of specific points being provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots;
the turned on pixels and unturned on pixels forming a checkered pattern in the binarization dither matrix pattern when a number of pixels substantially equal to one half the number of pixels which form the binarization dither matrix pattern are turned on in order.

15. The binarization dither matrix pattern as claimed in claim 14, wherein the binarization dither matrix pattern is configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixel of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the 1st to 19th columns and the 21st to 53rd columns which form the 54th row of the rectangular pattern are cut out,
a turn on order of the 1556 pixels being set such that:
the pixels of the 33rd to 34th columns which form the 1st row of the partly lacking pattern are turned on 403rd, and 399th, respectively;
the pixels of the 31st to 35th columns which form the 2nd row of the partly lacking pattern are turned on 411th, 427th, 435th, 423rd, and 395th, respectively;
the pixels of the 29th to 35th columns which form the 3rd row of the partly lacking pattern are turned on 391st, 445th, 463rd, 481st, 475th, 457th, and 429th, respectively;
the pixels of the 28th to 36th columns which form the 4th row of the partly lacking pattern are turned on 437th, 477th, 495th, 517th, 523rd, 515th, 491st, 467th, and 415th, respectively;
the pixels of the 26th to 36th columns which form the 5th row of the partly lacking pattern are turned on 419th, 471st, 511th, 531st, 551st, 563rd, 565th, 555th, 535th, 507th, and 455th, respectively;
the pixels of the 24th to 37th columns which form the 6th row of the partly lacking pattern are turned on 407th, 453rd, 505th, 539th, 571st, 587th, 599th, 607th, 603rd, 595th, 575th, 547th, 499th, and 443rd, respectively;
the pixels of the 23rd to 38th columns which form the 7th row of the partly lacking pattern are turned on 447th, 489th, 529th, 561st, 591st, 621st, 631st, 641st, 655th, 639th, 627th, 615th, 583rd, 543rd, 487th, and 405th, respectively;
the pixels of the 21st to 38th columns which form the 8th row of the partly lacking pattern are turned on 417th, 459th, 501st, 545th, 581st, 611th, 637th, 659th, 671st, 683rd, 687th, 679th, 663rd, 643rd, 619th, 579th, 527th, and 451st, respectively;
the pixels of the 19th to 39th columns which form the 9th row of the partly lacking pattern are turned on 397th, 431st, 469th, 509th, 549th, 585th, 1623rd, 653rd, 669th, 691st, 703rd, 711th, 715th, 707th, 695th, 675th, 649th, 609th, 559th, 503rd, and 421st, respectively;
the pixels of the 18th to 39th columns which form the 10th row of the partly lacking pattern are turned on 401st, 425th, 461st, 493rd, 537th, 577th, 617th, 651st, 677th, 701st, 721st, 727th, 737th, 743rd, 731st, 723rd, 699th, 667th, 635th, 593rd, 541st, and 473rd, respectively;
the pixels of the 16th to 40th columns which form the 11th row of the partly lacking pattern are turned on 376th, 380th, 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, and 439th, respectively;
the pixels of the 14th to 41st columns which form the 12th row of the partly lacking pattern are turned on 368th, 352nd, 344th, 356th, 384th, 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, and 393rd, respectively;
the pixels of the 12th to 41st columns which form the 13th row of the partly lacking pattern are turned on 388th, 334th, 316th, 298th, 304th, 322nd, 350th, 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, and 449th, respectively;
the pixels of the 11th to 42nd columns which form the 14th row of the partly lacking pattern are turned on 342nd, 302nd, 284th, 262nd, 256th, 264th, 288th, 312th, 364th, 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, and 408th, respectively;
the pixels of the 9th to 42nd columns which form the 15th row of the partly lacking pattern are turned on 360th, 308th, 268th, 248th, 228th, 216th, 214th, 224th, 244th, 272nd, 324th, 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, and 428th, respectively;
the pixels of the 7th to 43rd columns which form the 16th row of the partly lacking pattern are turned on 372nd, 326th, 274th, 240th, 208th, 192nd, 180th, 172nd, 176th, 184th, 204th, 232nd, 280th, 336th, 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, and 402nd, respectively;
the pixels of the 6th to 43rd columns which form the 17th row of the partly lacking pattern are turned on 332nd, 290th, 250th, 218th, 188th, 158th, 148th, 138th, 124th, 140th, 152nd, 164th, 196th, 236th, 292nd, 374th, 476th, 540th, 592nd, 638th, 670th, 702nd, 726th, 734th, 746th, 744th, 730th, 720th, 700th, 676th, 644th, 616th, 576th, 532nd, 492nd, 452nd, 420th, and 400th, respectively;
the pixels of the 4th to 44th columns which form the 18th row of the partly lacking pattern are turned on 362nd, 320th, 278th, 234th, 198th, 168th, 142nd, 120th, 108th, 96th, 92nd, 100th, 116th, 136th, 160th, 200th, 252nd, 328th, 422nd, 506th, 564th, 614th, 654th, 678th, 698th, 710th, 718th, 714th, 706th, 694th, 668th, 652nd, 620th, 584th, 548th, 508th, 468th, 432nd, 394th, 376th, and 380th, respectively;
the pixels of the 2nd to 45th columns which form the 19th row of the partly lacking pattern are turned on 382nd, 348th, 310th, 270th, 230th, 194th, 156th, 126th, 110th, 88th, 76th, 68th, 64th, 72nd, 84th, 104th, 130th, 170th, 220th, 276th, 358th, 460th, 530th, 582nd, 622nd, 650th, 666th, 682nd, 690th, 686th, 674th, 662nd, 636th, 612th, 580th, 544th, 500th, 456th, 416th, 368th, 352nd, 344th, 356th, and 384th, respectively;
the pixels of the 1st to 45th columns which form the 20th row of the partly lacking pattern are turned on 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, 306th, 412th, 490th, 546th, 586th, 618th, 630th, 646th, 658th, 648th, 634th, 626th, 594th, 562nd, 528th, 488th, 448th, 388th, 334th, 316th, 298th, 304th, 322nd, and 350th, respectively;
the pixels of the 1st to 46th columns which form the 21st row of the partly lacking pattern are turned on 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, 340th, 450th, 502nd, 550th, 578th, 598th, 606th, 610th, 602nd, 590th, 574th, 542nd, 504th, 458th, 410th, 342nd, 302nd, 284th, 262nd, 256th, 264th, 288th, 312th, and 364th, respectively;
the pixels of the 2nd to 46th columns which form the 22nd row of the partly lacking pattern are turned on 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, 386th, 462nd, 510th, 538th, 558th, 570th, 568th, 556th, 536th, 514th, 478th, 424th, 360th, 308th, 268th, 248th, 228th, 216th, 214th, 224th, 244th, 272nd, and 324th, respectively;
the pixels of the 2nd to 47th columns which form the 23rd row of the partly lacking pattern are turned on 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, 330th, 418th, 470th, 494th, 520th, 526th, 522nd, 498th, 486th, 442nd, 372nd, 326th, 274th, 240th, 208th, 192nd, 180th, 172nd, 176th, 184th, 204th, 232nd, 280th, and 336th, respectively;
the pixels of the 3rd to 48th columns which form the 24th row of the partly lacking pattern are turned on 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, 371st, 434th, 454th, 480th, 482nd, 466th, 446th, 396th, 332nd, 290th, 250th, 218th, 188th, 158th, 148th, 138th, 124th, 140th, 152nd, 164th, 196th, 236th, 292nd, and 374th, respectively;
the pixels of the 3rd to 48th columns which form the 25th row of the partly lacking pattern are turned on 387th, 295th, 245th, 191st, 147th, 107th, 75th, 51st, 29th, 13th, 5th, 7th, 15th, 27th, 47th, 71st, 99th, 139th, 175th, 213th, 255th, 305th, 351st, 398th, 426th, 438th, 430th, 414th, 362nd, 320th, 278th, 234th, 198th, 168th, 142nd, 120th, 108th, 96th, 92nd, 100th, 116th, 136th, 160th, 200th, 252nd, and 328th, respectively;
the pixels of the 4th to 49th columns which form the 26th row of the partly lacking pattern are turned on 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, 377th, 404th, 406th, 382nd, 348th, 310th, 270th, 230th, 194th, 156th, 126th, 110th, 88th, 76th, 68th, 64th, 72nd, 84th, 104th, 130th, 170th, 220th, 276th, and 358th, respectively;
the pixels of the 5th to 49th columns which form the 27th row of the partly lacking pattern are turned on 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, 379th, 390th, 378th, 354th, 318th, 286th, 242nd, 202nd, 162nd, 128th, 102nd, 78th, 58th, 52nd, 42nd, 36th, 48th, 56th, 80th, 112th, 144th, 186th, 238th, and 306th, respectively;
the pixels of the 5th to 50th columns which form the 28th row of the partly lacking pattern are turned on 357th, 273rd, 215th, 165th, 125th, 101st, 81st, 69th, 61st, 65th, 73rd, 85th, 111th, 127th, 159th, 195th, 231st, 271st, 311th, 347th, 385th, 403rd, 399th, 370th, 338th, 296th, 260th, 222nd, 182nd, 150th, 114th, 82nd, 54th, 40th, 30th, 24th, 22nd, 28th, 44th, 60th, 86th, 118th, 154th, 206th, 266th, and 340th, respectively;
the pixels of the 6th to 51st columns which form the 29th row of the partly lacking pattern are turned on 319th, 249th, 197th, 157th, 129th, 113th, 97th, 89th, 93rd, 105th, 117th, 143rd, 167th, 199th, 235th, 279th, 323rd, 363rd, 411th, 427th, 435th, 423rd, 395th, 346th, 294th, 254th, 210th, 174th, 132nd, 98th, 70th, 46th, 26th, 14th, 10th, 12th, 16th, 32nd, 50th, 74th, 106th, 146th, 190th, 246th, 300th, and 386th, respectively;
the pixels of the 6th to 51st columns which form the 30th row of the partly lacking pattern are turned on 367th, 289th, 233rd, 193rd, 161st, 149th, 133rd, 121st, 131st, 145th, 153rd, 185th, 217th, 251st, 291st, 331st, 391st, 445th, 463rd, 481st, 475th, 457th, 429th, 366th, 314th, 258th, 212th, 166th, 122nd, 90th, 62nd, 34th, 18th, 6th, 2nd, 4th, 8th, 20th, 38th, 66th, 94th, 134th, 178th, 226th, 282nd, and 330th, respectively;
the pixels of the 7th to 52nd columns which form the 31st row of the partly lacking pattern are turned on 329th, 277th, 229th, 201st, 181st, 173rd, 169th, 177th, 189th, 205th, 237th, 275th, 321st, 369th, 437th, 477th, 495th, 517th, 523rd, 515th, 491st, 467th, 415th, 335th, 283rd, 227th, 179th, 137th, 95th, 67th, 41st, 21st, 9th, 1st, 3rd, 11th, 23rd, 39th, 63rd, 91st, 123rd, 171st, 219th, 261st, 315th, and 371st, respectively;
the pixels of the 8th to 52nd columns which form the 32nd row of the partly lacking pattern are turned on 317th, 269th, 241st, 221st, 209th, 211th, 223rd, 243rd, 265th, 301st, 355th, 419th, 471st, 511th, 531st, 551st, 563rd, 565th, 555th, 535th, 507th, 455th, 387th, 295th, 245th, 191st, 147th, 107th, 75th, 51st, 29th, 13th, 5th, 7th, 15th, 27th, 47th, 71st, 99th, 139th, 175th, 213th, 255th, 305th, and 351st, respectively;
the pixels of the 8th to 53rd columns which form the 33rd row of the partly lacking pattern are turned on 361st, 309th, 285th, 259th, 253rd, 257th, 281st, 293rd, 337th, 407th, 453rd, 505th, 539th, 571st, 587th, 599th, 607th, 603rd, 595th, 575th, 547th, 499th, 443rd, 339th, 267th, 207th, 155th, 119th, 87th, 57th, 37th, 25th, 17th, 19th, 31st, 43rd, 55th, 83rd, 115th, 151st, 183rd, 225th, 263rd, 307th, 343rd, and 377th, respectively;
the pixels of the 9th to 53rd columns which form the 34th row of the partly lacking pattern are turned on 345th, 325th, 299th, 297th, 313th, 333rd, 383rd, 447th, 489th, 529th, 561st, 591st, 621st, 631st, 641st, 655th, 639th, 627th, 615th, 583rd, 543rd, 487th, 405th, 303rd, 239th, 187th, 141st, 109th, 77th, 53rd, 45th, 33rd, 35th, 49th, 59th, 79th, 103rd, 135th, 163rd, 203rd, 247th, 287th, 327th, 359th, and 379th, respectively;
the pixels of the 9th to 52nd columns which form the 35th row of the partly lacking pattern are turned on 381st, 353rd, 341st, 349th, 365th, 417th, 459th, 501st, 545th, 581st, 611th, 637th, 659th, 671st, 683rd, 687th, 679th, 663rd, 643rd, 619th, 579th, 527th, 451st, 357th, 273rd, 215th, 165th, 125th, 101st, 81st, 69th, 61st, 65th, 73rd, 85th, 111th, 127th, 159th, 195th, 231st, 271st, 311th, 347th, and 385th, respectively;
the pixels of the 10th to 50th columns which form the 36th row of the partly lacking pattern are turned on 375th, 373rd, 397th, 431st, 469th, 509th, 549th, 585th, 623rd, 653rd, 669th, 691st, 703rd, 711th, 715th, 707th, 695th, 675th, 649th, 609th, 559th, 503rd, 421st, 319th, 249th, 197th, 157th, 129th, 113th, 97th, 89th, 93rd, 105th, 117th, 143rd, 167th, 199th, 235th, 279th, 323rd, and 363rd, respectively;
the pixels of the 10th to 48th columns which form the 37th row of the partly lacking pattern are turned on 389th, 401st, 425th, 461st, 493rd, 537th, 577th, 617th, 651st, 677th, 701st, 721st, 727th, 737th, 743rd, 731st, 723rd, 699th, 667th, 635th, 593rd, 541st, 473rd, 367th, 289th, 233rd, 193rd, 161st, 149th, 133rd, 121st, 131st, 145th, 153rd, 185th, 217th, 251st, 291st, and 331st, respectively;
the pixels of the 11th to 47th columns which form the 38th row of the partly lacking pattern are turned on 409th, 441st, 483rd, 519th, 557th, 597th, 629th, 665th, 697th, 725th, 739th, 749th, 755th, 757th, 751st, 735th, 719th, 693rd, 661st, 625th, 573rd, 513th, 439th, 329th, 277th, 229th, 201st, 181st, 173rd, 169th, 177th, 189th, 205th, 237th, 275th, 321st, and 369th, respectively;
the pixels of the 12th to 45th columns which form the 39th row of the partly lacking pattern are turned on 433rd, 485th, 525th, 569th, 605th, 647th, 681st, 709th, 733rd, 753rd, 765th, 769th, 767th, 763rd, 747th, 729th, 705th, 673rd, 633rd, 589th, 533rd, 479th, 393rd, 317th, 269th, 241st, 221st, 209th, 211th, 223rd, 243rd, 265th, 301st, and 355th, respectively;
the pixels of the 12th to 43rd columns which form the 40th row of the partly lacking pattern are turned on 413th, 465th, 521st, 567th, 613th, 657th, 689th, 717th, 745th, 761st, 773rd, 777th, 775th, 771st, 759th, 741st, 713th, 685th, 645th, 601st, 553rd, 497th, 449th, 361st, 309th, 285th, 259th, 253rd, 257th, 281st, 293rd, and 337th, respectively;
the pixels of the 13th to 42nd columns which form the 41st row of the partly lacking pattern are turned on 444th, 496th, 552nd, 600th, 642nd, 684th, 712th, 738th, 758th, 770th, 778th, 776th, 768th, 756th, 740th, 716th, 688th, 656th, 608th, 560th, 518th, 464th, 408th, 345th, 325th, 299th, 297th, 313th, 333rd, and 383rd, respectively;
the pixels of the 13th to 40th columns which form the 42nd row of the partly lacking pattern are turned on 392nd, 484th, 534th, 588th, 632nd, 672nd, 704th, 728th, 750th, 766th, 774th, 772nd, 764th, 752nd, 732nd, 708th, 680th, 640th, 604th, 566th, 524th, 474th, 428th, 381st, 353rd, 341st, 349th, and 365th, respectively;
the pixels of the 14th to 38th columns which form the 43rd row of the partly lacking pattern are turned on 440th, 512th, 572nd, 624th, 660th, 692nd, 722nd, 742nd, 754th, 762nd, 760th, 748th, 736th, 724th, 696th, 664th, 628th, 596th, 554th, 516th, 472nd, 436th, 402nd, 375th, and 373rd, respectively;
the pixels of the 15th to 37th columns which form the 44th row of the partly lacking pattern are turned on 476th, 540th, 592nd, 638th, 670th, 702nd, 726th, 734th, 746th, 744th, 730th, 720th, 700th, 676th, 644th, 616th, 576th, 532nd, 492nd, 452nd, 420th, 400th, and 389th, respectively;
the pixels of the 15th to 35th columns which form the 45th row of the partly lacking pattern are turned on 422nd, 506th, 564th, 614th, 654th, 678th, 698th, 710th, 718th, 714th, 706th, 694th, 668th, 652nd, 620th, 584th, 548th, 508th, 468th, 432nd, and 394th, respectively;
the pixels of the 16th to 33rd columns which form the 46th row of the partly lacking pattern are turned on 460th, 530th, 582nd, 622nd, 650th, 666th, 682nd, 690th, 686th, 674th, 662nd, 636th, 612th, 580th, 544th, 500th, 456th, and 416th, respectively;
the pixels of the 16th to 31st columns which form the 47th row of the partly lacking pattern are turned on 412th, 490th, 546th, 586th, 618th, 630th, 646th, 658th, 648th, 634th, 626th, 594th, 562nd, 528th, 488th, and 448th, respectively;
the pixels of the 17th to 30th columns which form the 48th row of the partly lacking pattern are turned on 450th, 502nd, 550th, 578th, 598th, 606th, 610th, 602nd, 590th, 574th, 542nd, 504th, 458th, and 410th, respectively;
the pixels of the 18th to 28th columns which form the 49th row of the partly lacking pattern are turned on 462nd, 510th, 538th, 558th, 570th, 568th, 556th, 536th, 514th, 478th, and 424th, respectively;
the pixels of the 18th to 26th columns which form the 50th row of the partly lacking pattern are turned on 418th, 470th, 494th, 520th, 526th, 522nd, 498th, 486th, and 442nd, respectively;
the pixels of the 19th to 25th columns which form the 51st row of the partly lacking pattern are turned on 434th, 454th, 480th, 482nd, 466th, 446th, and 396th, respectively;
the pixels of the 19th to 23rd columns which form the 52nd row of the partly lacking pattern are turned on 398th, 426th, 438th, 430th, and 414th, respectively;
the pixels of the 20th to 21st columns which form the 53rd row of the partly lacking pattern are turned on 404th, and 406th, respectively; and
the pixel of the 20th column which forms the 54th row of the partly lacking pattern is turned on 390th.

16. The binarization dither matrix pattern as claimed in claim 14, wherein the binarization dither matrix pattern is configured as a partly lacking pattern wherein, from among a rectangular pattern formed from 2862 pixels arranged in a matrix of 54 rows and 53 columns, the pixels of the 1st to 32nd columns and the 35th to 53rd columns which form the 1st row of the rectangular pattern, the pixels of the 1st to 30th columns and the 36th to 53rd columns which form the 2nd row of the rectangular pattern, the pixels of the 1st to 28th columns and the 36th to 53rd columns which form the 3rd row of the rectangular pattern, the pixels of the 1st to 27th columns and the 37th to 53rd columns which form the 4th row of the rectangular pattern, the pixels of the 1st to 25th columns and the 37th to 56th columns which form the 5th row of the rectangular pattern, the pixels of the 1st to 23rd columns and the 38th to 53rd columns which form the 6th row of the rectangular pattern, the pixels of the 1st to 22nd columns and the 39th to 53rd columns which form the 7th row of the rectangular pattern, the pixels of the 1st to 20th columns and the 39th to 53rd columns which form the 8th row of the rectangular pattern, the pixels of the 1st to 18th columns and the 40th to 53rd columns which form the 9th row of the rectangular pattern, the pixels of the 1st to 17th columns and the 40th to 53rd columns which form the 10th row of the rectangular pattern, the pixels of the 1st to 15th columns and the 41st to 53rd columns which form the 11th row of the rectangular pattern, the pixels of the 1st to 13th columns and the 42nd to 53rd columns which form the 12th row of the rectangular pattern, the pixels of the 1st to 11th columns and the 42nd to 53rd columns which form the 13th row of the rectangular pattern, the pixels of the 1st to 10th columns and the 43rd to 53rd columns which form the 14th row of the rectangular pattern, the pixels of the 1st to 8th columns and the 43rd to 53rd columns which form the 15th row of the rectangular pattern, the pixels of the 1st to 6th columns and the 44th to 53rd columns which form the 16th row of the rectangular pattern, the pixels of the 1st to 5th columns and the 44th to 53rd columns which form the 17th row of the rectangular pattern, the pixels of the 1st to 3rd columns and the 45th to 53rd columns which form the 18th row of the rectangular pattern, the pixels of the 1st column and the 46th to 53rd columns which form the 19th row of the rectangular pattern, the pixels of the 46th to 53rd columns which form the 20th row of the rectangular pattern, the pixels of the 47th to 53rd columns which form the 21st row of the rectangular pattern, the pixel of the 1st column and the 47th to 53rd columns which form the 22nd row of the rectangular pattern, the pixel of the 1st column and the 48th to 53rd columns which form the 23rd row of the rectangular pattern, the pixels of the 1st to 2nd columns and the 49th to 53rd columns which form the 24th row of the rectangular pattern, the pixels of the 1st to 2nd columns and the 49th to 53rd columns which form the 25th row of the rectangular pattern, the pixels of the 1st to 3rd columns and the 50th to 53rd columns which form the 26th row of the rectangular pattern, the pixels of the 1st to 4th columns and the 50th to 53rd columns which form the 27th row of the rectangular pattern, the pixels of the 1st to 4th columns and the 51st to 53rd columns which form the 28th row of the rectangular pattern, the pixels of the 1st to 5th columns and the 52nd to 53rd columns which form the 29th row of the rectangular pattern, the pixels of the 1st to 5th columns and the 52nd to 53rd columns which form the 30th row of the rectangular pattern, the pixels of the 1st to 6th columns and the 53rd column which form the 31st row of the rectangular pattern, the pixels of the 1st to 7th columns and the 53rd column which form the 32nd row of the rectangular pattern, the pixels of the 1st to 7th columns which form the 33rd row of the rectangular pattern, the pixels of the 1st to 8th columns which form the 34th row of the rectangular pattern, the pixels of the 1st to 8th columns and the 53rd column which form the 35th row of the rectangular pattern, the pixels of the 1st to 9th columns and the 51st to 53rd columns which form the 36th row of the rectangular pattern, the pixels of the 1st to 9th columns and the 49th to 53rd columns which form the 37th row of the rectangular pattern, the pixels of the 1st to 10th columns and the 48th to 53rd columns which form the 38th row of the rectangular pattern, the pixels of the 1st to 11th columns and the 46th to 53rd columns which form the 39th row of the rectangular pattern, the pixels of the 1st to 11th columns and the 44th to 53rd columns which form the 40th row of the rectangular pattern, the pixels of the 1st to 12th columns and the 43rd to 53rd columns which form the 41st row of the rectangular pattern, the pixels of the 1st to 12th columns and the 41st to 53rd columns which form the 42nd row of the rectangular pattern, the pixels of the 1st to 13th columns and the 39th to 53rd columns which form the 43rd row of the rectangular pattern, the pixels of the 1st to 14th columns and the 38th to 53rd columns which form the 44th row of the rectangular pattern, the pixels of the 1st to 14th columns and the 36th to 53rd columns which form the 45th row of the rectangular pattern, the pixels of the 1st to 15th columns and the 34th to 53rd columns which form the 46th row of the rectangular pattern, the pixels of the 1st to 15th columns and the 32nd to 53rd columns which form the 47th row of the rectangular pattern, the pixels of the 1st to 16th columns and the 31st to 53rd columns which form the 48th row of the rectangular pattern, the pixels of the 1st to 17th columns and the 29th to 53rd columns which form the 49th row of the rectangular pattern, the pixels of the 1st to 17th columns and the 27th to 53rd columns which form the 50th row of the rectangular pattern, the pixels of the 1st to 18th columns and the 26th to 53rd columns which form the 51st row of the rectangular pattern, the pixels of the 1st to 18th columns and the 24th to 53rd columns which form the 52nd row of the rectangular pattern, the pixels of the 1st to 19th columns and the 22nd to 53rd columns which form the 53rd row of the rectangular pattern, and the pixels of the 1st to 19th columns and the 21st to 53rd columns which form the 54th row of the rectangular pattern are cut out,
a turn on order of the 1556 pixels being set such that:
the pixels of the 33rd to 34th columns which form the 1st row of the partly lacking pattern are turned on 805th, and 797th, respectively;
the pixels of the 31st to 35th columns which form the 2nd row of the partly lacking pattern are turned on 821st, 853rd, 869th, 845th, and 789th, respectively;
the pixels of the 29th to 35th columns which form the 3rd row of the partly lacking pattern are turned on 781st, 889th, 925th, 961st, 949th, 913th, and 857th, respectively;
the pixels of the 28th to 36th columns which form the 4th row of the partly lacking pattern are turned on 873rd, 953rd, 989th, 1033rd, 1045th, 1029th, 981st, 933rd, and 829th, respectively;
the pixels of the 26th to 36th columns which form the 5th row of the partly lacking pattern are turned on 837th, 941st, 1021st, 1061st, 1101st, 1125th, 1129th, 1109th, 1069th, 1013th, and 909th, respectively;
the pixels of the 24th to 37th columns which form the 6th row of the partly lacking pattern are turned on 813th, 905th, 1009th, 1077th, 1141st, 1173rd, 1197th, 1213th, 1205th, 1189th, 1149th, 1093rd, 997th, and 885th, respectively;
the pixels of the 23rd to 38th columns which form the 7th row of the partly lacking pattern are turned on 893rd, 977th, 1057th, 1121st, 1181st, 1241st, 1261st, 1281st, 1309th, 1277th, 1253rd, 1229th, 1165th, 1085th, 973rd, and 809th, respectively;
the pixels of the 21st to 38th columns which form the 8th row of the partly lacking pattern are turned on 833rd, 917th, 1001st, 1089th, 1161st, 1221st, 1273rd, 1317th, 1341st, 1365th, 1373rd, 1357th, 1325th, 1285th, 1237th, 1157th, 1053rd, and 901st, respectively;
the pixels of the 19th to 39th columns which form the 9th row of the partly lacking pattern are turned on 793rd, 861st, 937th, 1017th, 1097th, 1169th, 1245th, 1305th, 1337th, 1381st, 1405th, 1421st, 1429th, 1413th, 1389th, 1349th, 1297th, 1217th, 1117th, 1005th, and 841st, respectively;
the pixels of the 18th to 39th columns which form the 10th row of the partly lacking pattern are turned on 801st, 849th, 921st, 985th, 1073rd, 1153rd, 1233rd, 1301st, 1353rd, 1401st, 1441st, 1453rd, 1473rd, 1485th, 1461st, 1445th, 1397th, 1333rd, 1269th, 1185th, 1081st, and 945th, respectively;
the pixels of the 16th to 40th columns which form the 11th row of the partly lacking pattern are turned on 751st, 759th, 817th, 881st, 965th, 1037th, 1113th, 1193rd, 1257th, 1329th, 1393rd, 1449th, 1477th, 1497th, 1509th, 1513th, 1501st, 1469th, 1437th, 1385th, 1321st, 1249th, 1145th, 1025th, and 877th, respectively;
the pixels of the 14th to 41st columns which form the 12th row of the partly lacking pattern are turned on 735th, 703rd, 687th, 711th, 767th, 865th, 969th, 1049th, 1137th, 1209th, 1293rd, 1361st, 1417th, 1465th, 1505th, 1529th, 1537th, 1533rd, 1525th, 1493rd, 1457th, 1409th, 1345th, 1265th, 1177th, 1065th, 957th, and 785th, respectively;
the pixels of the 12th to 41st columns which form the 13th row of the partly lacking pattern are turned on 775th, 667th, 631st, 595th, 607th, 643rd, 699th, 825th, 929th, 1041st, 1133rd, 1225th, 1313th, 1377th, 1433rd, 1489th, 1521st, 1545th, 1553rd, 1549th, 1541st, 1517th, 1481st, 1425th, 1369th, 1289th, 1201st, 1105th, 993rd, and 897th, respectively;
the pixels of the 11th to 42nd columns which form the 14th row of the partly lacking pattern are turned on 683rd, 603rd, 567th, 523rd, 511th, 527th, 575th, 623rd, 727th, 887th, 991st, 1103rd, 1199th, 1283rd, 1367th, 1423rd, 1475th, 1515th, 1539th, 1555th, 1551st, 1535th, 1511th, 1479th, 1431st, 1375th, 1311th, 1215th, 1119th, 1035th, 927th, and 815th, respectively;
the pixels of the 9th to 42nd columns which form the 15th row of the partly lacking pattern are turned on 719th, 615th, 535th, 495th, 455th, 431st, 427th, 447th, 487th, 543rd, 647th, 783rd, 967th, 1067th, 1175th, 1263rd, 1343rd, 1407th, 1455th, 1499th, 1531st, 1547th, 1543rd, 1527th, 1503rd, 1463rd, 1415th, 1359th, 1279th, 1207th, 1131st, 1047th, 947th, and 855th, respectively;
the pixels of the 7th to 43rd columns which form the 16th row of the partly lacking pattern are turned on 743rd, 651st, 547th, 479th, 415th, 383rd, 359th, 343rd, 351st, 367th, 407th, 463rd, 559th, 671st, 879th, 1023rd, 1143rd, 1247th, 1319th, 1383rd, 1443rd, 1483rd, 1507th, 1523rd, 1519th, 1495th, 1471st, 1447th, 1391st, 1327th, 1255th, 1191st, 1107th, 1031st, 943rd, 871st, and 803rd, respectively;
the pixels of the 6th to 43rd columns which form the 17th row of the partly lacking pattern are turned on 663rd, 579th, 499th, 435th, 375th, 315th, 295th, 275th, 247th, 279th, 303rd, 327th, 391st, 471st, 583rd, 747th, 951st, 1079th, 1183rd, 1275th, 1339th, 1403rd, 1451st, 1467th, 1491st, 1487th, 1459th, 1439th, 1399th, 1351st, 1287th, 1231st, 1151st, 1063rd, 983rd, 903rd, 839th, and 799th, respectively;
the pixels of the 4th to 44th columns which form the 18th row of the partly lacking pattern are turned on 723rd, 639th, 555th, 467th, 395th, 335th, 283rd, 239th, 215th, 191st, 183rd, 199th, 231st, 271st, 319th, 399th, 503rd, 655th, 843rd, 1011th, 1127th, 1227th, 1307th, 1355th, 1395th, 1419th, 1435th, 1427th, 1411th, 1387th, 1335th, 1303rd, 1239th, 1167th, 1095th, 1015th, 935th, 863rd, 787th, 752nd, and 760th, respectively;
the pixels of the 2nd to 45th columns which form the 19th row of the partly lacking pattern are turned on 763rd, 695th, 619th, 539th, 459th, 387th, 311th, 251st, 219th, 175th, 151st, 135th, 127th, 143rd, 167th, 207th, 259th, 339th, 439th, 551st, 715th, 919th, 1059th, 1163rd, 1243rd, 1299th, 1331st, 1363rd, 1379th, 1371st, 1347th, 1323rd, 1271st, 1223rd, 1159th, 1087th, 999th, 911th, 831st, 736th, 704th, 688th, 712th, and 768th, respectively;
the pixels of the 1st to 45th columns which form the 20th row of the partly lacking pattern are turned on 755th, 707th, 635th, 571st, 483rd, 403rd, 323rd, 255th, 203rd, 155th, 115th, 103rd, 83rd, 71st, 95th, 111th, 159th, 223rd, 287th, 371st, 475th, 611th, 823rd, 979th, 1091st, 1171st, 1235th, 1259th, 1291st, 1315th, 1295th, 1267th, 1251st, 1187th, 1123rd, 1055th, 975th, 895th, 776th, 668th, 632nd, 596th, 608th, 644th, and 700th, respectively;
the pixels of the 1st to 46th columns which form the 21st row of the partly lacking pattern are turned on 739th, 675th, 591st, 519th, 443rd, 363rd, 299th, 227th, 163rd, 107th, 79th, 59th, 47th, 43rd, 55th, 87th, 119th, 171st, 235th, 307th, 411th, 531st, 679th, 899th, 1003rd, 1099th, 1155th, 1195th, 1211th, 1219th, 1203rd, 1179th, 1147th, 1083rd, 1007th, 915th, 819th, 684th, 604th, 568th, 524th, 512th, 528th, 576th, 624th, and 728th, respectively;
the pixels of the 2nd to 46th columns which form the 22nd row of the partly lacking pattern are turned on 691st, 587th, 507th, 419th, 347th, 263rd, 195th, 139th, 91st, 51st, 27th, 19th, 23rd, 31st, 63rd, 99th, 147th, 211th, 291st, 379th, 491st, 599th, 771st, 923rd, 1019th, 1075th, 1115th, 1139th, 1135th, 1111th, 1071st, 1027th, 955th, 847th, 720th, 616th, 536th, 496th, 456th, 432nd, 428th, 448th, 488th, 544th, and 648th, respectively;
the pixels of the 2nd to 47th columns which form the 23rd row of the partly lacking pattern are turned on 731st, 627th, 515th, 423rd, 331st, 243rd, 179th, 123rd, 67th, 35th, 11th, 3rd, 7th, 15th, 39th, 75th, 131st, 187th, 267th, 355th, 451st, 563rd, 659th, 835th, 939th, 987th, 1039th, 1051st, 1043rd, 995th, 971st, 883rd, 744th, 652nd, 548th, 480th, 416th, 384th, 360th, 344th, 352nd, 368th, 408th, 464th, 560th, and 672nd, respectively;
the pixels of the 3rd to 48th columns which form the 24th row of the partly lacking pattern are turned on 669th, 565th, 453rd, 357th, 273rd, 189th, 133rd, 81st, 41st, 17th, 1st, 5th, 21st, 45th, 77th, 125th, 181st, 245th, 341st, 437th, 521st, 629th, 741st, 867th, 907th, 959th, 963rd, 931st, 891st, 791st, 664th, 580th, 500th, 436th, 376th, 316th, 296th, 276th, 248th, 280th, 304th, 328th, 392nd, 472nd, 584th, and 748th, respectively;
the pixels of the 3rd to 48th columns which form the 25th row of the partly lacking pattern are turned on 773rd, 589th, 489th, 381st, 293rd, 213th, 149th, 101st, 57th, 25th, 9th, 13th, 29th, 53rd, 93rd, 141st, 197th, 277th, 349th, 425th, 509th, 609th, 701st, 795th, 851st, 875th, 859th, 827th, 724th, 640th, 556th, 468th, 396th, 336th, 284th, 240th, 216th, 192nd, 184th, 200th, 232nd, 272nd, 320th, 400th, 504th, and 656th, respectively;
the pixels of the 4th to 49th columns which form the 26th row of the partly lacking pattern are turned on 677th, 533rd, 413th, 309th, 237th, 173rd, 113th, 73rd, 49th, 33rd, 37th, 61st, 85th, 109th, 165th, 229th, 301st, 365th, 449th, 525th, 613th, 685th, 753rd, 807th, 811th, 764th, 696th, 620th, 540th, 460th, 388th, 312th, 252nd, 220th, 176th, 152nd, 136th, 128th, 144th, 168th, 208th, 260th, 340th, 440th, 552nd, and 716th, respectively;
the pixels of the 5th to 49th columns which form the 27th row of the partly lacking pattern are turned on 605th, 477th, 373rd, 281st, 217th, 153rd, 105th, 89th, 65th, 69th, 97th, 117th, 157th, 205th, 269th, 325th, 405th, 493rd, 573rd, 653rd, 717th, 757th, 779th, 756th, 708th, 636th, 572nd, 484th, 404th, 324th, 256th, 204th, 156th, 116th, 104th, 84th, 72nd, 96th, 112th, 160th, 224th, 288th, 372nd, 476th, and 612th, respectively;
the pixels of the 5th to 50th columns which form the 28th row of the partly lacking pattern are turned on 713th, 545th, 429th, 329th, 249th, 201st, 161st, 137th, 121st, 129th, 145th, 169th, 221st, 253rd, 317th, 389th, 461st, 541st, 621st, 693rd, 769th, 806th, 798th, 740th, 676th, 592nd, 520th, 444th, 364th, 300th, 228th, 164th, 108th, 80th, 60th, 48th, 44th, 56th, 88th, 120th, 172nd, 236th, 308th, 412th, 532nd, and 680th, respectively;
the pixels of the 6th to 51st columns which form the 29th row of the partly lacking pattern are turned on 637th, 497th, 393rd, 313th, 257th, 225th, 193rd, 177th, 185th, 209th, 233rd, 285th, 333rd, 397th, 469th, 557th, 645th, 725th, 822nd, 854th, 870th, 846th, 790th, 692nd, 588th, 508th, 420th, 348th, 264th, 196th, 140th, 92nd, 52nd, 28th, 20th, 24th, 32nd, 64th, 100th, 148th, 212th, 292nd, 380th, 492nd, 600th, and 772nd, respectively;
the pixels of the 6th to 51st columns which form the 30th row of the partly lacking pattern are turned on 733rd, 577th, 465th, 385th, 321st, 297th, 265th, 241st, 261st, 289th, 305th, 369th, 433rd, 501st, 581st, 661st, 782nd, 890th, 926th, 962nd, 950th, 914th, 858th, 732nd, 628th, 516th, 424th, 332nd, 244th, 180th, 124th, 68th, 36th, 12th, 4th, 8th, 16th, 40th, 76th, 132nd, 188th, 268th, 356th, 452nd, 564th, and 660th, respectively;
the pixels of the 7th to 52nd columns which form the 31st row of the partly lacking pattern are turned on 657th, 553rd, 457th, 401st, 361st, 345th, 337th, 353rd, 377th, 409th, 473rd, 549th, 641st, 737th, 874th, 954th, 990th, 1034th, 1046th, 1030th, 982nd, 934th, 830th, 670th, 566th, 454th, 358th, 274th, 190th, 134th, 82nd, 42nd, 18th, 2nd, 6th, 22nd, 46th, 78th, 126th, 182nd, 246th, 342nd, 438th, 522nd, 630th, and 742nd, respectively;
the pixels of the 8th to 52nd columns which form the 32nd row of the partly lacking pattern are turned on 633rd, 537th, 481st, 441st, 417th, 421st, 445th, 485th, 529th, 601st, 709th, 838th, 942nd, 1022nd, 1062nd, 1102nd, 1126th, 1130th, 1110th, 1070th, 1014th, 910th, 774th, 590th, 490th, 382nd, 294th, 214th, 150th, 102nd, 58th, 26th, 10th, 14th, 30th, 54th, 94th, 142nd, 198th, 278th, 350th, 426th, 510th, 610th, and 702nd, respectively;
the pixels of the 8th to 53rd columns which form the 33rd row of the partly lacking pattern are turned on 721st, 617th, 569th, 517th, 505th, 513th, 561st, 585th, 673rd, 814th, 906th, 1010th, 1078th, 1142nd, 1174th, 1198th, 1214th, 1206th, 1190th, 1150th, 1094th, 998th, 886th, 678th, 534th, 414th, 310th, 238th, 174th, 114th, 74th, 50th, 34th, 38th, 62nd, 86th, 110th, 166th, 230th, 302nd, 366th, 450th, 526th, 614th, 686th, and 754th, respectively;
the pixels of the 9th to 53rd columns which form the 34th row of the partly lacking pattern are turned on 689th, 649th, 597th, 593rd, 625th, 665th, 765th, 894th, 978th, 1058th, 1122nd, 1182nd, 1242nd, 1262nd, 1282nd, 1310th, 1278th, 1254th, 1230th, 1166th, 1086th, 974th, 810th, 606th, 478th, 374th, 282nd, 218th, 154th, 106th, 90th, 66th, 70th, 98th, 118th, 158th, 206th, 270th, 326th, 406th, 494th, 574th, 654th, 718th, and 758th, respectively;
the pixels of the 9th to 52nd columns which form the 35th row of the partly lacking pattern are turned on 761st, 705th, 681st, 697th, 729th, 834th, 918th, 1002nd, 1090th, 1162nd, 1222nd, 1274th, 1318th, 1342nd, 1366th, 1374th, 1358th, 1326th, 1286th, 1238th, 1158th, 1054th, 902nd, 714th, 546th, 430th, 330th, 250th, 202nd, 162nd, 138th, 122nd, 130th, 146th, 170th, 222nd, 254th, 318th, 390th, 462nd, 542nd, 622nd, 694th, and 770th, respectively;
the pixels of the 10th to 50th columns which form the 36th row of the partly lacking pattern are turned on 749th, 745th, 794th, 862nd, 938th, 1018th, 1098th, 1170th, 1246th, 1306th, 1338th, 1382nd, 1406th, 1422nd, 1430th, 1414th, 1390th, 1350th, 1298th, 1218th, 1118th, 1006th, 842nd, 638th, 498th, 394th, 314th, 258th, 226th, 194th, 178th, 186th, 210th, 234th, 286th, 334th, 398th, 470th, 558th, 646th, and 726th, respectively;
the pixels of the 10th to 48th columns which form the 37th row of the partly lacking pattern are turned on 777th, 802nd, 850th, 922nd, 986th, 1074th, 1154th, 1234th, 1302nd, 1354th, 1402nd, 1442nd, 1454th, 1474th, 1486th, 1462nd, 1446th, 1398th, 1334th, 1270th, 1186th, 1082nd, 946th, 734th, 578th, 466th, 386th, 322nd, 298th, 266th, 242nd, 262nd, 290th, 306th, 370th, 434th, 502nd, 582nd, and 662nd, respectively;
the pixels of the 11th to 47th columns which form the 38th row of the partly lacking pattern are turned on 818th, 882nd, 966th, 1038th, 1114th, 1194th, 1258th, 1330th, 1394th, 1450th, 1478th, 1498th, 1510th, 1514th, 1502nd, 1470th, 1438th, 1386th, 1322nd, 1250th, 1146th, 1026th, 878th, 658th, 554th, 458th, 402nd, 362nd, 346th, 338th, 354th, 378th, 410th, 474th, 550th, 642nd, and 738th, respectively;
the pixels of the 12th to 45th columns which form the 39th row of the partly lacking pattern are turned on 866th, 970th, 1050th, 1138th, 1210th, 1294th, 1362nd, 1418th, 1466th, 1506th, 1530th, 1538th, 1534th, 1526th, 1494th, 1458th, 1410th, 1346th, 1266th, 1178th, 1066th, 958th, 786th, 634th, 538th, 482nd, 442nd, 418th, 422nd, 446th, 486th, 530th, 602nd, and 710th, respectively;
the pixels of the 12th to 43rd columns which form the 40th row of the partly lacking pattern are turned on 826th, 930th, 1042nd, 1134th, 1226th, 1314th, 1378th, 1434th, 1490th, 1522nd, 1546th, 1554th, 1550th, 1542nd, 1518th, 1482nd, 1426th, 1370th, 1290th, 1202nd, 1106th, 994th, 898th, 722nd, 618th, 570th, 518th, 506th, 514th, 562nd, 586th, and 674th, respectively;
the pixels of the 13th to 42nd columns which form the 41st row of the partly lacking pattern are turned on 888th, 992nd, 1104th, 1200th, 1284th, 1368th, 1424th, 1476th, 1516th, 1540th, 1556th, 1552nd, 1536th, 1512th, 1480th, 1432nd, 1376th, 1312th, 1216th, 1120th, 1036th, 928th, 816th, 690th, 650th, 598th, 594th, 626th, 666th, and 766th, respectively;
the pixels of the 13th to 40th columns which form the 42nd row of the partly lacking pattern are turned on 784th, 968th, 1068th, 1176th, 1264th, 1344th, 1408th, 1456th, 1500th, 1532nd, 1548th, 1544th, 1528th, 1504th, 1464th, 1416th, 1360th, 1280th, 1208th, 1132nd, 1048th, 948th, 856th, 762nd, 706th, 682nd, 698th, and 730th, respectively;
the pixels of the 14th to 38th columns which form the 43rd row of the partly lacking pattern are turned on 880th, 1024th, 1144th, 1248th, 1320th, 1384th, 1444th, 1484th, 1508th, 1524th, 1520th, 1496th, 1472nd, 1448th, 1392nd, 1328th, 1256th, 1192nd, 1108th, 1032nd, 944th, 872nd, 804th, 750th, and 746th, respectively;
the pixels of the 15th to 37th columns which form the 44th row of the partly lacking pattern are turned on 952nd, 1080th, 1184th, 1276th, 1340th, 1404th, 1452nd, 1468th, 1492nd, 1488th, 1460th, 1440th, 1400th, 1352nd, 1288th, 1232nd, 1152nd, 1064th, 984th, 904th, 840th, 800th, and 778th, respectively;
the pixels of the 15th to 35th columns which form the 45th row of the partly lacking pattern are turned on 844th, 1012th, 1128th, 1228th, 1308th, 1356th, 1396th, 1420th, 1436th, 1428th, 1412th, 1388th, 1336th, 1304th, 1240th, 1168th, 1096th, 1016th, 936th, 864th, and 788th, respectively;
the pixels of the 16th to 33rd columns which form the 46th row of the partly lacking pattern are turned on 920th, 1060th, 1164th, 1244th, 1300th, 1332nd, 1364th, 1380th, 1372nd, 1348th, 1324th, 1272nd, 1224th, 1160th, 1088th, 1000th, 912th, and 832nd, respectively;
the pixels of the 16th to 31st columns which form the 47th row of the partly lacking pattern are turned on 824th, 980th, 1092nd, 1172nd, 1236th, 1260th, 1292nd, 1316th, 1296th, 1268th, 1252nd, 1188th, 1124th, 1056th, 976th, and 896th, respectively;
the pixels of the 17th to 30th columns which form the 48th row of the partly lacking pattern are turned on 900th, 1004th, 1100th, 1156th, 1196th, 1212th, 1220th, 1204th, 1180th, 1148th, 1084th, 1008th, 916th, and 820th, respectively;
the pixels of the 18th to 28th columns which form the 49th row of the partly lacking pattern are turned on 924th, 1020th, 1076th, 1116th, 1140th, 1136th, 1112th, 1072nd, 1028th, 956th, and 848th, respectively;
the pixels of the 18th to 26th columns which form the 50th row of the partly lacking pattern are turned on 836th, 940th, 988th, 1040th, 1052nd, 1044th, 996th, 972nd, and 884th, respectively;
the pixels of the 19th to 25th columns which form the 51st row of the partly lacking pattern are turned on 868th, 908th, 960th, 964th, 932nd, 892nd, and 792nd, respectively;
the pixels of the 19th to 23rd columns which form the 52nd row of the partly lacking pattern are turned on 796th, 852nd, 876th, 860th, and 828th, respectively;
the pixels of the 20th to 21st columns which form the 53rd row of the partly lacking pattern are turned on 808th, and 812th, respectively; and
the pixel of the 20th column which forms the 54th row of the partly lacking pattern is turned on 780th.

17. The binarization dither matrix pattern as claimed in claim 14, wherein the turn-on order set to arbitrary pixels in the binarization dither matrix pattern and a turn-on order set to pixels at point symmetric positions to the arbitrary pixels with respect to a specific point regarding halftone dots to which the arbitrary pixels belong are exchanged for each other.

18. The binarization dither matrix pattern as claimed in claim 15, wherein the turn-on order set to arbitrary pixels in the binarization dither matrix pattern and a turn-on order set to pixels at point symmetric positions to the arbitrary pixels with respect to a specific point regarding halftone dots to which the arbitrary pixels belong are exchanged for each other.

19. A computer-readable recording medium on or in which a printing program for causing a computer to execute a printing function for binarizing a multi-value image and forming an image on a medium is recorded, said printing program causing the computer to execute:
a step of producing a binarization dither matrix pattern configured by arranging a plurality of pixels to be successively turned on in a matrix and having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order; and
an image forming step of forming, based on inputted pixel values of a multi-value image, a color material for pixels of an object of formation of a color material decided by selecting pixels from the starting pixel of the turn-on order to a pixel to which a predetermined turn-on order number is set in the binarization dither matrix pattern in accordance with the turn-on order to form an image.

20. A computer-readable recording medium on or in which a binarization program for causing a computer to execute a binarization function for binarizing a multi-value image, said binarization program causing the computer to execute:
a step of producing a binarization dither matrix pattern configured by arranging a plurality of pixels to be successively turned on in a matrix and having a plurality of specific points provided at substantially point symmetric positions with respect to the position of the center of figure thereof, those of the pixels which are adjacent to turned on pixels being preferentially turned on in order beginning with those of the pixels which are positioned near to the specific points to individually form successive halftone dots, the turned on pixels and unturned on pixels forming a checkered pattern in the binarization dither matrix pattern when a number of pixels substantially equal to one half the number of pixels which form the binarization dither matrix pattern are turned on in order; and
a binarizing step of selecting, based on inputted pixel values of a multi-value image, pixels from the starting pixel of the turn-on order to a pixel to which a predetermined turn-on order number is set in the binarization dither matrix pattern in accordance with the turn-on order to perform the binarization process.
